(19) United States
(12) Patent Application Publication
(10) Pub. No.: US 2009/0266106 A1
(43) Pub. Date: Oct. 29, 2009

(54) Method and apparatus for producing clathrate hydrate slurry, and method for operating the same apparatus

(75) Inventors: Hidemasa Ogoshi, Kawasaki-shi (JP); Naoyuki Furumoto, Kawasaki-shi (JP); Hiroyuki Ida, Kawasaki-shi (JP)

Correspondence Address: COOPER & DUNHAM, LLP, 30 Rockefeller Plaza, 20th Floor, NEW YORK, NY, 10112, US

(73) Assignee: JFE Engineering Corporation

(21) Appl. No.: 12/459,176

(22) Filed: Jun. 25, 2009

Related U.S. Application Data
(63) Continuation of application No. PCT/JP07/74224, filed on Dec. 17, 2004.

(30) Foreign Application Priority Data
Dec. 25, 2006 (JP) 2006-347669
Jan. 30, 2007 (JP) 2007-019064
Mar. 28, 2007 (JP) 2007-083983
Mar. 28, 2007 (JP) 2007-084045
Mar. 29, 2007 (JP) 2007-086177
Jul. 30, 2007 (JP) 2007-196955
Aug. 20, 2007 (JP) 2007-213689

(51) Int. Cl. F28D 20/00; C09K 5/06; F28D 20/02; F25D 3/00

(52) U.S. Cl. 62/532; 62/123; 62/434; 165/104.17; 165/10; 62/114

(57) ABSTRACT

A method of producing a clathrate hydrate slurry, includes a step of heat-exchanging an aqueous solution of a guest compound for the clathrate hydrate or a slurry of the clathrate hydrate dispersed or suspended in an aqueous solution or water with a refrigerant thereby generating the clathrate hydrate in the aqueous solution or the slurry, in which a part of the clathrate hydrate deposited on the heat transfer surface in the process of heat exchange with the refrigerant is removed by adjustment of a temperature of the refrigerant and flow force of the aqueous solution or the slurry and the rest is kept remained as it covers the heat transfer surface.

### CROSS-REFERENCE TO RELATED APPLICATIONS

This is a Continuation Application of PCT Application No. PCT/JP2007/074224, filed Dec. 17, 20074, which was published under PCT Article 21(2) in Japanese.

This application is based upon and claims the benefit of priority from prior Japanese Patent Applications No. 2006-347669, filed Dec. 25, 2006; and No. 2007-019064, filed Jan. 30, 2007; and No. 2007-083983, filed Mar. 28, 2007; and No. 2007-084045, filed Mar. 28, 2007; and No. 2007-086177, filed Mar. 29, 2007; and No. 2007-196955, filed Jul. 30, 2007; and No. 2007-213689, filed Aug. 20, 2007, the entire contents of all of which are incorporated herein by reference.

### BACKGROUND OF THE INVENTION

1. Field of the Invention

The present invention relates to a technique for producing a clathrate hydrate slurry by using heat transfer tubes as a heat exchanger, and more particularly, to a method of producing a clathrate hydrate slurry, comprising a step of generating a clathrate hydrate in an aqueous solution or a slurry by feeding an aqueous solution of a guest compound for the clathrate hydrate or a slurry of the clathrate hydrate dispersed or suspended in an aqueous solution or water into a heat transfer tube and heat exchanging the aqueous solution with a refrigerant present at the outer periphery of the heat transfer tube, an apparatus for implementing the production method, and a method for operating the apparatus.

In the invention, the following terms are defined and construed as follows:

(1) The “clathrate hydrates” include semi-clathrate hydrates. Hereinafter, it may be abbreviated simply as “hydrates”.
(2) The “clathrate hydrate slurry” or the “hydrate slurry” is a slurry-like substance containing the clathrate hydrate dispersed or suspended in an aqueous solution of the guest compound or water solvent, and the aqueous solution or the water solvent containing other compositions (including additives) is also included in the “clathrate hydrate slurry” or the “hydrate slurry” as long as the clathrate hydrate is dispersed or suspended therein.
(3) The “aqueous solution of a guest compound for clathrate hydrate” is an aqueous solution containing the guest compound for clathrate hydrate as a solute, and the aqueous solution containing the clathrate hydrate and other compositions (including additives) is also included in the “aqueous solution of a guest compound for clathrate hydrate” as long as it is an aqueous solution containing the guest compound for clathrate hydrate as a solute.
(4) The “raw solution” represents an aqueous solution of a guest compound for clathrate hydrate having a property to generate the clathrate hydrate when cooled.
(5) The “raw slurry” represents a clathrate hydrate slurry or a hydrate slurry having a property to generate the clathrate hydrate when cooled.
(6) The “refrigerant” and the “heat transfer medium” are both substances storing and conveying heat energy, although there are some differences in literal expression and also in usage, for example for hydrate generation or condensation.

2. Description of the Related Art

Slurry of clathrate hydrate, which is used for example as a heat transfer medium such as thermal storage medium or latent-heat transfer medium in the field of thermal utilization, is produced by cooling its raw solution or slurry through heat exchange with a refrigerant (Patent Document 1). Examples of the heat exchanger allowing the heat exchange are those employing heat transfer tubes, and such heat exchangers can be further classified into single-tubular heat exchangers and multi-tubular heat exchangers (including shell-and-tube heat exchangers). The heat exchangers can also be classified into those performing heat exchange by supplying a refrigerant into the outer periphery of the heat transfer tube and a raw solution or slurry into the inner space, respectively, and those performing heat exchange alternatively by supplying a refrigerant into the heat transfer tube and a raw solution or slurry to the outer periphery, respectively (see Patent Documents 2 and 3).

The clathrate hydrate once deposited on the heat exchange surface of heat exchanger is known to accelerate generation of additional clathrate hydrate, as they function as a product nucleus (Patent Documents 4 and 5).

On the other hand, deposition of the clathrate hydrate on the heat-exchanger heat exchange surface results in coverage of the heat exchange surface, causing problems in heat exchange. Especially when a heat exchanger in the configuration of performing heat exchange by supplying a refrigerant to the outer periphery of the heat transfer tube and a raw solution or slurry to the inside respectively is used, the clathrate hydrate deposited on the heat transfer tube inner wall surface hinders flow of the raw solution or slurry. It makes it difficult to produce the clathrate hydrate slurry stably over an extended period of time. For that reason, the clathrate hydrate deposited is removed forcibly from the heat exchange surface as the flow rate of the raw solution or slurry is raised, and the degree of removal is monitored by measurement of a suitable parameter (Patent Document 6).

Patent Document 1: Jpn. Pat. Appln. KOKAI Publication No. 2004-93052

Patent Document 2: Jpn. Pat. Appln. KOKAI Publication No. 2002-263470

Patent Document 3: Jpn. Pat. Appln. KOKAI Publication No. 2004-85008

Patent Document 4: Jpn. Pat. Appln. KOKAI Publication No. 2000-234769

Patent Document 5: Jpn. Pat. Appln. KOKAI Publication No. 2002-283223

Patent Document 6: Japanese Patent No. 2001-343139

### BRIEF SUMMARY OF THE INVENTION

However, although it is possible to stably produce the clathrate hydrate slurry advantageously by removing the clathrate hydrate deposited on the heat-exchanger heat exchange surface completely, it is undeniable that the advantage of the clathrate hydrate deposited on the heat exchange surface functioning as a product nucleus for stable generation of additional clathrate hydrate is sacrificed because of overemphasis on stable production.

An object of the present invention, which has been made under the circumstances above, is to provide a method of producing a clathrate hydrate slurry stably over an extended period of time, while preserving the advantage of the clathrate hydrate deposited on the heat-exchanger heat exchange surface accelerating generation of additional clathrate hydrate.

In order to achieve the above object, a first aspect of the present invention provides a method of producing a clathrate hydrate slurry, comprising steps of feeding an aqueous solution of a guest compound for the clathrate hydrate or a slurry of the clathrate hydrate dispersed or suspended in an aqueous solution or water into a heat transfer tube and heat-exchanging the aqueous solution or the slurry with a refrigerant present at an outer periphery of the heat transfer tube thereby generating a clathrate hydrate in the aqueous solution or the slurry, characterized in that increase in an amount of the clathrate hydrate deposited on a heat transfer tube inner wall surface in a process of heat exchange with the refrigerant is suppressed by flow force of the aqueous solution or the slurry flowing inside the heat transfer tube.

A second aspect of the invention provides a method of producing a clathrate hydrate slurry, comprising steps of feeding an aqueous solution of a guest compound for the clathrate hydrate or a slurry of the clathrate hydrate dispersed or suspended in an aqueous solution or water into a heat transfer tube and heat-exchanging the aqueous solution or the slurry with a refrigerant present at an outer periphery of the heat transfer tube thereby generating a clathrate hydrate in the aqueous solution or the slurry, characterized in that a part of the clathrate hydrate deposited on the heat transfer tube inner wall surface in the process of heat exchange with the refrigerant is removed by flow force of the aqueous solution or the slurry and the rest is kept remained as it covers the heat transfer tube inner wall surface.

A third aspect of the invention provides the method of producing a clathrate hydrate slurry according to the first or second aspect, characterized in that a part or all of the aqueous solution or the slurry passed through the heat transfer tube is circulated around the heat transfer tube.

A fourth aspect of the invention provides the method of producing a clathrate hydrate slurry according to the first or second aspect, further comprising a step of regulating a temperature of the refrigerant.

A fifth aspect of the invention provides the method of producing a clathrate hydrate slurry according to the fourth aspect, characterized in that the refrigerant temperature is regulated to a temperature lower than a freezing point of the clathrate hydrate and close to the freezing point or a temperature close to that of the aqueous solution or slurry flowing inside the heat transfer tube.

A sixth aspect of the invention provides an apparatus for producing a clathrate hydrate, comprising heat transfer tubes, a refrigerant-supplying device supplying a refrigerant to the outer periphery of each heat transfer tube, a raw liquid-supplying device supplying an aqueous solution of a guest compound for the clathrate hydrate or a slurry of the clathrate hydrate dispersed or suspended in an aqueous solution or water into each heat transfer tube, and a flow rate-regulating device regulating a flow rate of the aqueous solution or the slurry, the clathrate hydrate being formed in the aqueous solution or the slurry through heat exchange with the refrigerant, characterized in that the flow rate of the aqueous solution or the slurry is regulated by the flow rate-regulating device in such a manner that increase in the amount of the clathrate hydrate deposited on the heat transfer tube inner wall surface is suppressed by flow force of the aqueous solution or the slurry flowing inside the heat transfer tube.

A seventh aspect of the invention provides an apparatus for producing a clathrate hydrate, comprising heat transfer tubes, a refrigerant-supplying device supplying a refrigerant to the outer periphery of each heat transfer tube, a raw liquid-supplying device supplying an aqueous solution of a guest compound for the clathrate hydrate or a slurry of the clathrate hydrate dispersed or suspended in an aqueous solution or water into each heat transfer tube, and a flow rate-regulating device regulating a flow rate of the aqueous solution or the slurry, the clathrate hydrate being formed in the aqueous solution or the slurry through heat exchange with the refrigerant, characterized in that a flow rate of the aqueous solution or the slurry is regulated by the flow rate-regulating device in such a manner that a part of the clathrate hydrate deposited on each heat transfer tube inner wall surface is removed by flow force of the aqueous solution or the slurry and the rest is kept remained as it covers each heat transfer tube inner wall surface.

An eighth aspect of the invention provides the apparatus for producing clathrate hydrate slurry according to the sixth or seventh aspect, further comprising a turbulence-generating means generating turbulence in a flow of the aqueous solution or the slurry supplied into each heat transfer tube.

A ninth aspect of the invention provides the apparatus for producing clathrate hydrate slurry according to the sixth or seventh aspect, characterized in that at least one of the heat transfer tube inner and outer wall surface has irregularities along a flow direction of the aqueous solution or the slurry.

A tenth aspect of the invention provides the apparatus for producing clathrate hydrate slurry according to the sixth or seventh aspect, further comprising a circulating device circulating a part or all of the aqueous solution or the slurry passed through the heat transfer tube around the heat transfer tube.

An eleventh aspect of the invention provides the apparatus for producing clathrate hydrate slurry according to the sixth or seventh aspect, further comprising a refrigerant temperature-regulating device regulating a temperature of the refrigerant.

A twelfth aspect of the invention provides a method of operating an apparatus for producing clathrate hydrate slurry, comprising heat transfer tubes, a refrigerant-supplying device supplying a refrigerant to the outer periphery of each heat transfer tube, a raw liquid-supplying device supplying an aqueous solution of a guest compound for the clathrate hydrate or a slurry of the clathrate hydrate dispersed or suspended in an aqueous solution or water into each heat transfer tube, a flow rate-regulating device regulating a flow rate of the aqueous solution or the slurry, and a circulating device circulating a part or all of the aqueous solution or the slurry passed through each heat transfer tube around the heat transfer tube regularly or as needed, the clathrate hydrate being formed in the aqueous solution or the slurry through heat exchange with the refrigerant, characterized in that, on initial operation, resumption of operation after cessation or commissioning for performance test of the apparatus, a part of the clathrate hydrate deposited on each heat transfer tube inner wall surface is removed by flow force of the aqueous solution or the slurry and the rest is kept remained as it covers the heat transfer tube inner wall surface.

A thirteenth aspect of the invention provides a method of operating an apparatus for producing clathrate hydrate slurry, comprising heat transfer tubes, a refrigerant-supplying device supplying a refrigerant to the outer periphery of each heat transfer tube, a refrigerant temperature-regulating device regulating the temperature of the refrigerant, a raw liquid-supplying device supplying an aqueous solution of a guest compound for the clathrate hydrate or a slurry of the clathrate hydrate dispersed or suspended in an aqueous solution or water into each heat transfer tube, a flow rate-regulating device regulating a flow rate of the aqueous solution or the slurry, and a circulating device circulating a part or all of the aqueous solution or the slurry passed through each heat transfer tube around the heat transfer tube regularly or as needed, the clathrate hydrate being formed in the aqueous solution or the slurry through heat exchange with the refrigerant, characterized in that, on initial operation, resumption of operation after cessation or commissioning for performance test of the apparatus, the refrigerant temperature is regulated to a temperature exceeding a freezing point of the clathrate hydrate with the refrigerant temperature-regulating device, and a part of the clathrate hydrate deposited on each heat transfer tube inner wall surface is removed by flow force of the aqueous solution or the slurry and the rest is kept remained as it covers the heat transfer tube inner wall surface.

A fourteenth aspect of the invention provides a method of operating an apparatus for producing clathrate hydrate slurry, comprising heat transfer tubes, a refrigerant-supplying device supplying a refrigerant to the outer periphery of each heat transfer tube, a refrigerant temperature-regulating device regulating the temperature of the refrigerant, a raw liquid-supplying device supplying an aqueous solution of a guest compound for the clathrate hydrate or a slurry of the clathrate hydrate dispersed or suspended in an aqueous solution or water into each heat transfer tube, a flow rate-regulating device regulating a flow rate of the aqueous solution or the slurry, and a circulating device circulating a part or all of the aqueous solution or the slurry passed through each heat transfer tube around the heat transfer tube regularly or as needed, the clathrate hydrate being formed in the aqueous solution or the slurry through heat exchange with the refrigerant, characterized in that, on normal operation of the apparatus, fluctuation in the refrigerant temperature is suppressed with the refrigerant temperature-regulating device, and a part of the clathrate hydrate deposited on each heat transfer tube inner wall surface is removed by flow force of the aqueous solution or the slurry and the rest is kept remained as it covers the heat transfer tube inner wall surface.

### BRIEF DESCRIPTION OF THE SEVERAL VIEWS OF THE DRAWING

FIG. 1 is a conceptual view illustrating the process of generation of clathrate hydrate, for explanation of the principle of the present invention.

FIG. 2 is a cross-sectional view of the tube of FIG. 1, as seen in the orthogonal direction.

FIG. 3 is an enlarged view of the region indicated by circle A in FIG. 1.

FIG. 4 is a diagram showing a test device for demonstrating the principle of the present invention.

FIG. 5 is a graph showing the test results obtained in the test device shown in FIG. 4.

FIG. 6 is a graph showing the test results obtained in the test device shown in FIG. 4.

FIG. 7 is a diagram showing another test device for demonstration of the principle of the present invention.

FIG. 8 is a graph showing the test results obtained in the test device shown in FIG. 7.

FIG. 9 is a graph showing the test results obtained in the test device shown in FIG. 7.

FIG. 10 is a graph showing the test results obtained in the test device shown in FIG. 7.

FIG. 11 is a graph showing the test results obtained in the test device shown in FIG. 7.

FIG. 12 is a graph showing the test results obtained in the test device shown in FIG. 7.

FIG. 13 is a graph showing the test results obtained in the test device shown in FIG. 7.

FIG. 14 is a graph showing the test results obtained in the test device shown in FIG. 7.

FIG. 15 is a graph showing the test results obtained in the test device shown in FIG. 7.

FIG. 16 is a diagram showing the configuration of the device in embodiment 1 of the present invention.

FIG. 17 is a graph showing the relationship between the temperature of the hydrate slurry in an aqueous TBAB solution and the solid phase fraction.

FIG. 18 is a diagram showing the configuration of the device in Example 1.

FIG. 19 is a diagram showing the configuration of the device in Example 2.

FIG. 20 is a diagram showing the configuration of the device in Example 3.

FIG. 21 is a diagram showing the configuration of the device in Example 3.

FIG. 22 is a view illustrating the turbulence-generating means in Example 4.

FIG. 23 is a view illustrating another turbulence-generating means in Example 4.

FIG. 24 is a diagram of a corrugate tube, an example of the tube having irregularities on the heat transfer tube inner and outer wall surfaces in Example 5.

FIG. 25 is a diagram of a grooved tube, another example of the tube having irregularities on the heat transfer tube inner wall surface in Example 5.

FIG. 26 is a graph showing the relationship between the shape of the heat transfer tube inner surface and the heat transmission rate.

FIG. 27 is a graph showing the relationship between the shape of the heat transfer tube inner surface and the pressure drop.

FIG. 28 is a diagram showing other examples of the heat transfer tubes having irregularities on the outer wall surface in Example 5.

FIG. 29 is a diagram showing the basic principle of Example 6 of the present invention.

FIG. 30 is a diagram showing the basic principle of Example 6 of the present invention.

FIG. 31 is a diagram showing Example 7 of the present invention.

FIG. 32 is a diagram showing Example 8 of the present invention.

FIG. 33 is a graph explaining operation in Example 8 of the present invention.

### DETAILED DESCRIPTION OF THE INVENTION

The principle of the present invention will be described.

FIGS. 1 to 3 are conceptual drawings explaining the process of generating a clathrate hydrate, more specifically preparing a clathrate hydrate slurry by feeding an aqueous solution of a guest compound for clathrate hydrate (raw solution) or a slurry of the clathrate hydrate dispersed or suspended in an aqueous solution or water (raw slurry) through a heat transfer tube and allowing generation of the clathrate hydrate in the raw solution or slurry through heat exchange with a refrigerant present at the outer periphery of the heat transfer tube.

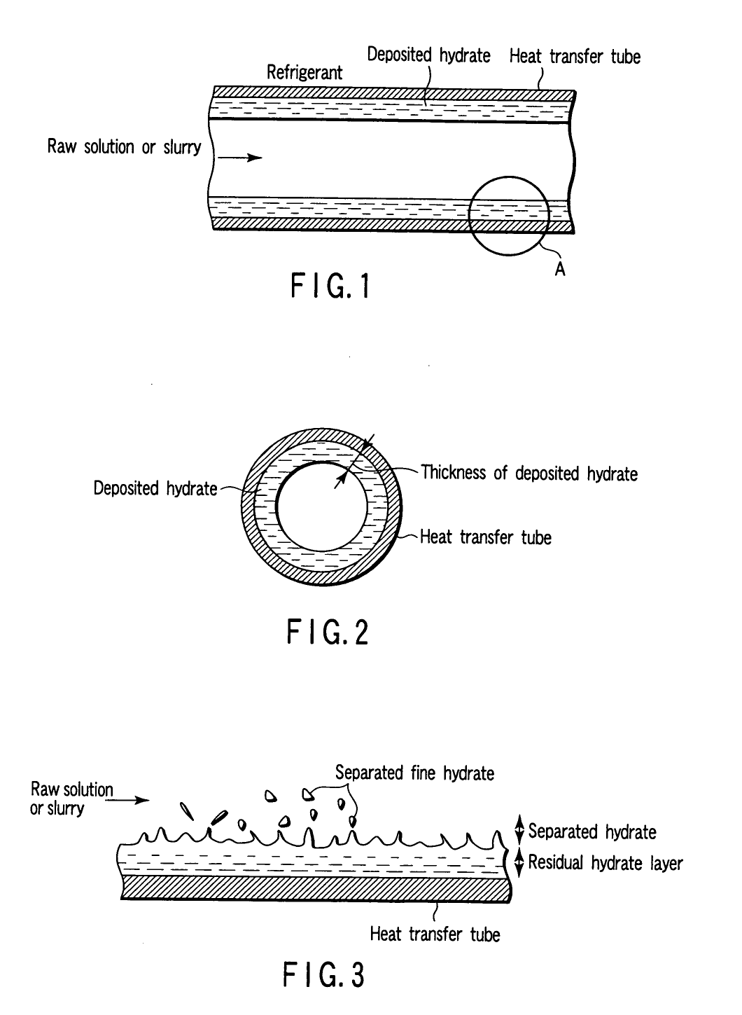

The refrigerant temperature is so regulated that the inner-wall surface temperature of the heat transfer tube becomes not higher than the freezing point of the clathrate hydrate (or hydrate generation-initiating temperature) by supplying the raw solution or slurry through a heat transfer tube. Thus, the hydrate deposits or sediments on the inner wall surface, as it is formed at the interface between the inner wall surface and the raw solution or slurry or in the raw solution close to the inner wall surface (see FIG. 1). The cooling effect of the refrigerant through the heat transfer tube is transmitted to the raw solution via the hydrate deposited or sedimented on the inner wall surface of heat transfer tube, resulting in generation of columnar or spicular hydrate crystals on the hydrate surface and also in increase of the deposition or sedimentation thickness of the clathrate hydrate (thickness in the direction from the heat transfer tube inner surface to the tube center. The same shall apply hereinafter) (see FIG. 2).

Among the hydrate crystals deposited on the heat transfer tube inner wall surface, those exposed to the raw solution or slurry become nuclei for hydrate crystallization and accelerate increase in the deposition or sedimentation thickness of the clathrate hydrate. For that reason, the thickness of the hydrate layer deposited on the inner wall surface increases gradually.

On the other hand, the increase in the deposition or sedimentation thickness of the clathrate hydrate leads to decrease of the channel sectional area in the heat transfer tube (see FIG. 2), which in turn leads to gradual increase of the flow rate of the raw solution or slurry flowing inside the heat transfer tube and also to gradual increase of the flow force of the raw solution or slurry (e.g., shearing force). Among the clathrate hydrate crystals deposited on the heat transfer tube inner wall surface, those in the raw solution or slurry or in the region more separated in the direction from the heat transfer tube inner surface toward the tube center direction (i.e., region exposed to the raw solution or slurry) are fairly soft and relatively easily separable. The degree of softness and separability varies according to various conditions (for example, temperature difference between the raw solution or slurry and the refrigerant), but the clathrate hydrate is obviously softer than ice. Therefore, among the hydrate layer crystals deposited on the inner wall surface of heat transfer tube, the hydrate crystals in the softer region, i.e., in the region exposed to the raw solution or slurry, are separated more easily by the flow force of the raw solution or slurry, but the thickness of the hydrate layer deposited on the inner wall surface still increases gradually (see FIG. 3).

Finally, the amount of the hydrate particles deposited or sedimented on the heat transfer tube inner wall surface and the amount of the hydrate particles separated from the hydrate layer deposited or sedimented become equilibrated, resulting in no or little fluctuation in the deposition or sedimentation thickness on the heat transfer tube inner wall surface.

The hydrate crystals separated from the hydrate layer deposited or sedimented on the heat transfer tube inner wall surface then are normally fine particles of approximately 50 to 100 microns, which function as nuclei for additionally hydrate crystals and thus prohibit generation of supercooled state of the raw solution or slurry. In addition, the hydrate crystals are incorporated as dispersed or suspended in the raw solution or slurry, giving a clathrate hydrate slurry as a whole.

When the deposition or sedimentation thickness of the hydrate on the heat transfer tube inner wall surface increases to a particular value or more, the cooling effect of the refrigerant through the heat transfer tube reaches the raw solution or slurry less efficiently, leading to leveling-off of the increase in thickness sooner or later. However, because of the hydrate-separating action by the flow force of the raw solution or slurry, the deposition or sedimentation thickness is kept in the range allowing the cooling effect of the refrigerant to reach the raw solution or slurry, and thus, generation of additional hydrate crystals and separation of the hydrate crystals proceeds concurrently. The additional hydrate crystals are incorporated as dispersed or suspended in the raw solution or slurry, giving a clathrate hydrate slurry as a whole.

In the present invention, in preparation of a clathrate hydrate in raw solution or slurry through heat exchange of a raw clathrate hydrate solution or slurry with a refrigerant present at the outer periphery of the heat transfer tube while supplying the raw solution or slurry through a heat transfer tube according to the principle of the present invention, increase in the amount of the clathrate hydrate deposited on the heat transfer tube inner wall surface is suppressed by the flow force of the raw solution or slurry flowing inside the heat transfer tube. More specifically, a part of the clathrate hydrate crystals deposited on the heat transfer tube inner wall surface (the soft and easily separable region facing the raw solution or slurry or closer to the tube center of the heat transfer tube) is separated or scraped off by the shearing or other force of the flow of raw solution or slurry, and the other is preserved, as the crystals cover the heat transfer tube inner wall surface.

Therefore, the present invention has the following functions and effects.

(a) Because the deposition or sedimentation thickness of the clathrate hydrate remaining on the heat transfer tube inner wall surface does not exceed (hits the ceiling at) a particular level that is determined by the balance with the flow strength of the raw solution or slurry, it is possible to keep the cooling effect of the heat exchanger in a range favorable for generation of the clathrate hydrate in the raw solution or slurry.
(b) The clathrate hydrate separated by the flow force of the raw solution or slurry is dispersed or suspended in the raw solution or slurry. Therefore, it is possible to prepare a clathrate hydrate slurry at a clathrate hydrate content or at a solid phase fraction higher than that of the original raw solution or slurry.
(c) Because the clathrate hydrate remaining as deposited on the heat transfer tube inner wall surface functions as a product nucleus, it is possible to form additional clathrate hydrate crystals easily.
(d) When the raw slurry is supplied into the heat transfer tube, it is possible to form additional clathrate hydrate crystals easily, because the clathrate hydrate present in the original raw slurry functions as a product nucleus.
(e) The clathrate hydrate separated from the heat transfer tube becomes a product nucleus for additional clathrate hydrate and function as a supercooling-suppressing agent as it is dispersed or suspended in the supercooled raw solution or slurry during passage through the heat transfer tube, it is possible to increase the clathrate hydrate content or the solid phase fraction in the clathrate hydrate slurry further, even after passage through the heat transfer tube.

It is thus possible to produce the clathrate hydrate slurry continuously over an extended period of time stably.

As described above, for control of the performance and capacity of the apparatus for producing clathrate hydrate slurry or the production capacity of the clathrate hydrate slurry, it is important to regulate and control the deposition or sedimentation thickness of the clathrate hydrate remaining on the heat transfer tube inner wall surface.

It is possible to regulate or control the deposition or sedimentation thickness, by modification of the flow force of the raw solution or slurry or of a parameter relevant to the force. Typical examples of the parameter(s) include flow rate (i.e., the flow rate of the raw solution or slurry per unit time divided by the sectional area of heat transfer tube), the material and dimension of the heat transfer tube, the heat exchange capacity of the heat exchanger, the concentration of the raw solution, freezing point (hydrate generation-initiating temperature), the viscosity and temperature of the raw solution or slurry, the pressure drop of the raw solution or slurry during passage through the heat transfer tube, the temperature and flow of the refrigerant present at the outer periphery of the heat transfer tube, and the like.

Among the parameters above, there are parameters previously determined when production of the clathrate hydrate slurry is initiated (e.g., dimension and material of heat transfer tube) and those undetermined. For production of the clathrate hydrate slurry stably over an extended period of time, it is preferable to use a parameter that is easily regulated or controlled during operation of the apparatus for producing clathrate hydrate slurry. Thus, flow rate is most favorable as the parameter. It is because, even if the parameters other than the flow rate fluctuate during production of the clathrate hydrate slurry, it is often possible to regulate or control the deposition or sedimentation thickness of the clathrate hydrate remaining on the heat transfer tube inner wall surface and also the performance and capacity of the apparatus for producing clathrate hydrate slurry or the production capacity of the clathrate hydrate slurry, by regulating or controlling the flow rate depending on the fluctuation.

It is also effective to select at least one of the temperature of refrigerant and the temperature of raw solution or slurry as the parameter and regulate or control it, for regulation or control of the generation amount of the clathrate hydrate and the deposition amount on the heat transfer tube inner wall surface. In such a case, it is more preferable to regulate or control the temperature of the refrigerant than to regulate or control the temperature of the raw solution or slurry, because the method is more sensitive to and faster in response to the generation amount of the clathrate hydrate and the deposition amount on the heat transfer tube inner wall surface and it is also possible to simplify actual production apparatus.

The inner wall surface of heat transfer tube may be covered with the clathrate hydrate entirely or partially in the tube axial direction, but the clathrate hydrate deposited and remained on the inner wall surface is preferably uniform, from the viewpoint of the stability during clathrate hydrate slurry production.

Practically, thick deposition of the clathrate hydrate over a wide region on the heat transfer tube inner wall surface may lead to increase in the pressure drop of the raw solution or slurry flowing inside the tube and also in the pump power needed for supply thereof, and consequently to increase of the cost for the apparatus and facility. It is possible to evaluate the allowable range of fluctuation of the parameter empirically or based on reasonable assumption, taking the economical point into consideration, by modifying the parameter for stabilized long-term production of the clathrate hydrate slurry. In the process or as a result of the evaluation above, it is also possible to determine the favorable ranges of the deposition or sedimentation thickness of the clathrate hydrate on the heat transfer tube inner wall surface and of the area covered therewith, empirically or based on reasonable assumptions.

Hereinafter, functions and effects in embodiments of the present invention will be described.

In the first embodiment of the present invention, it is possible to obtain the functions and effects (a) to (e) and to produce the clathrate hydrate slurry continuously over an extended period of time stably, because increase in the amount of the clathrate hydrate deposited on the heat transfer tube inner wall surface in the process of heat exchange with the refrigerant is suppressed by the flow force of the raw solution or slurry flowing inside the heat transfer tube.

In the second embodiment of the present invention, it is possible to obtain the functions and effects (a) to (e) and to produce the clathrate hydrate slurry continuously over an extended period of time stably, because a part of the clathrate hydrate deposited on the heat transfer tube inner wall surface is separated by the flow force of the raw solution or slurry and the rest of the clathrate hydrate is left as it covers the heat transfer tube inner wall surface in the process of heat exchange with the refrigerant.

In the second embodiment of the present invention, it is possible to obtain the function and effect (c) distinctively, because the crystallization nuclei of the clathrate hydrate are distributed widely over the heat transfer tube inner wall surface, giving an environment favorable for clathrate hydrate generation in the heat transfer tube.

In the third embodiment of the present invention, it is possible to obtain the functions and effects (a) to (e) and to produce the clathrate hydrate slurry continuously over an extended period of time stably and additionally to obtain the following functions and effects (f) and (g).

(f) Because a part or all of the aqueous solution or slurry passed through the heat transfer tube is resupplied into the heat transfer tube as the raw solution or slurry, it is possible to raise the clathrate hydrate content or the solid phase fraction in the clathrate hydrate slurry after each circulated liquid flow.
(g) It is possible, after each liquid circulation, to deposit and sediment the clathrate hydrate over a wider area of the heat transfer tube inner wall surface originally having no or only a small amount of clathrate hydrate or having unevenly deposited clathrate hydrate. Even if the clathrate hydrate is separated from the heat transfer tube inner wall surface carrying the clathrate hydrated originally deposited or sedimented, it is possible, after each liquid circulation, to deposit the clathrate hydrate once again on the separated region and finally to recover the separated region to the state with the clathrate hydrate uniformly deposited. Therefore, it is possible produce the clathrate hydrate slurry continuously over an extended period of time stably.

The functions and effects (f) and (g) are obviously beneficial, because it is possible to bring the production apparatus into the stabilized operation state sooner during initial operation, resumption of operation after break, and commissioning for performance test of the apparatus for producing clathrate hydrate slurry (see the 12th to 14th embodiments of the present).

The force by the flow of raw solution is generated only by action of the raw solution, while the force by the flow of raw slurry is generated by action of both the aqueous solution and the hydrate fine particles in the raw slurry. For that reason, the following function and effect (h) is obtained.

(h) It is possible to raise the separation efficiency, by circulating a part or all of the clathrate hydrate slurry containing the hydrate dispersed or suspended in the raw solution or the raw slurry into the heat transfer tube as the raw slurry.

When the concentration of the hydrate fine particles in the raw slurry is high, and thus when the viscosity of the raw solution is high, the separation force is applied in the direction toward increase of the channel cross-sectional area in the heat transfer tube and thus toward suppression of the increase in the pressure drop when the liquid passes through the heat transfer tube. Thus in the third embodiment of the present invention, it is possible to suppress the increase in the pressure drop when the liquid passes through the heat transfer tube and thus, to avoid drastic deterioration in operational state of the apparatus for producing clathrate hydrate slurry and to produce the clathrate hydrate slurry stably.

During production of the clathrate hydrate slurry, the temperature of the refrigerant present at the outer periphery of the heat transfer tube fluctuates depending on the change of the freezing capacity of the refrigerator cooling the refrigerant and also according to the balance between the freezing capacity of refrigerator and the cooling load at the heat-consuming side. The fluctuation in refrigerant temperature exerts influences on the amount of the clathrate hydrate generated by heat exchange through the heat transfer tube and the deposition amount thereof on the heat transfer tube inner wall surface, making it difficult to produce the clathrate hydrate slurry continuously over an extended period of time stably.

In contrast, in the fourth embodiment of the present invention, it is possible to control the amount of the clathrate hydrate generated in the heat transfer tube and the deposition amount thereof on the heat transfer tube inner wall surface by regulating the refrigerant temperature, more specifically by controlling the fluctuation in refrigerant temperature or alternatively by using the fluctuation more positively, and thus, it is possible to produce the clathrate hydrate slurry continuously over an extended period of time stably without such problems.

The operation “to regulate the amount of the clathrate hydrate generated in the heat transfer tube and the deposition amount thereof on the heat transfer tube inner wall surface by controlling the fluctuation in refrigerant temperature more positively” includes an operation “to melt at least a part of the clathrate hydrate sediment deposited on the heat transfer tube inner wall surface in a short period of time by making the refrigerant temperature exceeding the freezing point of the clathrate hydrate, separate and remove it by the force of the raw solution or slurry, and thus, eliminate or reduce the deposition amount significantly”. Such an operation is needed to bring the inner wall surface back to the initial state (i.e., state without or with little clathrate hydrate deposited) and useful for initialization or reset of the apparatus for producing clathrate hydrate slurry, when the deposition or sedimentation state of the clathrate hydrate on the heat transfer tube inner wall surface is undesirable for some reason.

In the fifth embodiment of the present invention, it is possible to suppress the increase in the amount of the clathrate hydrate deposited on the heat transfer tube inner wall surface more effectively by the flow force of the raw solution or slurry flowing inside the heat transfer tube, because the refrigerant temperature is regulated to a temperature lower than the freezing point of the clathrate hydrate and close to the freezing point, or a temperature close to that of the aqueous solution or the slurry fed into the heat transfer tube, i.e., a temperature lower than the freezing point of the clathrate hydrate but higher as much as possible. This will be described below in detail.

When the increase in the amount of the clathrate hydrate deposited in the heat transfer tube is controlled only by the flow force of the raw solution or slurry flowing inside the heat transfer tube, a high-output liquid-supplying pump should be used. However, it is also possible to suppress the increase by regulating the refrigerant temperature. Specifically, it is possible to reduce the cooling degree of the raw solution or slurry in contact with the heat exchange surface of the heat transfer tube (specifically, supercooling degree), by regulating the refrigerant temperature to a temperature lower than the freezing point of the clathrate hydrate and close to the freezing point or a temperature close to that of the aqueous solution or the slurry fed into the heat transfer tube, i.e., a temperature lower than the freezing point of the clathrate hydrate but higher as much as possible. It leads to increase of the rate of voids (aqueous solution content) in the deposition layer of the hydrate generated as cooled on the heat exchange surface of the heat transfer tube, giving a hydrate deposition layer softer and easily separable by the flow force of the raw solution or slurry.

On the other hand, regulation of the refrigerant temperature to a temperature lower than the freezing point of the clathrate hydrate but higher as much as possible may lead to decrease in heat exchange capacity and thus in hydrate slurry-producing capacity, but it also lead to decrease in the hydrate deposition thickness and thus, the thermal resistance during heat exchange, so that it is possible to suppress deterioration in the capacity of cooling the raw solution or slurry and preserve the production capacity for the hydrate slurry.

As a result, the thickness of the clathrate hydrate deposited on the heat transfer tube inner wall surface becomes smaller on the whole. Accordingly, the fifth embodiment of the present invention has functions and effects that it is possible to reduce the flow rate of the raw solution or slurry and thus to reduce the output of the liquid-supplying pump, use a smaller pump, or reduce energy consumption.

Because regulation of the refrigerant temperature to a temperature lower than the freezing point of the clathrate hydrate and close to the freezing point or a temperature close to that of the aqueous solution or slurry flowing inside the heat transfer tube leads to decrease in power consumption of the refrigerator supplying the refrigerant, it is possible to improve the COP of the hydrate slurry production system.

As described above, it is possible to suppress the increase of the clathrate hydrate deposited on the heat transfer tube inner wall surface with the flow force of the raw solution or slurry more effectively, by regulating the refrigerant temperature to a temperature lower than the freezing point of the clathrate hydrate and close to that of the aqueous solution or slurry flowing inside the heat transfer tube. Decrease in the temperature difference between the refrigerant and the raw solution or slurry results in deterioration in the heat transfer efficiency, and thus, the refrigerant temperature is preferably lower by 1 to 4° C. than the temperature of the raw solution or slurry.

The sixth embodiment of the present invention realizes an apparatus for producing clathrate hydrate slurry by the production method in the first embodiment of the present invention.

The seventh embodiment of the present invention realizes an apparatus for producing clathrate hydrate slurry by the production method in the second embodiment of the present invention.

In the eighth embodiment of the present invention, it is possible to generate turbulence in the flow of the raw solution or slurry supplied into the heat transfer tube with a turbulence-generating means, and thus, to suppress the increase in the amount of the clathrate hydrate deposited on the heat transfer tube inner wall surface more reliably with the turbulent flow force and produce the clathrate hydrate slurry continuously over an extended period of time stably.

Even when the flow rate of the raw solution or slurry flowing inside the heat transfer tube is lowered than that when there is no turbulence-generating means, it is possible to suppress the increase in the amount of the clathrate hydrate deposited on the heat transfer tube inner wall surface with the flow force and preserve the favorable heat exchange efficiency of the heat transfer tube. It is thus possible to reduce the load applied to the pumping apparatus for feeding the raw solution or slurry relatively.

It is also possible to reduce the deposition amount of the clathrate hydrate on the heat transfer tube inner wall surface, leading to decrease of the thermal resistance derived from the deposited clathrate hydrate and increase in the heat transfer efficiency and quantity from the refrigerant to the raw solution or slurry, which in turn lead to decrease of the heat transfer surface area (number of heat transfer tubes).

In addition, the turbulence generated in the flow of the raw solution or slurry flowing inside the heat transfer tube leads to improvement of the heat transfer efficiency from the refrigerant to the raw solution or slurry, consequently to improvement in the production capacity of the clathrate hydrate slurry.

In the ninth embodiment of the present invention, the heat transfer surface area of the heat transfer tube is enlarged for improvement in the heat transfer efficiency from the refrigerant to the raw solution or slurry, which in turn leads to improvement of the production capacity of the clathrate hydrate slurry, so that the production capacity of the clathrate hydrate slurry is improved.

Moreover, even when the flow rate of the raw solution or slurry flowing inside the heat transfer tube is raised than that when there is no irregularity on the heat transfer tube, the heat exchange efficiency of heat transfer tube is preserved. It is thus possible to suppress the increase in the amount of the clathrate hydrate deposited on the heat transfer tube inner wall surface by the flow force more reliably and produce the clathrate hydrate slurry continuously over an extended period of time stably.

It is also possible to generate additional clathrate hydrate more easily, because the generated clathrate hydrate easily deposits and remains in the recesses formed on the heat transfer tube inner wall surface in the flow direction of the raw solution or slurry and the residual clathrate hydrate functions as a product nucleus. Accordingly, even when the refrigerant temperature is set to a temperature exceeding that when there is no irregularity formed on the heat transfer tube, it is possible to produce the clathrate hydrate slurry stably, because the clathrate hydrate functioning as a product nucleus remains as deposited in the dents. It is thus possible to produce the clathrate hydrate slurry even at an elevated refrigerant temperature, relatively reducing the load on the refrigeration system for the refrigerant or improving the performance coefficient of the refrigerator.

The tenth embodiment of the present invention realizes an apparatus for producing clathrate hydrate slurry by the production method in the third embodiment of the present invention.

The eleventh embodiment of the present invention realizes an apparatus for producing clathrate hydrate slurry by the production method in the fourth embodiment of the present invention.

Combined use of the circulating device in the tenth embodiment and the refrigerant temperature-regulating device in the eleventh embodiment is advantageous for operational control of the production apparatus, because it allows accurate adjustment of the amount of the clathrate hydrate deposited or the sedimentation thickness thereof on the heat transfer tube inner wall surface.

It is possible, by using the refrigerant temperature-regulating device, to melt at least part of the clathrate hydrate sediment deposited on the heat transfer tube inner wall surface in a short period of time, and separate and remove it by the force of the raw solution or slurry, and eliminates or reduces the deposition amount drastically, by making the refrigerant temperature exceeding the freezing point of the clathrate hydrate. Such an operation is needed to bring the inner wall surface back to the initial state (i.e., to the state without or with little clathrate hydrate deposited) and useful for initialization or reset of the apparatus for producing clathrate hydrate slurry, when the deposition or sedimentation state of the clathrate hydrate on the heat transfer tube inner wall surface is undesirable for some reason.

As for the state of the heat transfer tube inner wall surface in the apparatus for producing clathrate hydrate slurry, it is not possible to accurately determine whether the clathrate hydrate is deposited or whether it is deposited uniformly, because there may be completely no or little clathrate hydrate deposited during initial operation of the apparatus for producing clathrate hydrate slurry, there may be only uneven deposition or sedimentation of the clathrate hydrate, as a part or all of the clathrate hydrate once deposited is separated by melting, during resumption of operation after break, and the operation condition may fluctuate during commissioning for performance test.

Therefore, in the twelfth embodiment of the present invention, it is possible to bring the production apparatus into a stabilized operation state sooner by the functions and effects (f) and (g), by removing part of the clathrate hydrate deposited on each heat transfer tube inner wall surface by the flow force of the aqueous solution or the slurry, leaving the rest of hydrate as it covers each heat transfer tube inner wall surface, and circulating a part or all of the raw solution or slurry passed through the heat transfer tube, regularly or as needed, into the heat transfer tube, during initial operation of the apparatus for producing clathrate hydrate slurry, resumption of operation after cessation or commissioning for performance test. It also has the function and effect (h).

The state of each heat transfer tube inner wall surface in heat transfer tubes is not identical and rather different in each heat transfer tube. It is necessary in this case to produce the clathrate hydrate slurry stably, by depositing the clathrate hydrate uniformly on the inner wall surface of as many heat transfer tubes as possible. Thus, the third, tenth and twelfth embodiments of the present invention, by which it is possible to deposit the clathrate hydrate uniformly on the heat transfer tube inner wall surface by circulation of the raw solution or slurry, are particularly advantageous when the apparatus for producing clathrate hydrate slurry has heat transfer tubes.

The thirteenth embodiment of the present invention has functions and effects similar to those in the twelfth embodiment. In addition, in the thirteenth embodiment, it is possible to regulate the refrigerant temperature with a refrigerant temperature-regulating device attached to the apparatus for producing clathrate hydrate slurry and to regulate the amount of the clathrate hydrate generated in the heat transfer tube and the deposition amount on the heat transfer tube inner wall surface, by regulation of the refrigerant temperature, more specifically by suppressing of fluctuation in the refrigerant temperature or by controlling the fluctuation positively, and thus, it is possible to specify the condition for normal operation and complete initial operation of the apparatus, resumption of operation after cessation or commissioning for performance test sooner or more efficiently than in the case of the twelfth embodiment.

The “normal operation” in the present invention is an operation in which the performance and capacity of the production apparatus or the production capacity of the clathrate hydrate slurry is kept at a particular value or in a particular range, not so much independent on the period of continuous operation, during continuous operation after initiation of the apparatus for producing clathrate hydrate slurry.

Further in the thirteenth embodiment of the present invention, combined use of the circulating device and the refrigerant temperature-regulating device allows fine regulation of the deposition or sedimentation thickness of the clathrate hydrate on the heat transfer tube inner wall surface, giving an advantage in operational control of the apparatus for producing clathrate hydrate slurry.

The refrigerant temperature-regulating device melts at least a part of the clathrate hydrate sediment deposited on the heat transfer tube inner wall surface in a short period of time by making the refrigerant temperature exceeding the freezing point of the clathrate hydrate, separates and removes it by the force of the raw solution or slurry, and eliminates or reduces the deposition amount drastically. As described above, such operation is effective for initialization or reset of the apparatus for producing clathrate hydrate slurry, and it is particularly important as an operation to bring the heat transfer tube inner wall surface into the initial state for revision of previously set conditions for initial operation of the production apparatus, resumption of operation after cessation, commissioning for performance test and other operational situation, in which there is a need for early settlement and decision, by trial and error, of the conditions necessary for normal operation.

In the fourteenth embodiment of the present invention, because it is possible to control the refrigerant temperature with the refrigerant temperature-regulating device even during normal operation after initial operation of the apparatus for producing clathrate hydrate slurry, resumption of operation after cessation or commissioning for performance test, it is possible to produce the clathrate hydrate slurry continuously over an extended period of time stably by regulation of the refrigerant temperature similarly to the fourth, fifth and eleventh embodiments.

The following tests were conducted to demonstrate the principle of the present invention.

### [Single Duplex Tube Test]

For control of the amount of the hydrate deposited on the heat transfer tube inner wall surface by the flow force of the raw solution or slurry, the flow rate of the raw solution or slurry was selected as a parameter relevant to the flow force, and an experiment for examining the relation between the flow rate of the slurry flowing inside the heat transfer tube and the hydrate deposition thickness was performed under varying flow rate by using a double-tube heat exchanger corresponding to a shell-and-tube heat exchanger.

### <Test Device>

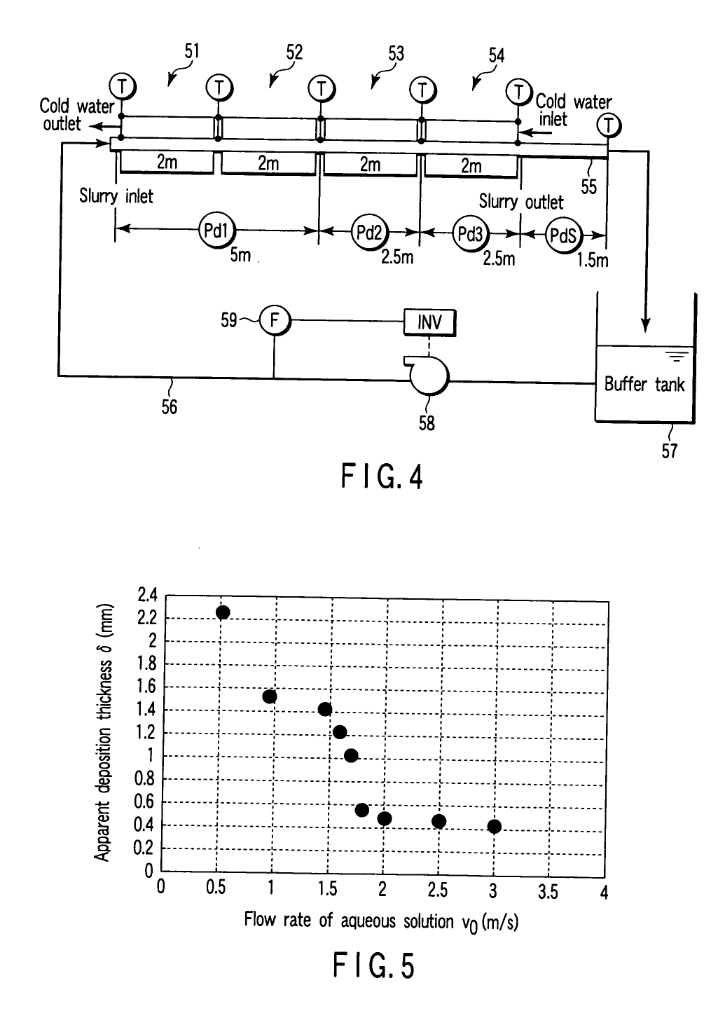

FIG. 4 is a chart illustrating the test device.

Used was a double-tube heat exchanger having a straight SUS304 tube (commercially available SUS tube without tube surface finishing) having an inner diameter φ of 15 mm, an outer diameter φof 18 mm, and a length of 2.5 m inserted in SUS tubes having an inner diameter φ of 28 mm and a length of 2 m.

As shown in FIG. 4, the test device has four double-tube heat exchangers 51 to 54 connected to each other in series and additionally a SUS straight tube having a length of 1.5 m (inner diameter φ: 15 mm, outer diameter φ: 18 mm) located at one end (downstream side) as a non-cooling region 55.

A thermometer for measurement of the inner-tube temperature is installed at each connecting region between the four double-tube heat exchangers 51 to 54 and also at each terminal of the test device.

There is also a thermometer installed at the terminal of the non-cooling region 55. A circulation channel 56 for flow of the raw solution or slurry was formed with the inner tubes of the double-tube heat exchangers 51 to 54. A buffer tank storing the raw solution or slurry 57, a circulation pump with inverter circulating the raw solution or slurry 58, and a flowmeter determining the flow rate of the raw solution or slurry flowing in the circulation channel 56 were installed, as connected to the circulation channel 56.

In addition, refrigerant cold water was designed to be supplied into the circular space between the inner and outer tubes in the double-tube heat exchangers 51 to 54.

An aqueous tetra-n-butylammonium bromide (TBAB) solution at a concentration of 23 wt % was used as the raw solution (aqueous clathrate hydrate solution). The hydrate generation-initiating temperature of the aqueous TBAB solution is approximately 10° C. The temperature of the cold water used as the refrigerant was 6 to 7° C.

### <Test Method>

In the test device having the configuration described above, the raw solution was fed by the circulation pump 58 from the buffer tank 57 into the inner tubes of the double-tube heat exchangers 51 to 54 at a previously set flow rate, while the cold water (6 to 7° C.) was supplied in the direction countercurrent to the aqueous solution, cooling the raw solution in the inner tubes.

The hydrate was formed as the raw solution was cooled, giving a hydrate slurry at approximately 8.6° C. at the outlet. Generation of the hydrate is accompanied with increase in the pressure difference at the measurement regions (Pd1 to Pd3). The flow rate of the raw solution or slurry was regulated by modifying the pump rotational frequency, and the maximum pressure difference then was determined.

The flow rate in the inner tube was determined by dividing the flow rate by the cross-sectional area in the same.

The thickness of the hydrate deposited on the tube inner wall (apparent deposition thickness) is calculated from the value obtained by subtracting the pressure difference in the non-cooling region PdS (equivalent to the pressure drop by the hydrate slurry) from the measured pressure difference in the measurement region, i.e., from the increase in the pressure difference caused by the change in inner diameter by hydrate deposition. Specifically, it is calculated in the following manner: When a fluid passes through a tube, it is known that the pressure drop in the tube is proportional with the square of the flow rate and inversely proportional with the tube inner diameter. Thus, the apparent deposition thickness 6 was calculated according to the following Formula.

Pd3₁′/Pd3₀={v₁²/(D−2δ)}/(v₀²/D)

where

suffix 0: when the liquid (aqueous solution) is fed first

suffix 1: after hydrate deposition

v: flow rate

D: inner-tube inner diameter

δ: apparent deposition thickness

Pd3: pressure difference between the inlet and the outlet of double-tube heat exchanger 54

Pd3₁′: pressure drop in tube, excluding the slurry pressure drop in double-tube heat exchanger 54

Pd3₁′ is determined according to the following Formula:

Pd3₁′=Pd3₁−(PdS₁−PdS₀)×2.5/1.5

### <Test Result>

### (1) Relationship Between the Apparent Deposition Thickness of Clathrate Hydrate and the Flow Rate

The pressure drops were determined at varied flow rates, and the apparent hydrate deposition thickness was calculated according to the Formula above. FIG. 5 is a plot showing the calculation results. In the graph of FIG. 5, the apparent deposition thickness 6 was plotted along ordinate, while the flow rate of the raw solution (when aqueous solution) along abscissa. As shown in the graph of FIG. 5, increase in flow rate resulted in decrease in deposition thickness. As obvious, increase in flow rate up to 1.8 m/s obviously lead to drastic decrease in deposition thickness, but further increase thereof did not cause significant change and lead to almost constant deposition thickness.

The results suggest that it is possible to suppress the increase in the amount of the hydrate deposited on the cooled surface heat exchanger by regulating the flow rate of the raw solution or slurry on the cooled surface to 1.8 m/s or more.

### (2) Change in Apparent Deposition Thickness Clathrate Hydrate and Thermal Transmittance Over Time

The change over time of the pressure difference caused by the change in inner diameter by hydrate deposition when the flow rate of the raw solution was set to 1.8 m/s (pressure difference after removal of the slurry pressure drop from the measured pressure difference) and the change over time of the thermal transmittance during heat transfer of the heat inputted by cold water were obtained.

The test condition is as follows:

Raw solution flow rate: 1.8 m/s

Cold water inlet temperature: 6.4° C.

Cold water outlet temperature: 6.7° C.

Raw solution inlet temperature: 8.9° C.

Hydrate slurry outlet temperatures: 8.6° C.

Heat density: 16.6 Mcal/m³

The pressure difference P due to the change in inner diameter caused by hydrate deposition (pressure difference per meter excluding the slurry pressure drop) and the thermal transmittance K1 were calculated according to the following Formulae.

P=(Pd1+Pd2+Pd3)/(5+2.5+2.5)−(PdS−PdS₀)/1.5

K1=Q/AΘ=Cp·ρ·u(To−Ti)/πDLΘ

where

suffix 0 of Pdn and PdS: when liquid (aqueous solution) is fed first

without suffix: after hydrate deposition

Q: heat input

A: heat transfer surface area

Cp: specific heat of water

ρ: density of water

u: flow rate of cold water

To: cold water exit temperature

Ti: cold water inlet temperature

D: inner-tube inner diameter

L: heat transfer length

Θ: aqueous solution temperature difference

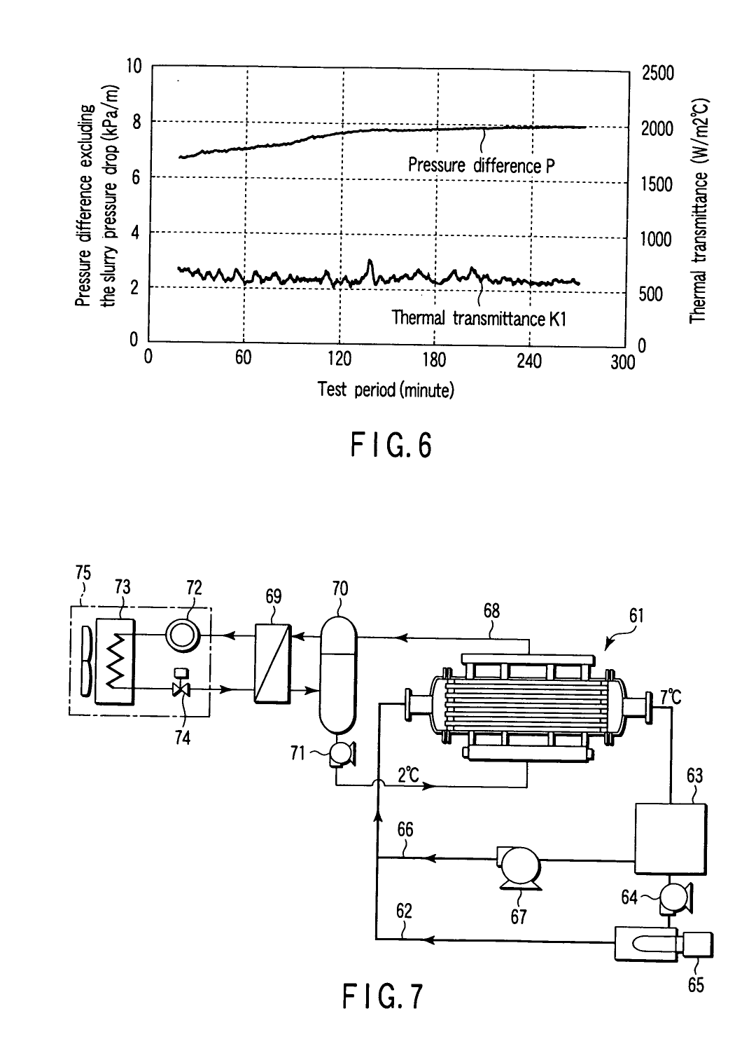

FIG. 6 is a graph showing the calculation results. The ordinate in the left side of FIG. represents the pressure difference by the change in inner diameter caused by hydrate deposition (pressure difference excluding the slurry pressure drop); the ordinate in the right side of FIG. represents the thermal transmittance; and the abscissa represents the test period.

As obvious from the graph shown in FIG. 6, the change in pressure drop of the heat exchanger tube over time is almost constant, indicating that it is possible to suppress the increase of the pressure drop. In addition, the thermal transmittance is also almost constant, indicating that it is possible to suppress the increase in the amount of the hydrate deposited on the heat-transfer surface and increase in thermal resistance.

As described above, it was demonstrated that it is possible to suppress deposition of the hydrate on the heat-transfer surface by regulating the flow rate of the raw solution or slurry passing through the heat exchanger to 1.8 m/s or more.

### [Test by Using Shell-and-Tube Heat Exchanger]

Hereinafter, a test performed for production of a hydrate slurry by cooling a raw solution or slurry with a Fleon refrigerant by using a shell-and-tube heat exchanger will be described.

### <Description of Test Device>

FIG. 7 is a schematic view showing the configuration of the test device.

The shell-and-tube heat exchanger is a one-pass heat exchanger having 27 SUS304 tubes having an outer diameter of 17.3 mm and an inner diameter of 14 mm placed in a shell of a SUS304 steel tube having a nominal diameter of 150 A. The raw solution or slurry flows in the tube, while the refrigerant flows in the shell side of the heat exchanger.

The circulation channel 62 circulating the raw solution or slurry into the tube of the shell-and-tube heat exchanger 61 has a tank 63 storing the raw solution or slurry (the raw solution is previously stored when experiment is started), a circulation pump 64 placed downstream side of the tank 63, and an electric heater for simulated loading 65 placed at the outlet side of the circulation pump 64.

The tank 63 has a cooling coil (not shown in the figure) installed therein; a hydrate slurry for seed crystallization is added thereto for elimination of the supercooled state of the raw solution fed from the heat exchanger.

The temperature of the raw solution or slurry supplied to the heat exchanger inlet is so controlled that the test is performed at a constant temperature, while the hydrate slurry fed from the tank 63 is heated to compensate the cold heat by the electric heater for simulated loading 65.

In addition, there is a recirculation channel 66 formed, connecting the tank 63 to a site downstream side of the electric heater 65 on the circulation channel 62, and there is a recirculation pump 67 installed on the recirculation channel 66.

The flow rate of the raw solution or slurry fed into the shell-and-tube heat exchanger 61 is controlled by inverters connected to the recirculation pump 67 and the circulation pump 64, as the rotational frequency of the pumps is regulated in a certain range.

A Fleon refrigerant R134a is supplied via a refrigerant circuit 68 into the shell side of the shell-and-tube heat exchanger 61. There are a refrigerant heat exchanger 69, a gas-liquid separator 70, and a refrigerant pump 71 installed on the refrigerant circuit 68. A Fleon refrigerant R404a previously cooled in a refrigerator unit 75 equipped with a compressor 72, a condenser 73, and an expansion valve 74 is sent to the refrigerant heat exchanger 69, heat-exchanging with the refrigerant R134a.

A refrigerant liquid at approximately 2° C. is fed into the shell from the gas-liquid separator 70 by the refrigerant pump 71, and the raw solution or slurry in the tube is cooled by vaporization of a part of the refrigerant liquid in the shell. The vaporized refrigerant gas and the refrigerant liquid are fed back to the gas-liquid separator 70. The R134a refrigerant gas separated in gas-liquid separator 70 is sent to the refrigerant heat exchanger 69, where it is cooled and condensed into a liquid refrigerant and fed back to the gas-liquid separator 70.

### <Test Method>

An aqueous TBAB solution at a concentration of 14.4 wt % was used as the raw solution in the present experiment. The hydrate generation-initiating temperature of the aqueous TBAB solution is approximately 8° C.

The raw solution or slurry is circulated in the circulation channel 62 and the recirculation channel 66 at particular flow rates, while the inverters for the recirculation pump 67 and the circulation pump 64 are regulated, and the refrigerant is then fed into the shell-and-tube heat exchanger 61, while the refrigerator unit 75 and the refrigerant pump 71 are activated, cooling the raw solution or slurry in the tube.

The refrigerant temperature in the shell is kept constant, as the compressor 72 in the refrigerator unit 75 is regulated. After the temperature of the raw solution passed through the outlet of the shell-and-tube heat exchanger 61 becomes 7° C. or lower in the supercooled state, a hydrate slurry separately prepared is fed into the tank 63, to eliminate supercooling.

Subsequently, the hydrate slurry temperature at the outlet of the shell-and-tube heat exchanger 61 and the pressure drop in the heat exchanger tube (difference in pressure between heat exchanger outlet and inlet) are monitored, while the refrigerant temperature and the flow rate of the raw solution or slurry are kept constant.

The sum of the input power to the electric heater for simulated loading 65, which is regulated to keep the temperature of the raw solution or slurry flowing into the shell-and-tube heat exchanger 61 constant, and the heat released in respective pumps corresponds to the cold heat held in the generated hydrate slurry, and thus, the production capacity for the hydrate slurry is determined by measuring these values.

The solid phase fraction SPF of the hydrate slurry (rate of hydrate in hydrate slurry) is determined from the hydrate slurry temperature at the outlet of the shell-and-tube heat exchanger 61.

### <Test Results 1>

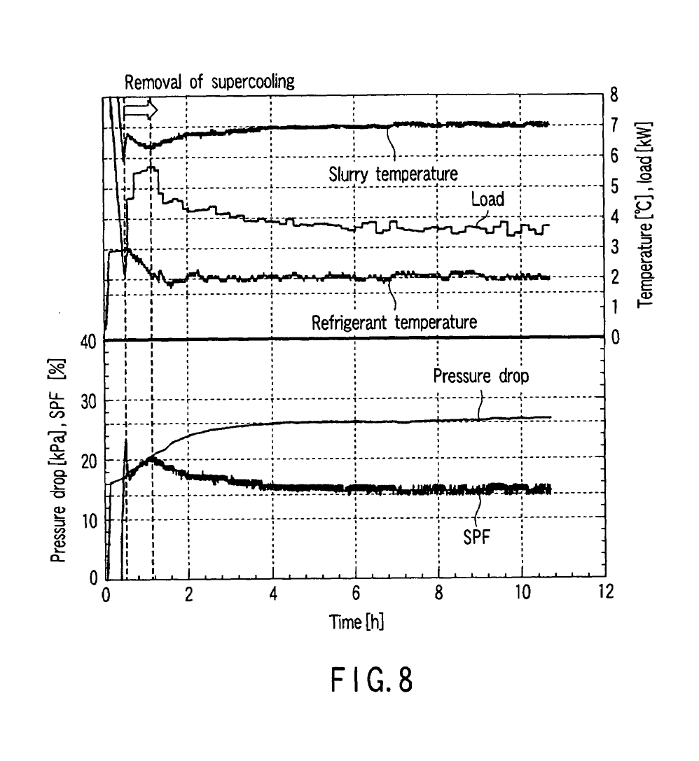

A raw solution or slurry was fed into a shell-and-tube heat exchanger 61, and the change in various data over time was determined. FIG. 8 is a graph showing the test results when the flow rate of the raw solution or slurry flowing in the shell-and-tube heat exchanger 61 was set to 450 L/min (flow rate in tube: 1.8 m/s).

In FIG. 8, the time is plotted on abscissa; the tube pressure drop of the shell-and-tube heat exchanger 61 and the solid phase fraction of the hydrate slurry SPF, on left ordinate; and the hydrate slurry temperature at the outlet of the shell-and-tube heat exchanger 61, the refrigerant temperature at the heat exchanger inlet, and the load of the simulatory loading heater, on right ordinate.

After removal of supercooling, the refrigerant temperature at the inlet of the shell-and-tube heat exchanger 61 was kept at approximately 2° C. and the hydrate slurry temperature at the outlet of the shell-and-tube heat exchanger 61 at 7° C., indicating that the test was performed under a consistent test condition.

After removal of supercooling, the tube pressure drop in the shell-and-tube heat exchanger 61 gradually increased, indicating that the hydrate deposition thickness on the tube inner wall surface increased, to an almost constant value of 26 kPa after 4 hours, indicating that the increase in hydrate deposition thickness was restricted.

After removal of supercooling, the load on the simulated loading heater decreased gradually, to an almost constant value of 3.6 kW after operation for 4 hours, indicating that a hydrate slurry having a particular cold heat was produced stably.

The solid phase fraction SPF of the hydrate slurry also reached an almost constant value of 14% after operation for 4 hours, indicating that the hydrate slurry was produced stably.

As described above, it was found that, when the in-tube flow rate of the raw solution or slurry flowing in the shell-and-tube heat exchanger 61 was set to 1.8 m/s, it was possible to suppress the increase in the hydrate deposition thickness on the tube inner wall surface and to produce the hydrate slurry stably.

### <Test Results 2>

Subsequently, a test for examination of the relationship between the tube pressure drop and the in-tube flow rate of the aqueous solution was performed, as the flow rate of the raw solution or slurry flowing inside the tube of the shell-and-tube heat exchanger 61 was altered in the range of 1.5 to 2.4 m/s by regulation of the recirculation pump 67 and the circulation pump 64.

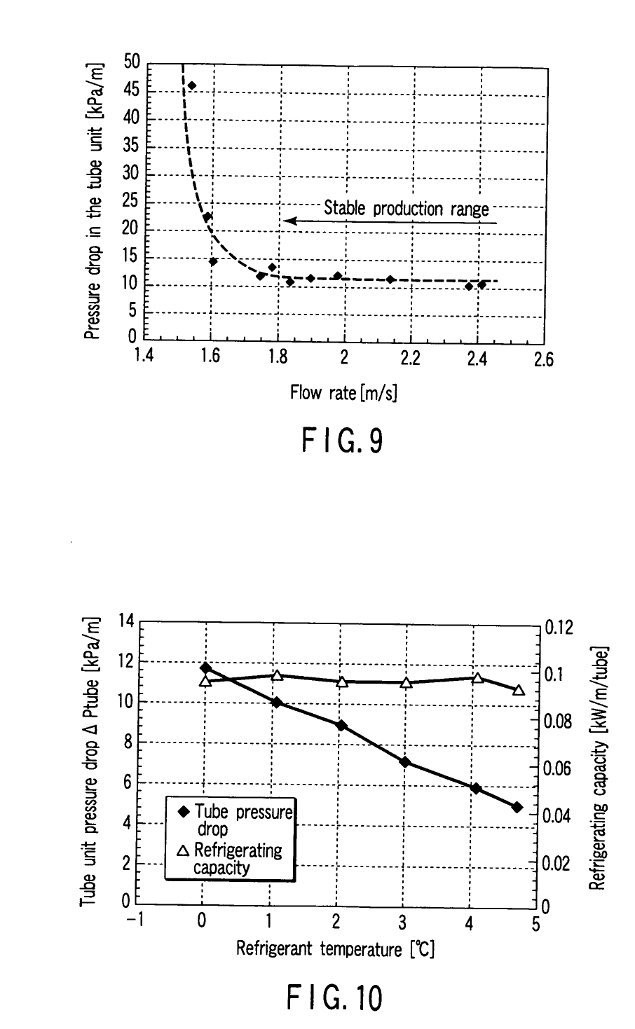

FIG. 9 is a graph showing the test results, and the in-tube flow rate of the raw solution or slurry was plotted on abscissa and the tube pressure drop when the tube pressure drop became constant, on ordinate.

As shown in FIG. 9, if the in-tube flow rate of the raw solution or slurry was approximately 1.8 m/s or more, the tube pressure drop was low, when the refrigerant temperature was 2° C. On the contrary, if the in-tube flow rate of the raw solution or slurry smaller than 1.8 m/s, the tube pressure drop was high.

The results indicate that it is possible to suppress the increase of the amount of the hydrate deposited on the tube inner wall surface by the flow force of the raw solution or slurry, by feeding the raw solution or slurry into the tube of the shell-and-tube heat exchanger 61, while keeping the flow rate of raw solution or slurry in the tube of the shell-and-tube heat exchanger 61 at 1.8 m/s or more, when the refrigerant temperature is 2° C. It is thus possible to perform heat exchange in the tube of the shell-and-tube heat exchanger 61 smoothly for an extended period of time and produce the hydrate slurry stably.

In addition, it is possible to suppress the increase in the amount of the hydrate deposited on the tube inner wall surface and also to keep a part of the hydrate deposited and remained on the tube inner wall surface by feeding the raw solution or slurry at a flow rate of the raw solution or slurry in the tube of the shell-and-tube heat exchanger at 61 of 1.8 m/s or more, thus to generate additional hydrate easily, because the residual hydrate functions as a crystallization nucleus for the hydrate, to regulate the solid phase fraction of the hydrate slurry in a suitable range, and to store and transport the cold heat smoothly.

### <Test Results 3>

The effect of the refrigerant temperature was evaluated, while the refrigerant temperature was altered. A production test by a shell-and-tube heat exchanger 61 was performed, while the refrigerant temperature was varied in the temperature range of 0 to 4.7° C., which is lower than the hydrate generation-initiating temperature (hydrate freezing point) of 14.4 wt % aqueous TBAB solution at 8° C., and the effect of the refrigerant temperature on the pressure drop in the tube of the shell-and-tube heat exchanger 61 was studied. The flow rate of the raw solution or slurry in the heat exchanger tube was set to 2 m/s.

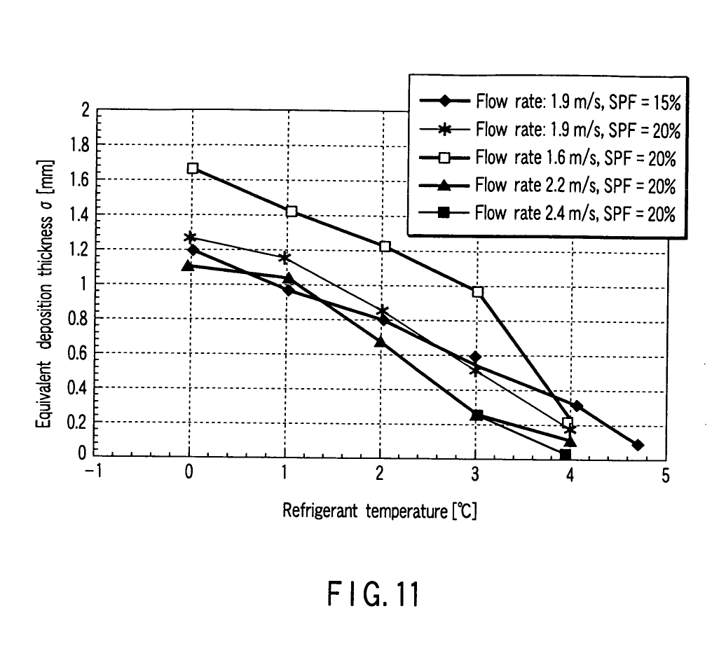

FIG. 10 is a graph showing the test results. The refrigerant temperature is plotted on abscissa, while the pressure drop in the tube of the shell-and-tube heat exchanger 61 and the refrigerating capacity of the shell-and-tube heat exchanger 61 on ordinate.

As shown in FIG. 10, the pressure drop in the tube of the shell-and-tube heat exchanger 61 is decreased, when the refrigerant temperature is higher in the temperature range of the test. The reason seems to be the followings:

Rise of the refrigerant temperature as high as possible in the range lower than the freezing point of the clathrate hydrate (in other words, closer to the freezing point of the clathrate hydrate) leads to decrease in the refrigeration degree (specifically supercooling degree) of the raw solution or slurry in contact with the heat exchange surface of the heat transfer tube. It results in increase of the rate of the voids (content of aqueous solution) in the hydrate generated as cooled on the heat exchange surface of the heat transfer tube, making the hydrate deposition layer softer and more easily separable by the flow force of the aqueous solution or hydrate slurry. Higher refrigerant temperature makes the hydrate deposited on the heat transfer tube inner surface softer and more separable and reduces the hydrate content. As a result, higher refrigerant temperature leads to decrease of the pressure drop in the heat exchanger tube unit.

In addition, the refrigerating capacity of the shell-and-tube heat exchanger 61 is determined in the following manner, and, when the refrigerant temperature is in the range of 0 to 4° C., the refrigerating capacity per unit tube length is almost constant at 0.095 to 0.097 [kW/m/tube], independently of the refrigerant temperature. High refrigerant temperature allows operation of the refrigerator supplying the refrigerant under a higher refrigerant temperature condition for obtaining the same refrigerating capacity, and thus, reduction of power consumption by the refrigerator.

Calculation of heat-exchanger refrigerating capacity

Refrigeration capacity Q=A·K·ΔTm

where, A: heat transfer surface area [m²]=π·Do·L·n
K: thermal transmittance [W/m²k]
ΔTm: logarithmic mean temperature difference (≈Ti−To)
To: refrigerant temperature
Ti=raw solution or slurry temperature in tube
Do: tube outer diameter
D: diameter of the in-tube aqueous solution channel
t: tube wall thickness
σ: hydrate layer thickness
ho: outside-tube thermal transmittance
hi: in-tube thermal transmittance
λ_{SUS}: SUS tube heat conductivity
λ_{CHS}: hydrate heat conductivity

The thermal transmittance is calculated according to the following Formula:

1/K=Do/Dhi+(Do/2λ_{CHS})ln(Do−2t)/D+(Do/2λ_{SUS})ln Do/(Do−2t)+1/ho

Here, D=Do−2t−2σ

### <Test Results 4>

The effect of the refrigerant temperature on the pressure drop in the tube of the shell-and-tube heat exchanger 61 was also evaluated, while the kind and the flow rate of the raw slurry were altered.

Hydrate slurries respectively at solid phase fractions SPFs of 15% and 20% were prepared by using 14.4 wt % aqueous TBAB solution (hydrate generation-initiating temperature (hydrate freezing point): 8° C.) as the raw solution and by generating the hydrate by previously cooling of the solution, and used as the raw slurries.

The temperature of the hydrate slurry at an SPF of 15% prepared with the 14.4 wt % aqueous TBAB solution was 7° C., and the temperature of the hydrate slurry at an SPF of 20% was 6° C.

In addition hydrate slurries respectively at solid phase fractions SPFs of 15% and 20% were prepared by using 11 wt % aqueous TBAB solution (hydrate generation-initiating temperature (hydrate freezing point): 7° C.) as the raw solution and by generating the hydrate by previously cooling of the solution, and used as the raw slurries.

The temperature of the hydrate slurry at an SPF of 15% prepared with the 11 wt % aqueous TBAB solution was 5° C., and the temperature of the hydrate slurry at an SPF of 20% was 4° C.

Thus, there were four kinds of raw slurries:

(1) Hydrate slurry at a solid phase fraction SPF of 15% obtained by cooling 14.4 wt % aqueous TBAB solution

(2) Hydrate slurry at a solid phase fraction SPF of 20% obtained by cooling 14.4 wt % aqueous TBAB solution

(3) Hydrate slurry at a solid phase fraction SPF of 15% obtained by cooling 11 wt % aqueous TBAB solution

(4) Hydrate slurry at a solid phase fraction SPF of 20% obtained by cooling 11 wt % aqueous TBAB solution

The effect of the pressure drop in the tube unit on the refrigerant temperature was examined by using the four kinds of raw slurries and by changing the refrigerant temperature in a temperature range of 0 to 4.7° C., which is lower than each hydrate generation-initiating temperature (hydrate freezing point) and varying the flow rate of the raw slurry flowing inside the tube of the shell-and-tube heat exchanger 61 in the range of 1.6 to 2.4 m/s by regulation of the recirculation pump 67 and the circulation pump 64. The thickness of the hydrate deposited on the tube inner surface was calculated from the measured value of the pressure drop in the tube unit, similarly to the single duplex tube test above.

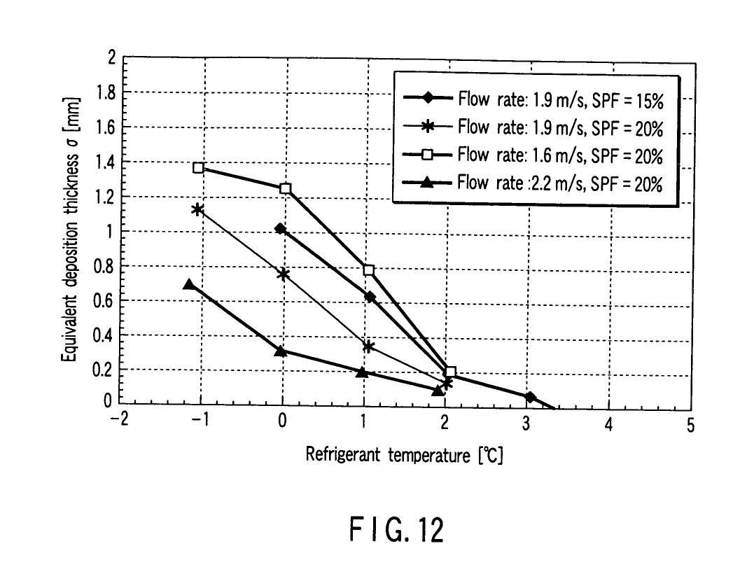

FIGS. 11 and 12 are graphs showing the test results. In FIGS. 11 and 12, the refrigerant temperature is plotted on abscissa, while the hydrate-equivalent deposition thickness calculated from the pressure drop in the tube of the shell-and-tube heat exchanger 61, on ordinate.

FIG. 11 shows the results obtained with the raw slurries prepared from the 14.4 wt % aqueous TBAB solution, while FIG. 12 shows the results obtained with the raw slurries prepared from the 11 wt % aqueous TBAB solution.

As shown in FIGS. 11 and 12, the hydrate-equivalent deposition thickness decreased when the refrigerant temperature was raised, independently of the kind and the flow rate of the raw slurry. Higher refrigerant temperature makes the hydrate deposition layer on the heat transfer tube inner surface softer and more separable by the flow force of the aqueous solution or hydrate slurry, and reduces the amount of the deposited hydrate, independently of the kind and the flow rate of the raw slurry.

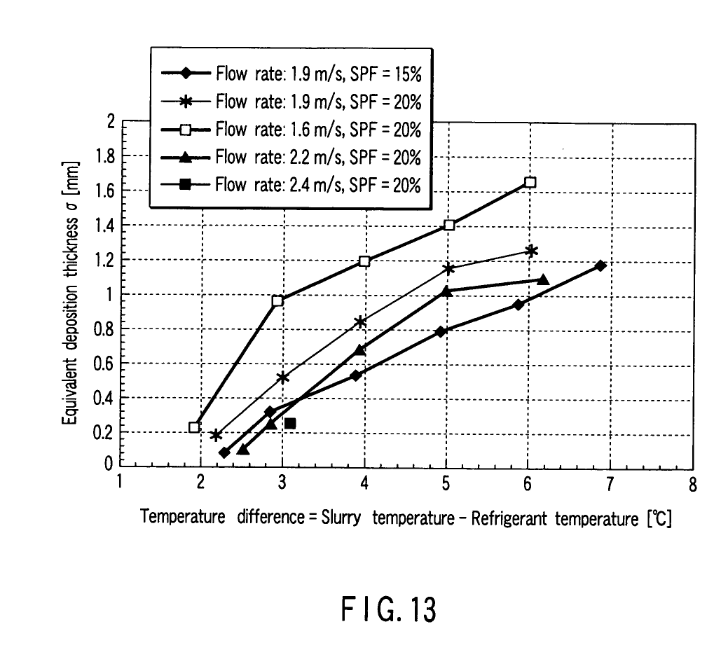

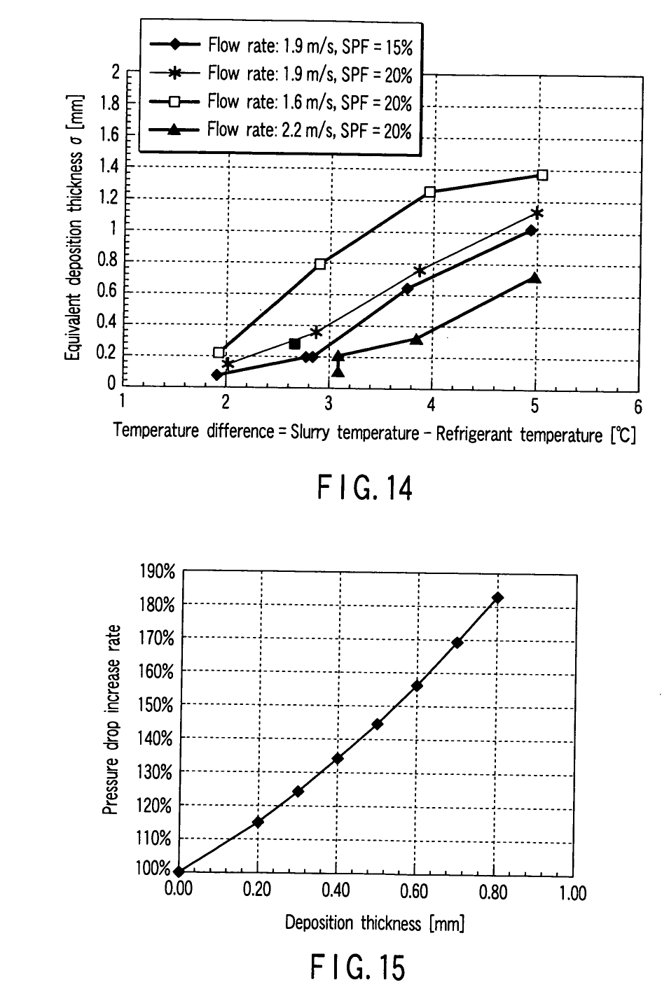

Then, the relationship of the temperature difference between the refrigerant and the raw slurry with the hydrate-equivalent deposition thickness was evaluated, based on the test results shown in FIGS. 11 and 12. FIGS. 13 and 14 are graphs showing the results. The abscissa shows the temperature difference between the refrigerant and the raw slurry, while the ordinate, the hydrate-equivalent deposition thickness calculated from the pressure drop in the tube of the shell-and-tube heat exchanger 61.

FIG. 13 is a graph showing the results obtained by using the raw slurries prepared from 14.4 wt % aqueous TBAB solution, while FIG. 14 is a graph showing the results obtained by using the raw slurries prepared from 11 wt % aqueous TBAB solution.

As shown in FIGS. 13 and 14, the hydrate-equivalent deposition thickness decreases when the temperature difference between the refrigerant and the raw slurry is smaller, independently of the raw slurry and the flow rate. Smaller temperature difference between the refrigerant and the raw slurry, i.e., high refrigerant temperature, makes the hydrate deposition layer on the heat transfer tube inner surface softer and more separable by the flow force of the aqueous solution or hydrate slurry and reduces the amount of the deposited hydrate, independently of the kind and the flow rate of the raw slurry.

Subsequently, the relationship between the deposition thickness of the hydrate deposited on the tube of the shell-and-tube heat exchanger 61 inner surface and the pressure drop in the tube unit was examined. FIG. 15 is a graph showing the results, and the deposition thickness is plotted on abscissa, while the pressure drop increase rate relative to 100% of the value when there is no hydrate deposition, on ordinate. The pressure drop in the tube unit is proportional with the square of the flow rate and inversely proportional with the effective tube inner diameter, and thus, increase in deposition thickness is accompanied with decrease in the effective inner diameter and increase in the pressure drop.

The pressure drop increase rate in the tube unit shell-and-tube heat exchanger is preferably 150% or less from the point of the allowable fluctuation range of the power of the pump feeding the raw solution or slurry, but, for that purpose, the hydrate deposition thickness should be approximately 0.5 mm or less, as shown in the graph of FIG. 15. As shown in FIGS. 13 and 14, the temperature difference between the refrigerant and the raw slurry is preferably 4° C. or lower, to make the hydrate deposition thickness approximately 0.5 mm or less.

Alternatively, excessively smaller temperature difference between the refrigerant and the raw slurry leads to deterioration in heat transfer efficiency, and thus, the temperature difference is desirably 1° C. or higher. Thus by limiting the temperature difference between the refrigerant and the raw slurry into a range of 1° C. or higher and 4° C. or lower, it is possible to perform heat exchange at a suitable heat transfer efficiency and suppress the increase of the hydrate deposition thickness on the tube inner surface.

### Embodiment 1

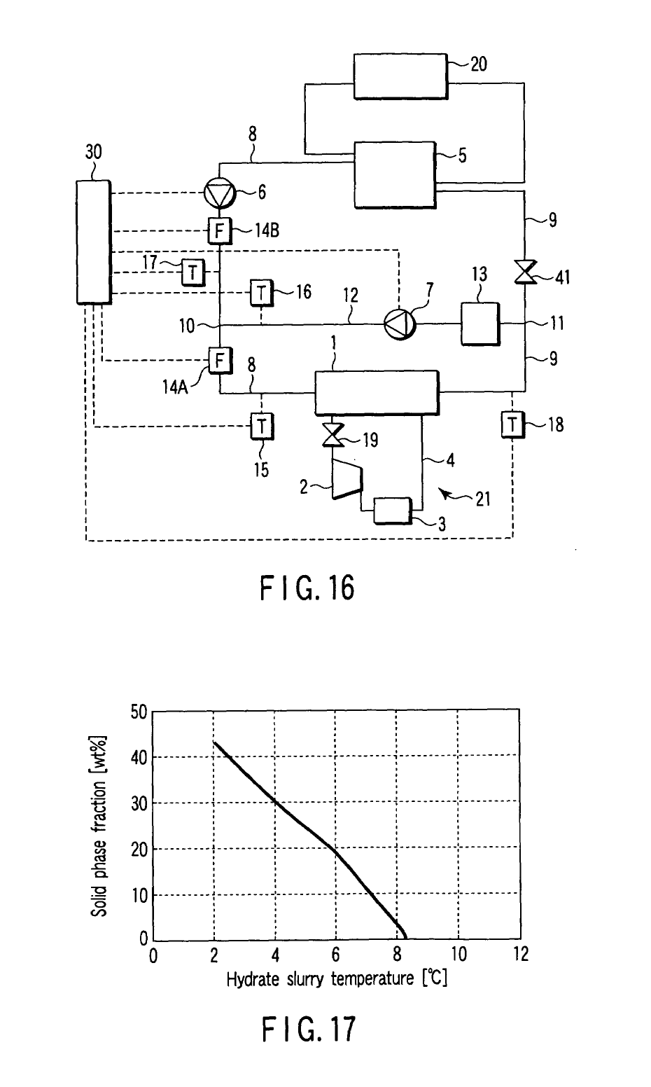

FIG. 16 is a schematic view illustrating the configuration of the apparatus for producing clathrate hydrate slurry in an embodiment of the present invention.

The apparatus for producing clathrate hydrate slurry in the present embodiment has a heat exchanger 1 heat-exchanging the raw solution (aqueous solution of a hydrate-generating guest compound) or raw slurry with a refrigerant, a refrigerant-supplying device 21 supplying the refrigerant to the heat exchanger 1, a thermal storage tank 5 storing the raw solution or slurry and the generated hydrate slurry, an inlet channel 8 communicating to the thermal storage tank 5 at one terminal and to the inlet side of the heat exchanger 1 at the other terminal, an outlet channel 9 communicating to the outlet side of the heat exchanger 1 at one terminal and to the thermal storage tank 5 at the other terminal, and a recirculation channel 12 connecting the outlet channel 8 with the inlet channel 9.

The heat exchanger 1 is a shell-and-tube heat exchanger, and a Fleon refrigerant such as R134a is designed to be fed into the shell while a raw solution or slurry into the tube.

The refrigerant-supplying device 21 has a compressor 2 compressing the gas refrigerant, a condenser 3 obtaining a liquid refrigerant by condensing the compressed gas refrigerant, a refrigerant piping 4, and a refrigerant flow control unit (inlet guide vane in the case of turbocompressor) 19, i.e., a refrigerant temperature-regulating device regulating the temperature of the refrigerant supplied to the heat exchanger by controlling the refrigerant flow rate.

Placed in the region on the inlet channel 8 upstream side of the connecting region 10 with the recirculation channel 12 (the side closer to the thermal storage tank 5 on the inlet channel 8) are a production pump 6 feeding the aqueous solution in the thermal storage tank 5, a flowmeter 14B monitoring the flow rate of the aqueous solution, and a first thermometer 17 monitoring the temperature of the aqueous solution.

In addition, placed in the region on the recirculation channel 12 are a storage tank 13, a recirculation pump 7 feeding the hydrate slurry, and a second thermometer 16 monitoring the temperature of the hydrate slurry.

The storage tank 13 has a supercooling-eliminating device eliminating supercooling of the supplied aqueous solution in the supercooled state (not shown in the figure).

The supercooling-eliminating device may be, for example, a cooling unit connected to a small refrigerator that is inserted into the piping through which the aqueous solution in the supercooled state flows. The cooling unit is cooled to a temperature not higher than the hydrate-generating temperature by a small refrigerator and has the hydrate deposited on the surface. When the supercooled aqueous solution becomes in contact with the cooling unit, the hydrate is generated easily, while the hydrate deposited on the surface of the cooling unit functions as a product nucleus, and the supercooling is eliminated.

Alternatively, the supercooling-eliminating device may be a low-temperature protuberance for example of a supercooling Pertier element inserted into a piping through which the aqueous solution in the supercooled state flows. Such a low-temperature protuberance is also cooled to a temperature of the hydrate-generating temperature or lower, similarly to the cooling unit of the small refrigerator described above, and has the hydrate deposited on the surface. When the supercooled aqueous solution becomes in contact with the low-temperature protuberance, the hydrate deposited on the surface of the low-temperature protuberance functions as a product nucleus and eliminates supercooling, generating hydrates easily.

Alternatively, a hydrate slurry separately prepared may be added as the supercooling-eliminating device.

On the inlet channel 8 downstream side of the connecting region 10 with the recirculation channel 12, placed are a flowmeter 14A monitoring the flow rate of the mixture of the raw solution or slurry and the hydrate slurry supplied from the recirculation channel 12, and a third thermometer 15 monitoring the temperature of the mixture.

In addition, on the outlet channel 9 upstream side of the connecting region 11 with the recirculation channel 12 (the side closer to the heat exchanger 1 on the outlet channel 9), placed is a fourth thermometer 18 monitoring the temperature of the raw solution or slurry or hydrate slurry passed through the heat exchanger 1. In addition, on the outlet channel 9 downstream side of the connecting region 11 with the recirculation channel 12, placed is an on-off valve 41.

The hydrate slurry-producing apparatus has a control means 30 controlling the flow rate of the production pump 6 and/or the recirculation pump 7, based on the data obtained in the flowmeter 14, first thermometer 17, second thermometer 16, and third thermometer 15.

An air conditioning load 20 performing air conditioning with the hydrate slurry supplied from the thermal storage tank 5 is connected, via a hydrate slurry piping, to the thermal storage tank 5.

Operation of the apparatus in the present embodiment in the configuration above will be described below.

### <Brief Description of Hydrate Production>

A Fleon refrigerant such as R134a flows through the shell side of the heat exchanger 1, while the raw solution or slurry through the tube side.

An aqueous solution at 12 to 15° C. is withdrawn from the thermal storage tank 5 and supplied, via the inlet piping 8, into the heat exchanger 1 by the production pump 6.

The raw solution or slurry supplied to the heat exchanger 1 is cooled by the heat by vaporization in the shell of the Fleon liquid refrigerant compressed in the compressor 2 and liquefied in the condenser 3, giving a hydrate slurry. The hydrate slurry is fed from the heat exchanger 1, via the outlet piping 9, into the thermal storage tank 5 and stored there.

When the raw slurry is fed from the thermal storage tank 5 to the heat exchanger 1, the hydrate is generated additionally, giving a hydrate slurry higher in the rate of the hydrate in the hydrate slurry, or in the solid phase fraction (SPF).

The hydrate slurry stored in the thermal storage tank 5 is sent to the air conditioning load 20 for supply of the cold heat, and a hydrate slurry in the aqueous solution or having a lower solid phase fraction is sent back to the thermal storage tank 5.

### <Description of the Operation Method of Production Apparatus>

Operation of the production apparatus producing a hydrate slurry will be described below, by taking tetra-n-butylammonium bromide (TBAB) as an example of the hydrate-generating guest compound. Preparative operation such as initial operation or resumption of operation after cessation and normal operation for continuous production of the hydrate slurry will be described separately.

When the concentration of the aqueous solution is 14.4 wt %, the hydrate generation-initiating temperature is 8° C. The solid phase fraction (SPF) of the hydrate slurry at 7° C. is 14%, and the heat density is 14 Mcal/m³ (14° C. standard).

### <Preparative Operation>

[1] When hydrate slurry production is started, there is a raw solution at 12° C. or higher in the inlet channel 8, outlet channel 9 and the tube of the heat exchanger, and the raw solution at 12° C. or higher stored in the thermal storage tank 5 and the storage tank 13.

When hydrate slurry production is started, the on-off valve 41 is closed. The recirculation pump 7 is activated, the flow rate is controlled by regulation of the inverter for the recirculation pump 7 to make the flow rate of the raw solution in the tube of heat exchanger 1 constant at a particular flow rate while the flow rate is monitored with a flowmeter 14A. The raw solution flows then in the direction of 13→7→12→14A→8→1→9→13.

[2] Subsequently, the compressor 2 for refrigerator is activated, and the raw solution flowing inside the tube is cooled, while the refrigerant is supplied to the heat exchanger 1. For example, for control of the refrigerator during cooling, the compressor capacity-controlling unit (inverter) or the refrigerant flow control unit 19 (inlet guide vane in the case of turbocompressor) is regulated to make the refrigerant vaporization temperature (pressure) in the shell at a particular value. The raw solution is cooled in the tube of heat exchanger 1 into the supercooled state.
[3] The raw solution is circulated in the direction of 13→7→12→14A→8→1→9→13, while the channel is cooled; when the temperature of the raw solution in the storage tank 13 becomes close to the hydrate-generating temperature, the condenser tube innerly installed as a supercooling-eliminating device is cooled, allowing deposition of the hydrate on the condenser tube surface. When the raw solution cooled into the supercooled state by the heat exchanger 1 is brought into contact with the hydrate deposited on the condenser tube surface, the deposit hydrate functions as a hydrate product nucleus and eliminates supercooling, generating the hydrate and giving a hydrate slurry, which is stored. When the supercooling is eliminated, the temperature in the storage tank 13 rises to the targeted hydrate slurry temperature. When a certain amount of the hydrate slurry is stored in the storage tank 13, the preparative operation is terminated and replaced with normal operation.

When the solid phase fraction of the hydrate slurry flowing into the storage tank 13 is larger than 0, cooling of the condenser tube may be terminated. The method of calculating the solid phase fraction will be described below.

### <Normal Operation>

[4] The raw solution in the thermal storage tank 5 is supplied into the inlet channel 8 as the on-off valve 41 is turned open and the production pump 6 activated, and the hydrate slurry in the storage tank 13 is supplied via the recirculation channel 12 into the inlet channel 8, as the recirculation pump 7 is operated continuously. In this way, the hydrate slurry from the storage tank 13 is supplied into the raw solution, giving a hydrate slurry lower in the solid phase fraction, which is then supplied to the heat exchanger 1. The hydrate slurry having a low solid phase fraction is cooled in the heat exchanger 1, generating additional hydrate, giving a hydrate slurry having a particular solid phase fraction.

The hydrate slurry prepared in the heat exchanger 1 is fed into the outlet channel 9, and a part of it is fed into the recirculation channel 12 and the other part is supplied to and stored in the thermal storage tank 5. The hydrate slurry supplied to the recirculation channel 12 is stored in the storage tank 13, and supplied again into the inlet channel 8 by the recirculation pump 7. On the other hand, the hydrate slurry supplied to the thermal storage tank 5 is stored in the thermal storage tank 5, until it is supplied to the air conditioning load 20. The solid phase fraction of the slurry is determined by measuring the temperature of the hydrate slurry fed from heat exchanger 1 by the fourth thermometer 18, and the hydrate slurry-producing apparatus is operated continuously, to make the slurry have a desired solid phase fraction.

The hydrate slurry stored in the thermal storage tank 5 is supplied to the air conditioning load 20 and used, for example, for indoor air conditioning.

Then, the flow volume and flow rate of the hydrate slurry having a low solid phase fraction in the tube of heat exchanger 1 is controlled, by regulation of the inverters for the production pump 6 and the recirculation pump 7, to a flow rate for example of 1.8 m/s or more at which a part of the hydrate deposited on the tube inner wall surface is removed by the flow force and the other part remaining on the tube inner wall surface, while the flow rate of the hydrate slurry having a low solid phase fraction supplied to the heat exchanger 1 is monitored by the flowmeter 14A. The flowmeter 14A and the inverters for the production pump 6 and the recirculation pump 7 function in combination as a flow rate-regulating device.

[5] The flow rates of the raw solution from the thermal storage tank 5 and the hydrate slurry from the storage tank 13 are so regulated that there are hydrate particles remaining in the mixture of the raw solution from the thermal storage tank 5 and the hydrate slurry from the storage tank 13, i.e., that the solid phase fraction of the hydrate slurry having a low solid phase fraction immediately after mixing does not become 0. In this way, the slurry in the state containing hydrate microparticles flows into the heat exchanger 1; the hydrate microparticles function as product nuclei, generating additional hydrate and eliminating supercooling in the heat exchanger 1; and thus, it is possible to prevent excessively large pressure drop and other troubles caused by rapid removal of supercooling in the tube and to produce the hydrate slurry stably.

The method of controlling the flow rate of the raw solution from the thermal storage tank 5 and the hydrate slurry from the storage tank 13 will be described below.

When an aqueous solution of a hydrate-generating guest compound is cooled, hydrate particles are generated at a temperature of the hydrate-generating temperature or less, giving a hydrate slurry containing the hydrate particles dispersed or suspended in the aqueous solution. Continued cooling leads to increase in the amount of the hydrate particles and also in the solid phase fraction (weight ratio of hydrate particles in hydrate slurry). There is a certain relationship between the hydrate slurry temperature and the solid phase fraction, although it depends on the initial concentration of a hydrate-generating guest compound in the aqueous solution.

For example, the relationship between the hydrate slurry temperature and the solid phase fraction of an aqueous tetra-n-butylammonium bromide (TBAB) solution at an initial concentration of 14 wt % is shown as a graph in FIG. 17. As shown in FIG. 17, low hydrate slurry temperature leads to high solid phase fraction, and the solid phase fraction is almost zero when the hydrate slurry temperature is 8.4° C. or higher in this case.

In the present embodiment, the flow rates of the raw solution and the hydrate slurry fed are so regulated that there are hydrate particles remaining in the mixture of the raw solution from the thermal storage tank 5 and the hydrate slurry from the storage tank 13, i.e., that the solid phase fraction of the hydrate slurry having a low solid phase fraction immediately after mixing does not become 0. For example, when the temperature of the raw solution from the thermal storage tank 5 is 12° C. or higher and the temperature of the hydrate slurry from the storage tank 13 is 7° C., if the flow rate of the raw solution is excessively larger than the flow rate of the hydrate slurry from the storage tank 13, the temperature of the hydrate slurry after mixing is higher than the temperature at which the solid phase fraction becomes 0, and thus, there is no hydrate particle.

The flow rates of the raw solution and the hydrate slurry from the storage tank 13 are so regulated that the solid phase fraction of the hydrate slurry after mixing does not become 0, i.e., that the temperature of the mixture of the raw solution and the hydrate slurry from the storage tank 13 is lower than the temperature at which the solid phase fraction becomes 0, Specifically, the regulation is performed in the following manner:

As shown in FIG. 16, the flow rate and the temperature of the raw solution fed from the thermal storage tank 5 are monitored by a flowmeter 14B and a first thermometer 17, and the measured values are inputted into the control means 30. In addition, the temperature of the hydrate slurry fed from the storage tank 13 is monitored by a secondary flowmeter 16, and the measured value is inputted into the control means 30. Further, the flow rate and the temperature of the mixture of the raw solution sent to the heat exchanger 1 and the hydrate slurry fed from the storage tank 13 are monitored by a flowmeter 14A and a third thermometer 15, and the measured values are inputted into the control means 30. The flow rate of the hydrate slurry fed from the storage tank 13 corresponds to the difference of the measured values between the flowmeter 14A and the flowmeter 14B.

The control means 30 controls the apparatus, based on the inputted values, in such a manner that the solid phase fraction of the mixture of the raw solution and the hydrate slurry fed from the storage tank 13 becomes larger than 0 before the mixture is sent to the heat exchanger 1. Specifically, it controls the flow rates of the production pump 6 and/or the recirculation pump 7 in such a manner that the temperature of the mixture of raw solution and the hydrate slurry fed from the storage tank 13 becomes a particular temperature lower than the temperature at which the solid phase fraction becomes 0.

After regulation of the flow rates of the pumps, the flow rate and the temperature of the mixture are monitored by the flowmeter 14A and the third thermometer 15; the measured values are inputted into the control means 30; it is then judged whether the flow rate and the temperature are targeted values; and if not, the flow rates of the production pump 6 and/or the recirculation pump 7 are controlled to be the targeted flow rate and temperature.

By the flow rate regulation described above, the mixture of raw solution and the hydrate slurry fed from the storage tank 13 flows into the heat exchanger 1, as it contains the hydrate particles. When raw solution containing the hydrate particles is cooled in the heat exchanger 1, additional hydrate particles are formed using the hydrate particles as crystallization nuclei, suppressing generation of the supercooled state in the heat exchanger 1, and thus, it is possible to suppress excessively large pressure drop and other troubles caused by rapid removal of supercooling in the tube and to produce the hydrate slurry stably.

As described above, in the present embodiment, it is possible to produce the hydrate slurry stably without generation of supercooling in the heat exchanger 1, because the flow rate in the tube of heat exchanger 1 is set to a flow rate at which a part of the hydrate deposited on the tube inner wall surface is removed by the flow force and the other part remaining on the tube inner wall surface, for example to 1.8 m/s or more, and the raw solution supplied to the heat exchanger 1 contains hydrate particles, by regulation of the flow rate of the hydrate slurry having a low solid phase fraction supplied to the heat exchanger 1 or of the raw solution.

In addition, because there is a recirculation channel 12 and a storage tank 13 equipped with a supercooling-eliminating device is connected to the recirculation channel 12, it is possible to produce the hydrate slurry stably without generation of supercooling in the heat exchanger 1 even during preparative operation.

In the present embodiment, the flow rate regulation by the control means 30 is performed by flow rate control of the production pump 6 and/or the recirculation pump 7, but flow rate control valves may be formed in the inlet channel 8 and the recirculation channel 12 for control of the flow rate.

The inverter for regulation of operation of the production pump 6 or the flow rate control valve formed in the inlet channel 8, and/or the inverter for regulation of operation of the recirculation pump 7 or the flow rate control valve and the flowmeter 15 formed in the recirculation channel 12 correspond to the flow rate-regulating device regulating the flow rate of the raw solution or slurry according to the present invention.

Also in the present embodiment, a refrigerant flow control unit controlling the flow rate of the refrigerant supplied to the heat exchanger 19 (inlet guide vane in the case of turbocompressor) or an apparatus having a compressor capacity-controlling unit (inverter) was described as an example of the refrigerant temperature-regulating device regulating the temperature of the refrigerant supplied to the heat exchanger, but the refrigerant temperature may be regulated by other means.

Also in the present embodiment, an evaporator of compression refrigerator was described as an example of the heat exchanger, but the heat exchanger may be a unit heat-exchanging with cold water cooled by a refrigerator or may be a unit using any other refrigerator.

Also in the present embodiment, a production apparatus having a recirculation channel 12 was described. However, the hydrate slurry in the thermal storage tank 5 may be withdrawn into the inlet channel 8, as described above, in such a manner that the solid phase fraction of the mixture is kept larger than 0 without installation of such a recirculation channel 12.

In the embodiments above, the solid phase fraction was described to be larger than 0, but the typical value of the solid phase fraction is preferably selected properly according to the kind of the hydrate and the like.

Examples of the hydrate-forming substances forming the hydrate and having a high latent heat include various salts including tetra-n-butylammonium salts, tetra-iso-amylammonium salts, tetra-iso-butylphosphonium salts, tri-iso-amylsulfonium salt, and others, and typical examples of the tetra-n-butylammonium salts include tetra-n-butylammonium bromide ((n-C₄H₉)₄NBr, TBAB), tetra-n-butylammonium fluoride ((n-C₄H₉)₄NF), tetra-n-butylammonium chloride ((n-C₄H₉)₄NCl), and the like.

In addition, the anion above, Br, F, or Cl, may be replaced with acetate (CH₃CO₂), chromate (CrO₄), tungstenate (WO₄), oxalate (C₂O₄), or phosphate (HPO₄). The other salts are also the same.

Hereinafter, examples of the thermal-storage air conditioning systems employing the hydrate slurry-producing apparatus according to the present invention will be described below in the following Examples.

In the following Examples, the measurement and control devices for control of the flow rate and the temperature of the hydrate slurry-producing apparatus and the storage tank for removal of supercooling are not described.

### Example 1

### Thermal-Storage Air Conditioning System 1

In the thermal-storage air conditioning system 1 of Example 1, heat is stored by operation of a refrigerator for slurry production at night; the heat is used for air conditioning during daytime; and the heat is used for air conditioning, while it is stored by operation of the refrigerator for slurry production when the cooling load is high during daytime. The system is characteristic in that it is possible to cope with high cooling load during daytime with a single refrigerator for slurry production 1.

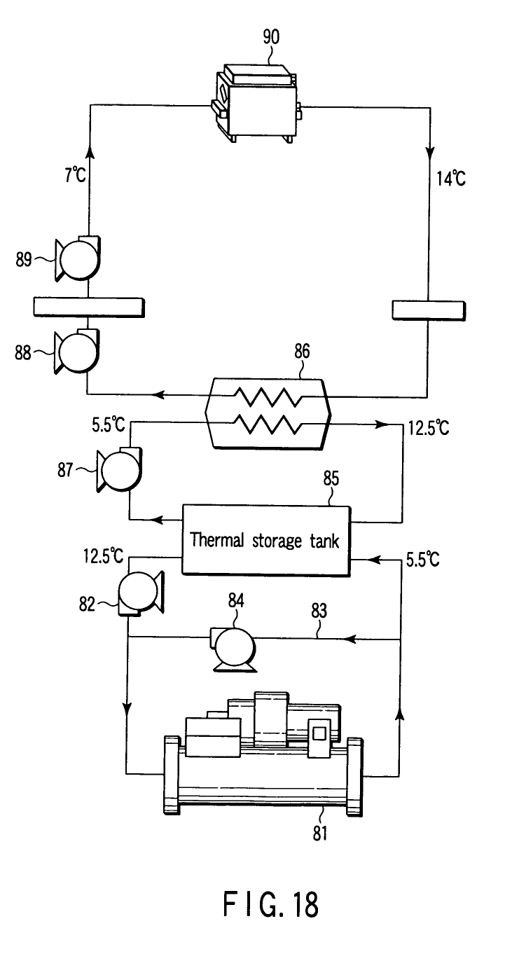

FIG. 18 is a chart illustrating a system in the device configuration of Example 1 that is applicable to a building having a maximum cooling load of 400 RT.

The thermal-storage air conditioning system 1 of Example 1 has a refrigerator for slurry production 81 for production of hydrate slurry, a thermal storage pump 82 circulating the raw solution or slurry installed on the hydrate slurry-producing line, a recirculation pump 84 installed in the recirculation channel 83, a thermal storage tank 85 storing the raw solution or slurry or the hydrate slurry, a cold water/slurry heat exchanger 86 generating cold water by heat exchange between the hydrate slurry and water, a heat discharge pump 87 sending the hydrate slurry in the thermal storage tank 85 into the cold water/slurry heat exchanger 86, a first cold water pump 88 circulating the cold water, a second cold water pump 89 sending cold water to the load side, and an air conditioning load 90.

The raw solution used in Example 1 is an aqueous tetra-n-butylammonium bromide (TBAB) solution, and the concentration is 12.4 wt %, and the hydrate generation-initiating temperature is 7.5° C. The heat supplied during a temperature change of the hydrate slurry from 5.5° C. to 12.5° C. is approximately 14 Mcal/m³, and the solid phase fraction (SPF) thereof is 17% when the hydrate slurry is at 5.5° C.

The refrigerator for slurry production 81 is a turborefrigerator consisting of a compressor, an evaporator, and a condenser. The raw solution or slurry flows through the tube of the evaporator shell-and-tube heat exchanger. A Fleon refrigerant such as R134a flows in the shell, and the raw solution or slurry flowing inside the tube is cooled by the vaporization latent heat of the Fleon refrigerant.

The recirculation pump 84 has an action to regulate the flow rate of the raw solution or slurry flowing inside the tube to a particular flow rate or more, for suppression of increase in the amount of the hydrate deposited on the tube.

The thermal storage pump 82 is a pump having the same function as that of the production pump described above.

The thermal storage tank 85 is a multi-compartment tank that has a thermal storage capacity of approximately 2000 RTh.

The hydrate slurry is withdrawn from the thermal storage tank 85 and fed into the cold water/slurry heat exchanger 86 by the heat discharge pump 87, and supplies the cold water with the cold heat in the cold water/slurry heat exchanger 86.

The cold water cooled in the cold water/slurry heat exchanger 86 is sent to the air conditioning load 90 by the first cold water pump 88 and second cold water pump 89, supplying the cold heat for air conditioning.

### <Thermal Storage Operation>

A particular hydrate slurry (5.5° C., SPF=17%) is stored in the thermal storage tank 85 for thermal storage at night by operation of the refrigerator for slurry production 81, the recirculation pump 84, and the thermal storage pump 82.

A raw solution at approximately 12.5° C. is stored in the thermal storage tank 85 before thermal storage, and a hydrate slurry at approximately 5.5° C. and an SPF of 17% is stored after completion of thermal storage.

### <Air Conditioning Operation by Using Stored Heat>

When there is a cooling load generated in building during daytime, the first cold water pump 88 and the heat discharge pump 87 are activated, and heat discharging operation of producing cold water at 7° C. is performed by heat exchange of cold water with the hydrate slurry at 5.5° C. withdrawn from the thermal storage tank 85 by the heat discharge pump 87 in the cold water/slurry heat exchanger 86. The cold water is supplied for air conditioning to an air conditioning load 90 of indoor air conditioner, while the second cold water pump 89 is activated.

### <Supplementary Thermal Storage and Air Conditioning Operation>

When a cooling load per day is estimated to be larger than a thermal storage quantity of 2000 RTh, heat discharging operation is performed simultaneously with supplementary thermal storage, while the refrigerator for slurry production 81, recirculation pump 84, and thermal storage pump 82 are activated.

### Example 2

### Thermal-Storage Air Conditioning System 2

Basically in the thermal-storage air conditioning system 2 of Example 2, heat is stored by operation of the refrigerator for slurry production at night and the heat is used for air conditioning during daytime, and, when the cooling load is high during daytime, the cold water is produced and supplied by a separate refrigerator.

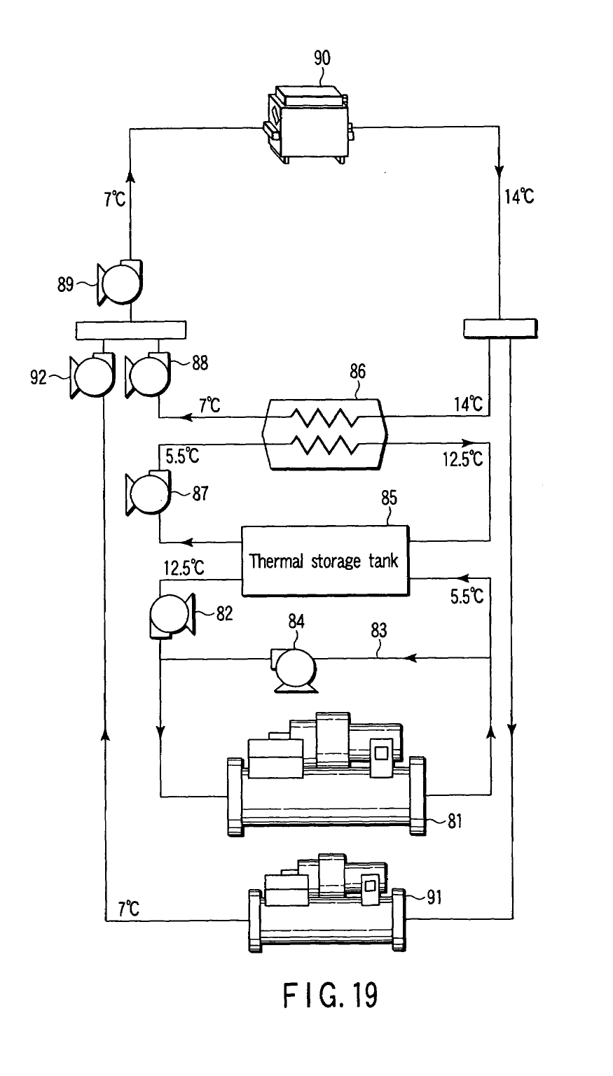

FIG. 19 is a chart illustrating a system in the device configuration of Example 2, and the same numerals are allocated to the compositions the same as those in FIG. 18. As shown in FIG. 19, in the present Example 2, a cold water refrigerator 91 producing cold water at 7° C. and a first cold water pump 92 sending the cold water from the cold water refrigerator 91 are added to the configuration shown in FIG. 18.

Thermal storage operation at night and air conditioning operation by using the stored heat during daytime are performed, similarly to Example 1. When the cooling load per day is estimated to be larger than a thermal storage quantity of 2000 RTh, cold water is supplied from the cold water refrigerator 91 (200 RT) as it is activated, and supplementary, cold water cooled by heat discharged from the hydrate slurry in the thermal storage tank 85 is supplied to the air conditioning load 90.

### Example 3

### Thermal-Storage Air Conditioning System 3

The present Example is characteristic in that the refrigerator is a double-evaporator refrigerator sending the refrigerant to the slurry-producing evaporator and to the cold water-producing evaporator alternately by switching. Basically, the heat is stored by slurry-producing operation at night, and the stored heat is used for air conditioning during daytime, and, when the cooling load is estimated to be large during daytime, cold water-producing operation is performed for supplement.

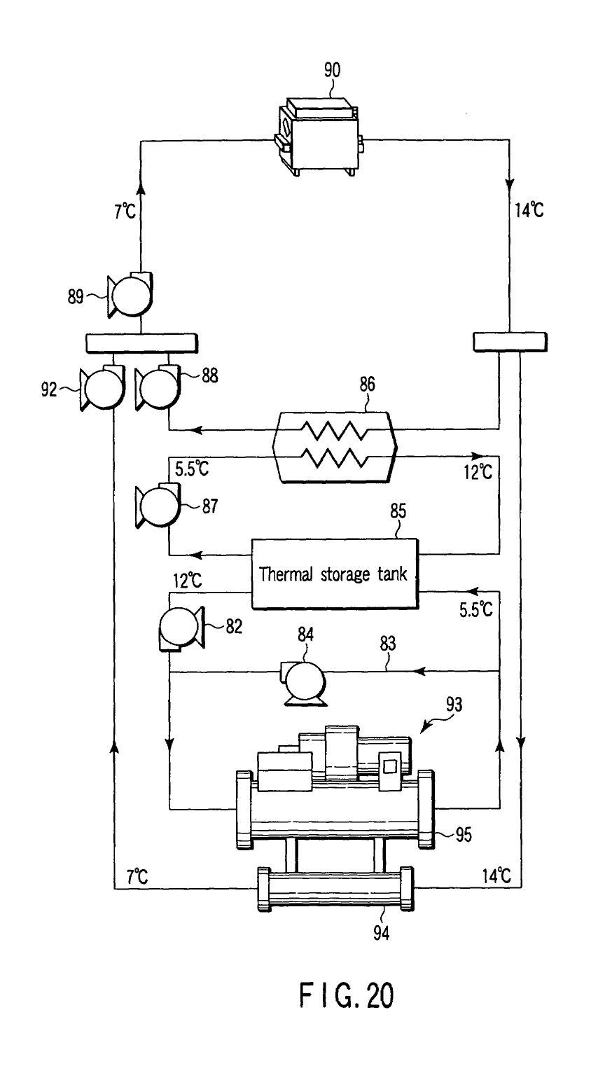

FIG. 20 is a chart illustrating a system in the device configuration of Example 3, and the same numerals are allocated to the compositions the same as those in FIG. 19.

The slurry/cold water-producing refrigerator 93 of the present Example 3 is a refrigerator having a cold water-producing evaporator 94 and a hydrate slurry-producing evaporator 95 that can produce cold water and the hydrate slurry by switching of the flow of the Fleon refrigerant.

During thermal storage at night, hydrate slurry is produced and heat is stored by using the hydrate slurry-producing evaporator 95.

Air conditioning is performed by using the heat of the hydrate slurry in the thermal storage tank 85 during daytime, and, when the cooling load is estimated to be large, cold water is produced by using the cold water-producing evaporator 94, as the slurry/cold water-producing refrigerator 93 is activated, and supplied, together with the cold water cooled by heat energy discharged from the hydrate slurry in the thermal storage tank 85, to the air conditioning load 90.

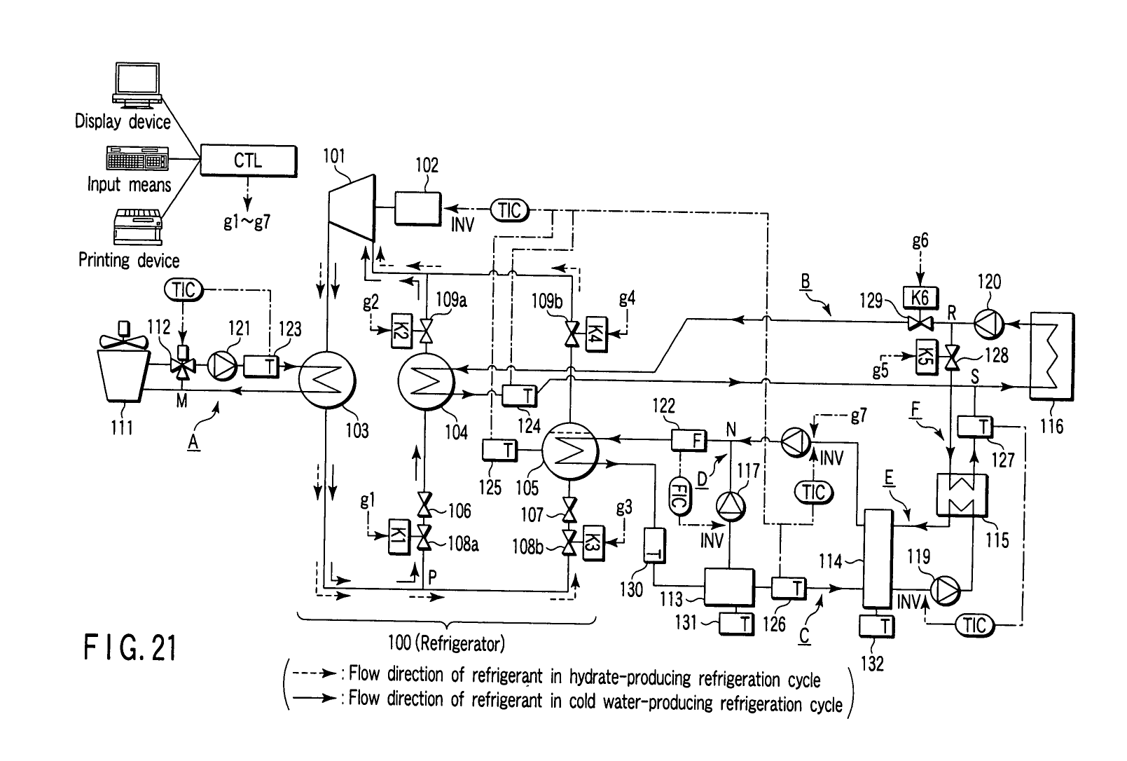

FIG. 21 is an explanatory diagram showing a thermal-storage air conditioning system employing a double-evaporator refrigerator similar to that of the thermal-storage air conditioning system 3 in Example 3.

Hereinafter, a thermal-storage air conditioning system employing a double-evaporator refrigerator will be described in detail, with reference to FIG. 21. First, the configuration of the double-evaporator refrigerator (region 100 in parenthesis in the figure) and then of the entire configuration will be described.

### <Basic Configuration of Refrigerator>

In the figure, 101 represents a centrifugal compressor; 102 represents a motor driving the centrifugal compressor 101; 103 represents a condenser; 104 represents a cold water-producing liquid-filled evaporator; 105 represents a hydrate slurry-producing evaporator; 106 represents an expansion valve or orifice in the cold water-producing refrigeration cycle; 107 represents an expansion valve or orifice in the hydrate slurry-producing refrigeration cycle; 108 represents a refrigerant liquid shut-off valve; and 109 represents a refrigerant gas shut-off valve. 108a and 108b are respectively refrigerant liquid shut-off valves 108 constituting the cold water-producing refrigeration cycle and the hydrate slurry-producing refrigeration cycle, while 109a and 109b are respectively refrigerant gas shut-off valves 109 constituting the cold water-producing refrigeration cycle and the hydrate slurry-producing refrigeration cycle.

The solid line arrow in the FIG. indicates the flow direction of the refrigerant when cold water is produced by using the cold water-producing liquid-filled evaporator 104, while the dotted line arrow, the flow direction of the refrigerant when the hydrate slurry is produce by using the hydrate slurry-producing evaporator 105. The refrigerant is preferably R134a or R123.

The cold water-producing refrigeration cycle includes a centrifugal compressor 101, a motor 102, a condenser 103, a refrigerant liquid shut-off valve 108a, an expansion valve or orifice 106, a cold water-producing liquid-filled evaporator 104, a refrigerant gas shut-off valve 109a and refrigerant piping connecting these compositions, and the refrigerant is circulated through the centrifugal compressor 101, condenser 103, refrigerant liquid shut-off valve 108a, expansion valve or orifice 106, cold water-producing liquid-filled evaporator 104, refrigerant gas shut-off valve 109a, and centrifugal compressor 101 in that order. In the cold water-producing liquid-filled evaporator 104, the water supplied is cooled through heat exchange with the refrigerant and discharged as cold water.

The hydrate slurry-producing refrigeration cycle includes a centrifugal compressor 101, a motor 102, a condenser 103, a refrigerant liquid shut-off valve 108b, an expansion valve or orifice 107, a hydrate slurry-producing evaporator 105, a refrigerant gas shut-off valve 109b and refrigerant piping connecting these composition, and the refrigerant flows through the centrifugal compressor 101, condenser 103, refrigerant liquid shut-off valve 108b, expansion valve or orifice 107, hydrate slurry-producing evaporator 105, refrigerant gas shut-off valve 109b, and centrifugal compressor 101 in that order. In the hydrate slurry-producing evaporator 105, the raw solution supplied is cooled through heat exchange with the refrigerant and discharged as hydrate slurry.

The hydrate slurry-producing evaporator 105 is not particularly limited in its kind, but preferably a liquid-filled evaporator. The hydrate-generating temperature varies according to the concentration of the raw solution; and thus, the hydrate slurry-producing evaporator is preferably an evaporator allowing easy and high-accuracy control of the refrigerant temperature (in particular, vaporization temperature), because the concentration varies, as the clathrate hydrate is generated in the raw solution. For that reason, a liquid-filled evaporator higher in heat transfer efficiency that allows high-accuracy control of the refrigerant temperature (in particular, refrigerant vaporization temperature) would be favorable as the hydrate slurry-producing evaporator.

The switching means for each refrigeration cycle includes expansion valves or orifices 106 and 107, refrigerant liquid shut-off valves 108 (108a and 108b), refrigerant gas shut-off valves 109 (109a and 109b), drive devices driving these compositions (K1 to K4) and a control device CTL controlling the drive devices (not shown in the figure). The switching means allows selective connection to the hydrate slurry-producing evaporator or to the cold water-producing liquid-filled evaporator, thus switching of the hydrate slurry-producing refrigeration cycle and the cold water-producing refrigeration cycle, configuring a single refrigeration cycle as a whole. At least the centrifugal compressor 101 and the condenser 103, more specifically the centrifugal compressor 101, the motor 102, the condenser 103 and the refrigerant piping connecting the same to each other, constituting the single refrigeration cycle are used both in the hydrate slurry-producing refrigeration cycle and the cold water-producing refrigeration cycle.

### <Operation of Refrigerator and Operation Method>

Hereinafter, the operation and the operation method of the refrigerator will be described. For blockage of the flow of refrigerant, only one of the refrigerant liquid shut-off valves (108a and 108b) or the refrigerant gas shut-off valves (109a and 109b) is needed, but presence of both shut-off valves is assumed in the following description.

### (1) When the Hydrate Slurry is Produced by Using the Hydrate Slurry-Producing Evaporator 105

First, the expansion valve or orifice 106 is turned closed (in no operation), while at least one of the refrigerant liquid shut-off valve 108a and the refrigerant gas shut-off valve 109a is closed by the switching means, and then, the expansion valve or orifice 107 is turned open (in operation), as the cold refrigerant liquid shut-off valve 108b and the refrigerant gas shut-off valve 109b are opened. In this way, formed is a refrigerant flow route in the hydrate slurry-producing refrigeration cycle (route along the dotted line arrow in the figure).

Then, the refrigerant gas is compressed, while the centrifugal compressor 101 is driven by the motor 102. The refrigerant gas compressed by the centrifugal compressor 101 is sent to the condenser 103, where it is cooled with cooling water. The refrigerant becomes almost saturated liquid by the cooling. The refrigerant liquid is then sent to the expansion valve or orifice 107, where it is placed under reduced pressure. The refrigerant liquid under reduced pressure is sent to the hydrate slurry-producing liquid-filled evaporator 5, generating clathrate hydrate by cooling the raw solution flowing inside the heat transfer tube in the hydrate slurry-producing evaporator 105 and thus giving a hydrate slurry of the hydrate dispersed or suspended in the raw solution, while it is vaporized into gas. The gasified refrigerant is sent back to the centrifugal compressor 101, and the circulation above is continued thereafter. Thus, the refrigerant flows only through the hydrate slurry-producing evaporator 105.

As a result, the raw solution is cooled in the hydrate slurry-producing evaporator 105, giving a hydrate slurry.

### (2) When Cold Water is Produced by Using the Cold Water-Producing Liquid-Filled Evaporator 104

The expansion valve or orifice 107 is turned closed (no operation), while at lease one of the refrigerant liquid shut-off valve 108b and refrigerant gas shut-off valve 109b is closed by the switching means, and the expansion valve or orifice 106 is turned open (in operation), while both of the refrigerant liquid shut-off valve 108a and the refrigerant gas shut-off valve 109a are opened. In this way, formed is a refrigerant flow route in the cold water-producing refrigeration cycle (route along the solid line arrow in the figure).

Then, the refrigerant gas is compressed, while the centrifugal compressor 101 is driven by the motor 102. The refrigerant gas compressed by the centrifugal compressor 101 is sent to the condenser 103, where it is cooled with cooling water. The refrigerant becomes almost saturated liquid by the cooling. The refrigerant liquid is then sent to the expansion valve or orifice 106, where it is placed under reduced pressure. The refrigerant liquid under reduced pressure is sent to the cold water-producing liquid-filled evaporator 104, cooling the water flowing inside the heat transfer tube of the cold water-producing liquid-filled evaporator 104 into cold water, while it is vaporized into gas. The gasified refrigerant is sent back to the centrifugal compressor 101, and the circulation above is continued thereafter. Thus, the refrigerant flows only through the cold water-producing liquid-filled evaporator 104.

As a result, the water supplied is cooled, giving cold water, in the cold water-producing liquid-filled evaporator 104.

### (3) Temperature Condition During Production of Cold Water and Hydrate Slurry

(3-1) The temperature of the cold water and the hydrate slurry respectively produced in the cold water-producing liquid-filled evaporator 104 and the hydrate slurry-producing evaporator 105 (exit temperature respectively of the evaporators 104 and 105) is set to about 4 to 8° C. In the case of a cold water air-conditioning facility, the lowest temperature is 4° C. for suppression of the freezing problems described above, while the highest temperature is approximately 8° C., because the temperature demanded in the cooling load apparatus (such as air conditioner, AHU, or FCU) is generally 7 to 8° C. The same is true for hydrate slurry air-conditioning facilities.

(3-2) If the refrigerant vaporization temperature of the cold water-producing liquid-filled evaporator 104 is designed to be identical with that of the hydrate slurry-producing evaporator 105, the operation condition of the centrifugal compressor 101 is the same, independently of whether the hydrate slurry-producing refrigeration cycle or the cold water-producing refrigeration cycle is used.

For example, if the refrigerant vaporization temperature and the cold-water outlet temperature in the cold water-producing liquid-filled evaporator 104 are designed respectively to be 2° C. and 5° C. and the refrigerant vaporization temperature and the hydrate-slurry outlet temperature in the hydrate slurry-producing evaporator 105 respectively to be 2° C. and 5° C., because the refrigerant vaporization temperature of each evaporator 104 or 105 is 2° C., the operation condition of the centrifugal compressor 101 is the same, independently of whether it constitutes the hydrate slurry-producing refrigeration cycle or the cold water-producing refrigeration cycle.

Therefore, in such a design, the compressor 101 is used both in the hydrate slurry-producing refrigeration cycle and the cold water-producing refrigeration cycle, and there is no need for changing the operation condition of the compressor 101 according to the change in refrigeration cycle.

### <Brief Summary>

Accordingly, in the refrigerator used in the present Example, the hydrate slurry-producing evaporator and the cold water-producing liquid-filled evaporator can be connected selectively to a single refrigeration cycle by the switching means, and the cold water-producing refrigeration cycle and the hydrate slurry-producing refrigeration cycle are switched selectively. Therefore, it is a single refrigerator applicable both to a hydrate slurry air-conditioning facility and a cold water air-conditioning facility, or alternatively both to an air-conditioning facility in the operation mode of producing the hydrate slurry at night and in the operation mode of producing the cold water during daytime (in particular, combined operation). At least a centrifugal compressor 101 and a condenser 103, more specifically a centrifugal compressor 101, a motor 102, a condenser 103 and a refrigerant piping connecting these composition, are used in both refrigeration cycles. Therefore, such a facility may be constructed relatively at a lower cost and provides a higher cost performance.

The centrifugal compressor 101 is drawn as a single-stage compressor in the figure, but may be a multi-stage compressor. Because multi-stage compressors are more expensive than single-stage compressors, the advantageous effects of the present invention, i.e., relative reduction of the facility cost and relative improvement in cost performance by use of a single compressor, are more obvious in a multi-phase compressor than in a single-stage compressor.

In the refrigerator 100 shown in FIG. 21, the functions of two refrigerant shut-off valves (108a and 108b) may be provided by a three-way valve placed at the position of P. Alternatively, the functions of two refrigerant gas shut-off valves (109a and 109b) may be provided by a three-way valve placed at the position of Q.

The expansion valves or orifices 106 and 107 respectively may have a drive device (not shown in the figure) for control of the opening of the control device CRL (not shown in the figure). The opening of the expansion valve or orifice 106 or 107 can be thus regulated according to each refrigeration cycle, to provide a favorable operation condition in each refrigeration cycle. For example, the opening of the expansion valve or orifice 106 or 107 is so regulated that the degree of superheating is controlled to a particular constant value by detection of the superheating degree of the evaporator outlet refrigerant gas. The opening of the expansion valve or orifice 106 or 107 is so regulated that the position of the liquid surface is kept constant by detection of the liquid surface position with a liquid level indicator installed in the evaporator.

### <Basic Configuration of Air-Conditioning Facility>

Hereinafter, other composition devices shown in FIG. 21 will be described.

In FIG. 21, 111 represents a cooling tower; 112 represents a three-way valve; 113 represents a buffer tank; 114 represents a hydrate slurry thermal storage tank; 115 represents a cold water/hydrate slurry heat exchanger; 116 represents a heat-consuming sided load (e.g., air conditioner); 117 to 121 each represent a pump, in particular 117 is a hydrate slurry-recirculating pump; 118 represents an raw solution-conveying pump; 119 represents a hydrate slurry-withdrawing pump; 120 represents a cold water-conveying pump; and 121 represents a cooling water-conveying pump. 122 represents a flowmeter; 123 to 127 and 130 to 132 each represent a temperature sensor; and 128 and 129 each represent an on-off valve.

The hydrate slurry thermal storage tank 114 has a level indicator (not shown in the figure) for detection of the volume of the hydrate slurry.

The air-conditioning facility shown in FIG. 21 has a refrigerator 100; a circulation route A of the cooling water/water between the cooling tower 111 and the condenser 103; a circulation route B of the cold water/water between the cold water-producing liquid-filled evaporator 104 and the heat-consuming sided load 116; a circulation route C of the hydrate slurry/raw solution between the hydrate slurry-producing heat exchanger 5 and the hydrate slurry thermal storage tank 114; a recirculation route D of the hydrate slurry between the hydrate slurry-producing evaporator 105 and the buffer tank 113; a circulation route E of the hydrate slurry/raw solution between the hydrate slurry thermal storage tank 114 and the cold water/hydrate slurry heat exchanger 115; and a circulation route F of the cold water/water between the cold water/hydrate slurry heat exchanger 115 and the heat-consuming sided load 116.

The route A is a piping route extending on 111, 112, 121, 123, 103, point M, and 111, while the route B, a piping route extending on 104, 124, point S, 116, 120, point R, 129 and 104. The route C is a piping route extending on 105, 113, 126, 114, 118, point N, 122, 105, 130, and 113, while the route D is a piping route extending on 105, 113, 117, point N, 122, and 105. The route E is a piping route extending on 114, 119, 115, and 114, while the route F is a piping route extending on 115, 127, point S, 116, 120, point R, and 115.

Cold water is produced and the heat energy of the cold water is used in the heat-consuming sided load by the route A and the refrigerator and the route B; the hydrate slurry is produced and stored by the route A, the refrigerator, and the routes C and D; and the heat energy of the stored hydrate slurry is used in the heat-consuming sided load by the routes E and F.

### (1) Route A

Along the route A, cooling water passed through the cooling tower 111 is conveyed by the pump 121, fed, via the three-way valve 112, pump 121, and temperature sensor 123, into the condenser 103, and heat-exchanged in the condenser 103 for condensation of the refrigerant gas, and then, sent back to the cooling tower 111 as water at an elevated temperature. The circulation is repeated thereafter.

Temperature control of the cooling water is performed by operation of the three-way valve 112, based on the output from the temperature sensor 123 monitoring the temperature of the cooling water supplied to the condenser 103. Thus, if the cooling water temperature is lower than a targeted value, the drive quantity of three-way valve 112 corresponding to the deviation is calculated by TIC, and the three-way valve 112 is driven in that quantity, allowing withdrawal of water at a relatively high temperature into the cooling water from the point M. If the cooling water temperature is higher than a targeted value, the cooling water temperature is lowered, supply of the water at a relatively high temperature from the point M is restricted by operation of the three-way valve 112.

### (2) Route B

The route B is a route wherein the refrigerator 100 constitutes the cold water-producing refrigeration cycle. Along the route, cold water fed from the cold water-producing liquid-filled evaporator 104 is conveyed by the pump 120 to the heat-consuming sided load 116 for utilization of the heat, and fed by the pump 120, via the point R and then on-off valve 129, back to the cold water-producing liquid-filled evaporator 104, as water at an elevated temperature. The circulation is repeated thereafter.

Temperature control of the cold water is performed by changing the rotational frequency of the compressor 101 as required by inverter control of the motor 102, based on the output of the temperature sensor 124 monitoring the temperature the cold water fed from the cold water-producing liquid-filled evaporator 104. Thus, if the cold water temperature is lower than a targeted value and the output of the temperature sensor 124 is lower than setting, the refrigerant vaporization temperature and the cold-water outlet temperatures in the cold water-producing liquid-filled evaporator 104 are raised, as the change in output of motor 102 corresponding to the deviation is calculated by TIC and the rotational frequency of the motor 102, thus compressor 101, is lowered only by the calculated value. On the other hand, if the cold water temperature is higher than a targeted value and the output of the temperature sensor 124 is higher than a setting, the refrigerant vaporization temperature and the cold-water outlet temperatures in the cold water-producing liquid-filled evaporator 104 is lowered, as the change in output of motor 102 corresponding to the deviation is calculated by TIC and the rotational frequency the motor 102, thus the compressor 101, is raised only by the calculated value. The control is continued, until the deviation between the output of the temperature sensor 124 and the setting value becomes zero.

### (3) Routes C and D

Both routes C and D are routes wherein the refrigerator 100 constitutes the hydrate slurry-producing refrigeration cycle. The route D is a route wherein the hydrate slurry is added from the buffer tank 113 into the route C for control of the flow rate of the raw solution fed to the hydrate slurry-producing evaporator 105.

(3-1)

Along the route C, the raw solution previously stored in the hydrate slurry thermal storage tank 114 is conveyed by the pump 118, blended at the point N with the hydrate slurry fed from the buffer tank 113 by the pump 117, and sent to the hydrate slurry-producing evaporator 105, for heat exchange with the refrigerant liquid in the hydrate slurry-producing evaporator 105. Here, the raw solution is cooled, and the hydrate slurry produced. Thus, the clathrate hydrate is generated in the cooled raw solution, giving a hydrate slurry, as the generated hydrate is dispersed or suspended in the raw solution. The hydrate slurry is passed through the hydrate slurry-producing evaporator 105, and a part of it is stored in the buffer tank 113 and the other is sent to the hydrate slurry thermal storage tank 114 for storage there. Repeated circulation of the raw solution/hydrate slurry between the hydrate slurry-producing evaporator 105 and the hydrate slurry thermal storage tank 114 leads to increase in the solid phase rate of the hydrate slurry stored in the buffer tank 113 and the hydrate slurry thermal storage tank 114, and thus to gradual increase of the thermal storage quantity.

Temperature control of the hydrate slurry is performed at least by one of the following methods (i) and (ii):

(i) The rotational frequency of the compressor 101 is altered as required by inverter control of the motor 102, based on the output of the temperature sensor 126 monitoring the temperature of the hydrate slurry fed to the hydrate slurry thermal storage tank 114. Specifically, if the hydrate slurry temperature is lower than a targeted value and thus the output of the temperature sensor 126 is lower than a setting, the refrigerant vaporization temperature is raised in the hydrate slurry-producing evaporator 105, and additionally, the temperature of the hydrate slurry outlet and of the hydrate slurry sent from the buffer tank 113 to the hydrate slurry thermal storage tank 114 is raised, as the change in output of the motor 102 corresponding to the deviation motor 102 is calculated by the TIC and the rotational frequency of the motor 102, thus the compressor 101, is lowered only by the calculated value. If the hydrate slurry temperature is higher than a targeted value and thus the output of the temperature sensor 126 is higher than a setting, the refrigerant vaporization temperature is lowered in the hydrate slurry-producing evaporator 105, and additionally, the temperature of the hydrate slurry outlet and of the hydrate slurry sent from the buffer tank 113 to the hydrate slurry thermal storage tank 114 is lowered, as the change in output of the motor 102 corresponding to the deviation motor 102 is calculated by the TIC and the rotational frequency of the motor 102, thus the compressor 101 is raised only by the calculated value. The control is continued, until the deviation between the output of the temperature sensor 126 and the setting value becomes zero.

(ii) The feed rate of the raw solution to the hydrate slurry-producing evaporator 105 (including the hydrate slurry as a raw solution) is altered as required by inverter control of the pump 118, based on the output of the temperature sensor 126. Specifically, if the hydrate slurry temperature lower than a targeted value and the output of the temperature sensor 126 is lower than a setting, the feed rate of the raw solution to the hydrate slurry-producing evaporator 105 is raised and the hydrate-slurry outlet temperature is raised, as the change in output of the motor 118 corresponding to the deviation motor is calculated by the TIC and the output of the motor 118 is raised only by the calculated value. If the hydrate slurry temperature exceeding a targeted value and the output of the temperature sensor 126 is larger than a setting, the feed rate of the raw solution to the hydrate slurry-producing evaporator 105 is lowered and the hydrate-slurry outlet temperature is lowered, as the change in output of the motor 118 corresponding to the deviation motor is calculated by the TIC and the output of the motor 118 is lowered only by the calculated value. The control is continued, until the deviation between the output of the temperature sensor 126 and the setting value becomes zero.

(3-2)

Along the route D, a part of the hydrate slurry fed from the hydrate slurry-producing evaporator 105 for storage in the buffer tank 113 is withdrawn by the pump 117, blended with the raw solution conveyed by the pump 118 (including the hydrate slurry as an raw solution) at the point N, and delivered to the hydrate slurry-producing evaporator 105 for heat exchange with the refrigerant liquid in the hydrate slurry-producing evaporator 105.

Here, the raw solution is cooled, and the hydrate slurry produced. Specifically, the clathrate hydrate is generated in the cooled raw solution, giving a hydrate slurry, as the generated hydrate is dispersed or suspended in the raw solution. The hydrate slurry is passed through the hydrate slurry-producing evaporator 105, and a part of it is stored in the buffer tank 113 and the other is sent to the hydrate slurry thermal storage tank 114 for storage there. Repeated circulation of the raw solution/hydrate slurry between the hydrate slurry-producing evaporator 105 and the buffer tank 113 leads to increase in the solid phase rate of the hydrate slurry stored in the buffer tank 113 and the hydrate slurry thermal storage tank 114, and thus to gradual increase of the thermal storage quantity.

When the hydrate slurry-producing evaporator 105 is a liquid-filled evaporator, the hydrate slurry is preferably produced, as a part of the hydrate deposited on the heat transfer tube inner wall surface is preferably removed by the flow force of the raw solution (or the hydrate slurry as an raw solution) and the other remains as it covers on the heat transfer tube inner wall surface.

The flow rate is then controlled for regulation of the flow rate of the raw solution flowing inside the heat transfer tube to a particular value or more. The flow rate control of the raw solution supplied to the hydrate slurry-producing evaporator 105 (including the hydrate slurry as an raw solution) is performed, by regulating the flow rate of the hydrate slurry fed from the buffer tank 113 to the point N as required by inverter control of the pump 117, based on the output of the flowmeter 122 monitoring the flow rate of the raw solution supplied to the hydrate slurry-producing evaporator 105. Specifically, if the flow rate of the raw solution is smaller than a targeted value and the output of the flowmeter 122 is lower than a setting, the flow rate of the hydrate slurry fed from the buffer tank 113 to the point N is raised and the flow rate of the raw solution fed from the point N to the hydrate slurry-producing evaporator 105 is raised, as the change in output of the pump 117 corresponding to the deviation is calculated by FIC and the output of the pump 117 is raised by the calculated value. On the other hand, if the flow rate of the raw solution is larger than a targeted value and the output of the flowmeter 122 is larger than a setting, the flow rate of the hydrate slurry fed from the buffer tank 113 to the point N is decreased and the flow rate of the raw solution fed from the point N to the hydrate slurry-producing evaporator 105 is decreased, as the change in output of the pump 117 corresponding to the deviation is calculated by FIC and the output of the pump 117 is lowered by the calculated value. The control is continued, until the deviation between the output of the flowmeter 122 and the setting value becomes zero.

(3-3)

The refrigerant vaporization temperature in the hydrate slurry-producing evaporator 105 is controlled to make the fluctuation width smaller.

Specifically, the rotational frequency of the compressor 101 is altered as required by inverter control of the motor 102, based on the output of the temperature sensor 125 monitoring the refrigerant temperature in the hydrate slurry-producing evaporator 105. More specifically, if the refrigerant vaporization temperature lower than a targeted value and thus the output of the temperature sensor 125 is lower than a setting, the refrigerant vaporization temperature in the hydrate slurry-producing evaporator 105 is raised, as the change in output of the motor 102 corresponding to the deviation motor 102 is calculated by the TIC and the rotational frequency of the motor 102, thus the compressor 101, is lowered only by the calculated value.

If the refrigerant vaporization temperature is higher than a targeted value and the output of the temperature sensor 125 is higher than a setting, the refrigerant vaporization temperature in the hydrate slurry-producing evaporator 105 is raised, as the change in output of the motor 102 corresponding to the deviation is calculated by TIC and the rotational frequency of the motor 102, thus the compressor 101, is raised only by the calculated value. The control is continued, until the deviation between the output of the temperature sensor 125 and the setting value becomes zero.

The sensor 125 may not a temperature sensor, and may be a pressure sensor monitoring the pressure of the refrigerant gas. There may be targeted values and settings (e.g., upper and lower limit values).

(3-4)

Production of the hydrate slurry starts in the route D.

In production of the hydrate slurry, an raw solution is stored in the buffer tank 113 and the raw solution is fed into the hydrate slurry-producing evaporator 105, as the pump 117 is activated, and cooled through heat exchange with a refrigerant liquid. It is possible to eliminate supercooling and thus to produce the hydrate slurry, by addition of a separately prepared hydrate slurry into the buffer tank 113 or by installing a means of eliminating supercooling of the raw solution. The hydrate-slurry outlet temperature in the hydrate slurry-producing evaporator 105 and the hydrate slurry temperature in the buffer tank 113 are measured and monitored respectively by the temperature sensors 130 and 131. When the output of the temperature sensor 130 or 131 reaches a particular value, the pump 118 is activated by manual operation by an operator or by a control signal (g7) from the control device CTL, superimposing the route C.

The raw solution previously stored in the hydrate slurry thermal storage tank 114 is conveyed by the pump 118, blended with the hydrate slurry conveyed from the buffer tank 113 at the point N, sent to the hydrate slurry-producing evaporator 105, and subjected to heat exchange with the refrigerant liquid in the hydrate slurry-producing evaporator 105, thus giving a cooled raw solution and a hydrate slurry. The hydrate slurry is fed from the hydrate slurry-producing evaporator 105, and a part of it is stored in the buffer tank 113, and the other is fed into and stored in the hydrate slurry thermal storage tank 114. For control of the flow rate of the raw solution flowing inside the heat transfer tube in the hydrate slurry-producing evaporator 105 to a constant rate of a particular value or more, based on the output of the flowmeter 122, the flow rate of the hydrate slurry fed from the buffer tank 113 to the hydrate slurry-producing evaporator 105 is regulated by inverter control of the pump 117. In production of the hydrate slurry, the route D is a hydrate slurry recirculation route for control of the flow rate of the raw solution conveyed to the hydrate slurry-producing evaporator 105. In addition, the pump 118 is so controlled that the output of the temperature sensor 126 monitoring the temperature of hydrate slurry fed to the hydrate slurry thermal storage tank 114 becomes a setting value (see (3-1) (ii) above).

(4) Routes E and F

The routes E and F are routes for thermal utilization of the heat energy of the hydrate slurry stored in the hydrate slurry thermal storage tank 114 (cold heat).

Along the route E, the hydrate slurry stored in the hydrate slurry thermal storage tank 114 is conveyed by the pump 119 into the cold water/hydrate slurry heat exchanger 115, subjected to heat exchange for making cold water from water in the cold water/hydrate slurry heat exchanger 115, and then, fed back to the hydrate slurry thermal storage tank 114 in the state of aqueous solution. The circulation is repeated thereafter. Along the route F, the cold water produced through heat exchange with the hydrate slurry in the cold water/hydrate slurry heat exchanger 115 is conveyed by the pump 120, used for thermal utilization in heat-consuming sided load 116, and then fed, via the pump 120, point R, and the on-off valve 128, back to the cold water/hydrate slurry heat exchanger 115, as water at an elevated temperature. The circulation is repeated thereafter. Therefore, the routes E and F are connected to each other thermally via the cold water/hydrate slurry heat exchanger 115, and thus, the heat energy corresponding to the latent heat of the hydrate slurry is supplied to the heat-consuming sided load 116, as it is converted to the heat energy corresponding to the sensible heat of cold water.

The cold-water outlet temperature in the cold water/hydrate slurry heat exchanger 115 is controlled, as the feed rate of the hydrate slurry into the cold water/hydrate slurry heat exchanger 115 is altered as required by inverter control of the pump 119, based on the output of the temperature sensor 127 monitoring the temperature of the cold water fed from the cold water/hydrate slurry heat exchanger 115. Specifically, if the cold water temperature is lower than a targeted value and the output of the temperature sensor 127 is lower than a setting, the feed rate of the hydrate slurry into the cold water/hydrate slurry heat exchanger 115 is reduced and the cold-water outlet temperature raised as the change in output of the pump 119 corresponding to the deviation is calculated by the TIC and the output of the pump 119 is reduced only by the calculated value. On the other hand, if the cold water temperature is higher than a targeted value and the output of the temperature sensor 127 is larger than a setting, the feed rate of the hydrate slurry into the cold water/hydrate slurry heat exchanger 115 is raised and the cold-water outlet temperature reduced, as the change in output of the pump 119 corresponding to the deviation is calculated by the TIC and the output of the pump 119 is raised only by the calculated value. The control is continued, until the deviation between the output of the temperature sensor 127 and the setting value becomes zero.

### <Operation of Air-Conditioning Facility and Operation Mode>

Entire operation of the air-conditioning facility shown in FIG. 21, including operation of the refrigerator, is controlled by the control device CTL. The operation method of the air-conditioning facility includes at least the following operation modes (M1) to (M4).

(M1) Operation mode supplying the cold water produced in the cold water-producing liquid-filled evaporator 104 to the heat-consuming sided load 116 (i.e., operation mode using the refrigerator and the route B)

In the operation mode, the control device CTL, by delivering control signals g1 to g4, turns on drive devices (K1 to K4) for the refrigerant shut-off valves 108a and 108b and the refrigerant gas shut-off valves 109a and 109b, and opening the shut-off valves 108a and 109a and closing the shut-off valves 108b and 109b, and thus configuring a cold water-producing refrigeration cycle in the refrigerator. Simultaneously, the control device CTL, by delivering control signals g5 and g6, turns on drive devices (K5 and K6) of the on-off valves 128 and 129, closing the valve 128 and opening the valve 129, and thus, connecting the heat-consuming sided load 116 to the route B and disconnecting it from the route F. In this way, the refrigerator and the route B are connected to each other via the cold water-producing liquid-filled evaporator 104, and only the cold water produced in the cold water-producing liquid-filled evaporator 104 is supplied to the heat-consuming sided load 116.

(M2) Operation mode of supplying the hydrate slurry produced in the hydrate slurry-producing evaporator 105 to the hydrate slurry thermal storage tank 114 (i.e., operation mode of using the refrigerator and the routes C and D)

In the operation mode, the control device CTL, by delivering control signals g1 to g4, turns on respective drive device (K1 to K4), closing the shut-off valves 108a and 109a and opening the shut-off valves 108b and 109b and configuring a hydrate slurry-producing refrigeration cycle in the refrigerator. In this way, the refrigerator and the routes C and D are connected to each other via the hydrate slurry-producing evaporator 105, and the hydrate slurry produced in the cold water-producing liquid-filled evaporator 104 is supplied to the hydrate slurry thermal storage tank 114.

(M3) Operation mode of supplying the heat energy of the hydrate slurry stored in the hydrate slurry thermal storage tank 114 to the heat-consuming sided load 116 (i.e., operation mode of using the routes E and F)

In the operation mode, the control device CTL, by delivering control signals g5 and g6, turns on respective drive devices (K5 and K6) for the on-off valves 128 and 129, opening the valve 128 and closing the valve 129, and thus, disconnecting the heat-consuming sided load 116 from the route B and connecting it to the route F. Thus, the heat-consuming sided load 116 and the hydrate slurry thermal storage tank 114 are connected to each other via the route E, the cold water/hydrate slurry heat exchanger 115 and the route F; and the heat energy corresponding to the latent heat of the hydrate slurry stored in the hydrate slurry thermal storage tank 114 is supplied to the heat-consuming sided load 116 as the heat energy corresponding to the sensible heat of the cooled water by heat exchange between the hydrate slurry and water in the cold water/hydrate slurry heat exchanger 115.

(M4) Other operation mode: operation mode of supplying the heat energy of the hydrate slurry to the heat-consuming sided load 116 before the hydrate slurry produced in the hydrate slurry-producing evaporator 105 is stored in the hydrate slurry thermal storage tank 114 sufficiently (i.e., operation mode of using the refrigerator, routes C and D, and additionally routes E and F)

In the operation mode, the control device CTL, by delivering control signals g1 to g4, turns on respective drive devices (K1 to K4), closing the shut-off valves 108a and 109a and opening the shut-off valves 108b and 109b, and thus configuring a hydrate slurry-producing refrigeration cycle in the refrigerator. Simultaneously, the control device CTL, by delivering control signals g5 and g6, turns on respective drive devices (K5 and K6) for the on-off valves 128 and 129, opening the valve 128 and closing the valve 129, and thus disconnecting the heat-consuming sided load 116 from the route B and connecting it to the route F.

In this way, the refrigerator and the routes C and D are connected to each other via the hydrate slurry-producing evaporator 105; the hydrate produced in the slurry cold water-producing liquid-filled evaporator 104 is supplied to the hydrate slurry thermal storage tank 114; and additionally, the heat-consuming sided load 116 and the hydrate slurry thermal storage tank 114 are connected to each other, via the route E, the cold water/hydrate slurry heat exchanger 115 and the route F, and the heat energy corresponding to the latent heat of the hydrate slurry stored in the hydrate slurry thermal storage tank 114 is supplied to the heat-consuming sided load 116 as the heat energy corresponding to the sensible heat of cooled water, by heat exchange between the hydrate slurry and water in the cold water/hydrate slurry heat exchanger 115.

### <Typical Examples of the Operation Methods of Air-Conditioning Facility>

### (1) Thermal Storage Operation at Night

Operation for production of hydrate slurry and storage thereof in the thermal storage tank, i.e., thermal storage operation, is performed at night. In thermal storage operation in the air-conditioning facility shown in FIG. 21, the air-conditioning facility is operated in the (M2) operation mode, as the hydrate slurry-producing evaporator 105, not the cold water-producing liquid-filled evaporator 104, is connected to the refrigeration system, forming a hydrate-producing refrigeration system in the refrigerator 100. In such a case, the hydrate slurry-producing evaporator 105 is so controlled that the fluctuation width of the refrigerant vaporization temperature thereof is minimized. Specifically, the rotational frequency of the compressor 101 is altered as required by inverter control of the motor 102, so that the deviation between the output of the temperature sensor 125 monitoring the temperature of the refrigerant liquid in the hydrate slurry-producing evaporator 105 and a setting value becomes zero.

When the hydrate slurry-producing evaporator 105 is a liquid-filled evaporator, the hydrate slurry is produced, as a part of the hydrate deposited on the heat transfer tube inner wall surface is preferably removed by the flow force of the raw solution (or hydrate slurry as an raw solution) and the other remains as it covers on the heat transfer tube inner wall surface. It is important then to control the flow rate of the raw solution flowing inside the heat transfer tube constant and not to reduce the refrigerant vaporization temperature in the liquid-filled evaporator excessively. Then, the flow rate of the hydrate slurry fed from the buffer tank 113 to the point N is altered as required by inverter control of the pump 117 for recirculation of the hydrate slurry, so that the flow rate of the raw solution fed from the point N to the hydrate slurry-producing evaporator 105 becomes a targeted value or the deviation between the output of the flowmeter 122 and the setting value becomes zero. (see <basic configuration of air-conditioning facility> (3-2) and (3-4)).

At the same time, the rotational frequency of the compressor 101 is altered as required by inverter control of the motor 102 so that the deviation between the output of the temperature sensor 125 monitoring the temperature of the refrigerant liquid in the hydrate slurry-producing evaporator 105 and the setting value becomes zero (see <basic configuration of air-conditioning facility> (3-3)).

It is also possible to control the motor 102 to make the output of the temperature sensor 125 become not lower than a particular value and to change the rotational frequency of the compressor 101 adequately, depending on the values of setting, and such an operation mode may be used in the thermal storage operation of the air-conditioning facility shown in FIG. 21 (independently of whether the hydrate slurry-producing evaporator 105 is a liquid-filled evaporator or not). In production of the hydrate slurry in the route D, when the hydrate-slurry outlet temperature in the hydrate slurry-producing evaporator 105 or the hydrate slurry temperature in the buffer tank 113 becomes a particular value, the pump 118 is activated, superimposing the route C, and the pump 118 is so controlled that the hydrate slurry inlet temperature in the hydrate slurry thermal storage tank 114 becomes a setting value (see <basic configuration of air-conditioning facility> (3-4)).

When the hydrate slurry thermal storage tank 114 is filled with the hydrate slurry or the thermal storage period lapses, the centrifugal compressor 101 and the motor 102 are turned off and the pumps 118 and 117 are turned off by manual operation by an operator or by the control signals form the control device CTL.

If there are problems in production of the hydrate slurry by increase in the amount of the hydrate deposited on the heat transfer tube inner wall surface of the hydrate slurry-producing evaporator 105 and also in pressure drop in the heat transfer tube during the thermal storage operation, it is needed to take a melting operation to remove the deposited hydrate by melting.

A communicating bypass route connecting the hydrate slurry-producing evaporator 105 to the condenser 103, by passing the compressor 101 of the refrigerator, and additionally a bypass valve opening/closing the bypass route may be formed for melting operation. When there is such a bypass valve formed, the compressor 101 and the motor 102 are turned off the bypass valve is opened, and the hydrate slurry-producing evaporator 105 is connected to the condenser 103, bypassing the compressor 101 during melting operation. In this way, the high-temperature high-pressure refrigerant in the condenser 103 flows via the bypass route into the hydrate slurry-producing evaporator 105, and it is possible to remove the hydrate deposited in the heat transfer tube by melting it with the heat of the high temperature high-pressure refrigerant in the condenser 103.

### (2) Operation During Daytime

### (2-1) Operation by Using Stored Heat

Operation to cool the heat-consuming sided load 116, i.e., air conditioning operation, is conducted during daytime by using the heat energy of the hydrate slurry stored in the hydrate slurry thermal storage tank 114 (heat energy (cold heat energy)). If the stored heat-consuming operation is carried out in the air-conditioning facility shown in FIG. 21, the air-conditioning facility is operated in the (M3) operation mode. In such a case, the pump 119 is controlled to regulate the cold-water outlet temperature in the cold water/hydrate slurry heat exchanger 115 to a targeted value (see <basic configuration of air-conditioning facility> (4)).

### (2-2) Combined Refrigerator Operation

This operation is an air conditioning operation employed when the cold heat of the hydrate slurry stored in the hydrate slurry thermal storage tank 114 is insufficient for satisfying the cold heat needed for cooling the heat-consuming sided load 116 and thus additional cold heat of cold water should be separately prepared for compensation.

For example, in the refrigerator according to the invention, the cold water-producing liquid-filled evaporator 104, not the hydrate slurry-producing evaporator 105, is connected to the refrigeration system, forming a cold water-producing refrigeration system, and the air-conditioning facility is operated in the (M1) operation mode. The rotational frequency of the centrifugal compressor 101 is controlled then to make the cold-water, outlet temperature constant by monitoring the temperature with a temperature sensor 124 installed at the outlet side of the cold water-producing liquid-filled evaporator 104. Then, the on-off valve 128 is opened, conveying the cold water from the cold water/hydrate slurry heat exchanger 115 and the cold water from the cold water-producing liquid-filled evaporator 104 to the heat-consuming sided load 116. It is thus possible to supply the cold heat energy of both cold waters to the heat-consuming sided load 116.

In another example, the cold heat energy of the hydrate slurry stored in the hydrate slurry thermal storage tank 114 is first heat-exchanged with the cold water in the cold water/hydrate slurry heat exchanger 115, and the cold heat energy of the cold water is supplied to the heat-consuming sided load 116 for consumption as much as possible (no need for complete consumption). Then, the air-conditioning facility is operated in the (M1) operation mode, allowing supply of the cold heat energy of the cold water produced in the cold water-producing liquid-filled evaporator 104 to the heat-consuming sided load 116.

The combined operation may be performed by anyone of the methods in the examples above.

Hereinafter, an example of the turbulence-generating means of generating turbulence in the flow of the raw solution or slurry flowing inside the heat transfer tube of the hydrate slurry-producing apparatus according to the present invention will be described below.

### Example 4

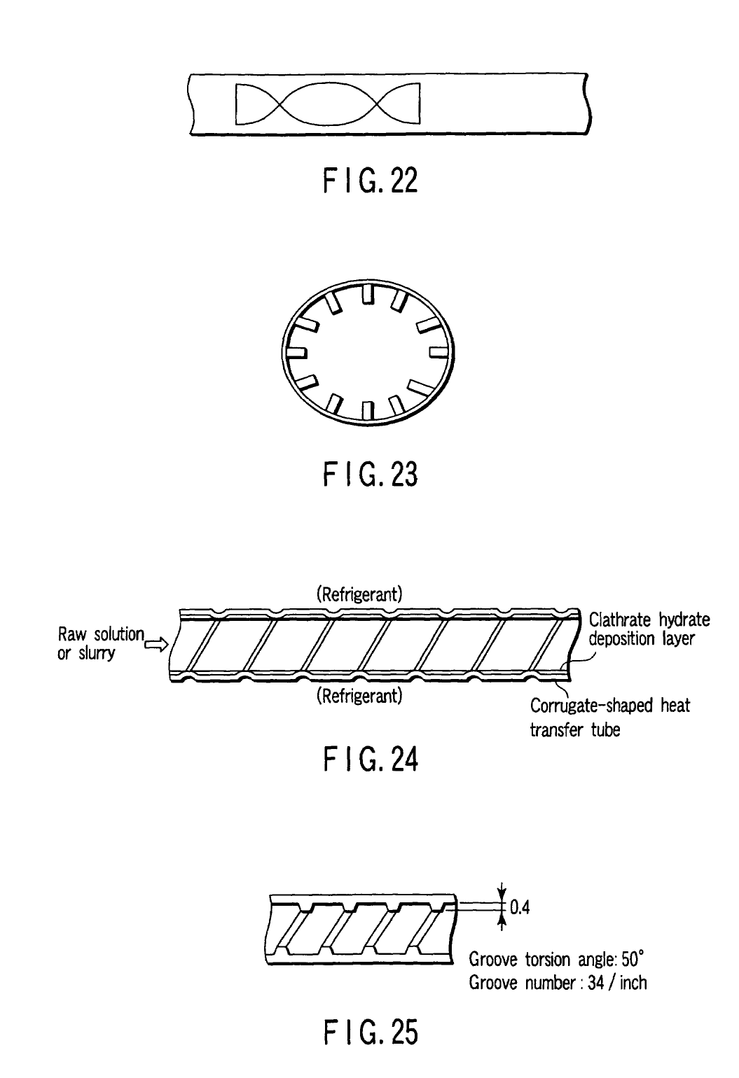

FIG. 22 is a view illustrating an example of the turbulence-generating means in the twisted blade shape. It is possible to accelerate convective heat transfer and improve the heat transfer efficiency from the refrigerant to the raw solution or slurry by placing a twisted blade in a heat transfer tube, generating turbulence by circulating the flow of the raw solution or slurry with the twisted blade and agitating the boundary layer close to the heat transfer tube inner wall surface. The twisted blade may be inserted partially into the inlet of a heat transfer tube inlet or entirely into a heat transfer tube.

FIG. 23 is a view of another turbulence-generating means having protuberances (turbulence promoters) on the heat transfer tube inner surface. It is possible to accelerate the convective heat transfer and improve the heat transfer efficiency from the refrigerant to the raw solution or slurry by generating turbulence in the flow of the raw solution or slurry flowing inside the heat transfer tube and agitating the boundary layer close to the heat transfer tube inner wall surface with the protuberances. The shape of the protuberance (circular cylinder, rectangular, cone, flat plate), the dimension (height, width), the installation shape (vertical, inclined) and the arrangement interval and shape (checkerboard-like, zigzag, etc.) are not particularly limited, and are selected properly. In addition, it may be placed partially, for example, at the inlet for the heat transfer tube or entirely in the heat transfer tube.

Hereinafter, an example, wherein surface irregularity is formed on at least one of the heat transfer tube inner and outer wall surfaces along the flow direction of the aqueous solution or the slurry in the hydrate slurry-producing apparatus according to the present invention, will be described below.

### Example 5

FIG. 24 is a view illustrating a corrugate tube, an example of the tube having surface irregularities on the inner and outer wall surfaces of the heat transfer tube. Narrow protuberances are molded helically on the heat transfer tube inner wall surface, and there are recesses formed between the protuberances along the flow direction of the raw solution or slurry.

FIG. 25 is a view illustrating an inner surface-fluted tube, an example of a tube having surface irregularities on the heat transfer tube inner wall surface. Grooves having a depth of 0.4 mm are formed on the heat transfer tube inner wall helically at a torsion angle of 50°.

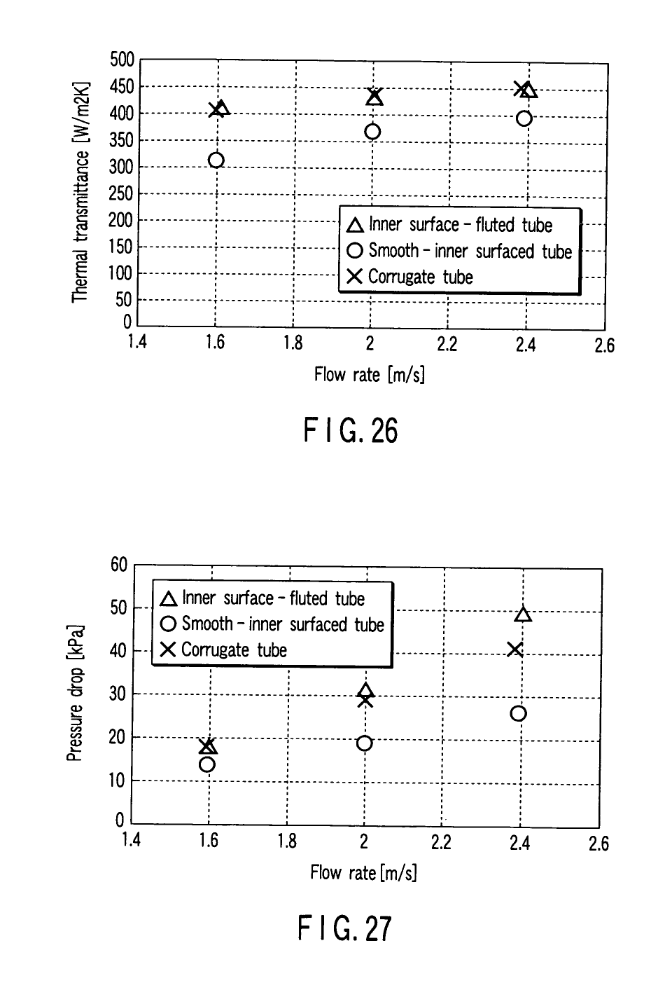

The change in heat transfer performance and pressure drop caused by the shape of the heat transfer tube inner wall surface are examined by using a single duplex tube test device. FIG. 26 is a chart showing the relationship between the flow rate in tube and the thermal transmittance. FIG. 27 is a chart showing the relationship between the flow rate in tube and the slurry pressure difference, as determined as pressure drop.

The heat transfer tubes used in the test were an innerly smooth-surfaced tube (inner diameter: 16.2 mm), an innerly surface-fluted tube (groove depth: 0.4 mm, groove number: 34/inch, model: TE-iE, manufactured by Hitachi Cable), and a corrugate tube (inner surface protuberance height: 0.6 mm, protuberance pitch: 14 mm, model: JISH3300, manufactured by Hitachi Cable).

As shown in FIG. 26, the thermal transmittance of the inner surface-fluted tube and the corrugate tube was larger by 14 to 32% than that of the smooth-inner surfaced tube. Because the inner surface-fluted tube and the corrugate tube have protuberance helically formed on the heat transfer tube inner wall surface, it is possible to accelerate convective heat transfer and improve the heat transfer efficiency from the refrigerant to the raw solution or slurry, by generating turbulence in the flow of the raw solution or slurry by circulation and agitating the boundary layer close to the heat transfer tube inner wall surface. The resulting swirling of the flow of raw solution or slurry increases the contact area thereof with the heat transfer tube inner wall surface, i.e., the heat transfer surface area, and thus, it is possible to improve the heat transfer efficiency further.

It is also possible to generate additional clathrate hydrate more easily, because the generated clathrate hydrate remains deposited in the recesses on the heat transfer tube inner wall surface, functioning as a product nucleus.

On the other hand, as shown in FIG. 27, the pressure drop (slurry pressure difference) in the inner surface-fluted tube or the corrugate tube becomes larger by 30 to 88% than that of the smooth-inner surfaced tube.

The increase in the pressure drop of heat transfer tube results in increase in the power of the pump needed for supply of the raw solution or slurry. Thus, in selecting the shape of the heat transfer tube inner wall surface, it is needed to select a suitable shape by taking into consideration both the heat transfer performance as an exchanger and the pump power.

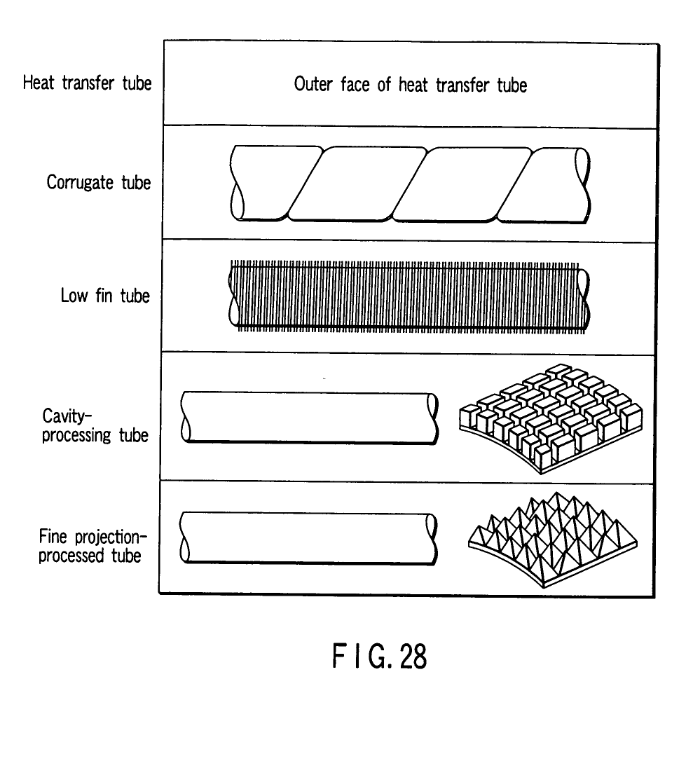

FIG. 28 is a chart showing other examples of the heat transfer tubes having irregularities on the outer wall surface. Examples thereof include low fin tubes having low fins formed on the outer wall surface of the heat transfer tube, and tubes having microcavities, microgrooves, microtunnel structures or microprotuberances formed by mechanical and molding processing on the outer wall surface.

Examples of the cavity-processing tubes include “Thermoexcel” (model: TE-E) manufactured by Hitachi Cable. It is a tube having fine openings on the outermost surface and spiral tunnels connecting the openings under the outermost surface, which generates air bubbles continuously and efficiently by heat exchange of the liquid refrigerant, and thus, it is a heat transfer tube giving an extremely high vaporization heat-transfer performance. The cavity-processing tube has a thermal transmittance of about 10 times larger than that of the low fin tube, and thus, has an extremely improved vaporization heat-transfer performance.

Use of such a heat transfer tube having irregularities on the outer wall surface leads to increase in the heat transfer surface area of the heat transfer tube, and consequently to improvement in the heat transfer efficiency from the refrigerant to the raw solution or slurry. Because the heat transfer efficiency is high, it is possible to produce the clathrate hydrate slurry even when the production refrigerant temperature is set to a relatively higher value, and thus, it is possible to reduce the load on the refrigerant-refrigerating system relatively or to improve the refrigerator performance coefficient.

Hereinafter, operation to remove the clathrate hydrate deposited on the heat-transfer surface of the heat exchanger for heat exchange between the raw solution or slurry and the refrigerant by melting in the apparatus for producing clathrate hydrate slurry according to the present invention (melting operation) will be described. Melting operation in the apparatus for producing clathrate hydrate slurry in an embodiment of the present invention shown in FIG. 16, when the heat exchanger is a compression-type refrigerator evaporator having a refrigeration cycle consisting of a compressor, a condenser, a pressure-reducing device, and an evaporator connect to the piping sequentially, will be described in the following example.

### Example 6

### Melting Operation of Clathrate Hydrate-Producing Apparatus

In Example 6, explained is a melting operation method of the clathrate hydrate-producing apparatus in which the clathrate hydrate deposited on the heat-transfer surface of the heat exchanger is removed by melting during operation of the clathrate hydrate-generating refrigeration cycle of generating the clathrate hydrate by cooling with the refrigerant flowing in the heat exchanger. The clathrate hydrate may be formed in the evaporator in the refrigeration cycle or in a heat exchanger installed separately from the evaporator.

The melting operation is useful for cooling the aqueous solution of a guest compound for clathrate hydrate with the refrigerant flowing in the heat exchanger and generating the clathrate hydrate in the aqueous solution stably or for maintenance of the heat exchanger, and particularly useful for producing the clathrate hydrate slurry containing the clathrate hydrate dispersed or suspended in the aqueous solution stably or continuously in a large amount.

In the description below, the following terms are defined as follows:

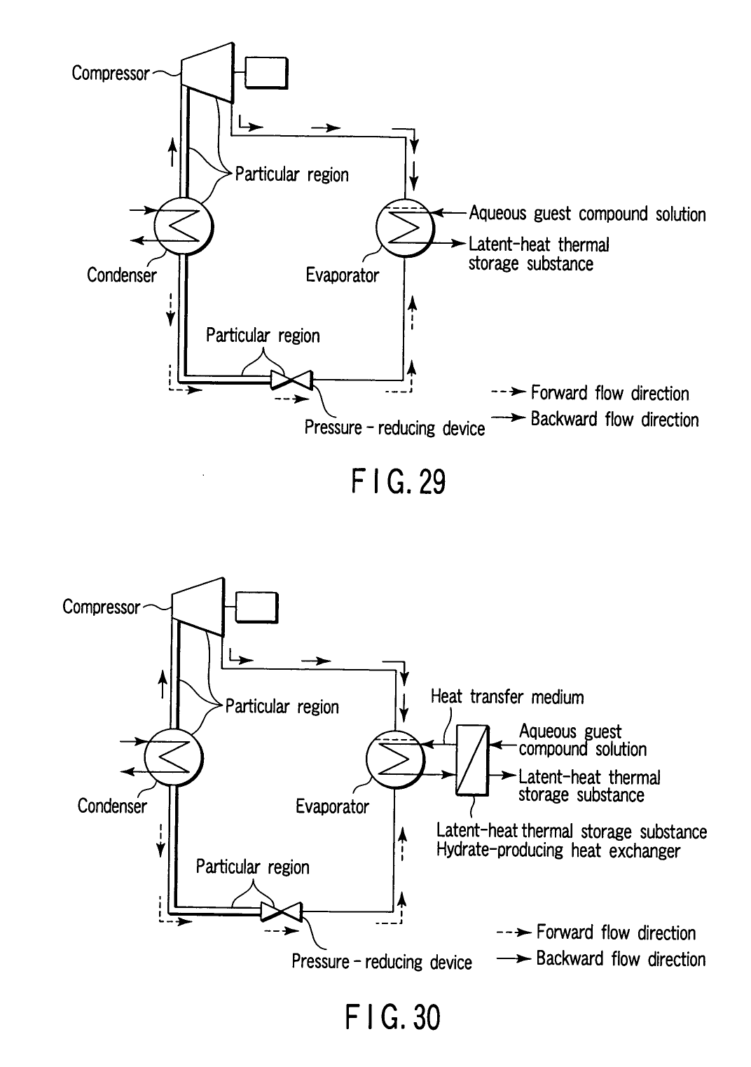

(1) The “refrigerant” and the “heat transfer medium” are both substances storing and conveying heat energy, although there are some differences in literal expression and also in application, for example for hydrate generation or condensation.
(2) When the refrigeration cycle includes a compressor, a condenser, a pressure-reducing device, and an evaporator connected to each other sequentially with piping and the refrigerant flowing through the piping is compressed, condensed, placed under reduced pressure and vaporized sequentially, “any region of or a region in the region of the compressor, condenser and piping connecting these compositions, and condenser, pressure-reducing device and the piping connecting these compositions” in the refrigeration cycle may be referred to as a “particular region”.
(3) The “forward flow” of the refrigerant is flow of the refrigerant in at least a part of the piping in the refrigeration cycle in the direction of a compressor, a condenser, a pressure-reducing device and an evaporator connected thereto in that order (counterclockwise in any one of FIG. 29 to 31), and the “back flow” of the refrigerant is flow of the refrigerant in at least a part of the piping in the refrigeration cycle in the direction of the evaporator, the pressure-reducing device, the condenser and the compressor (clockwise in any one of FIGS. 29 to 31).

When the clathrate hydrate is generated in the aqueous solution of a guest compound for clathrate hydrate by heat exchange thereof with the refrigerant, the clathrate hydrate deposited on the heat-transfer surface of the heat exchanger for heat exchange may lead to decrease in heat transfer efficiency, obstruction of piping and suppression of flow with the deposited clathrate hydrate becoming a physical obstacle. Typically to solve the problems above, deposition of the clathrate hydrate is suppressed or deposited clathrate hydrate is melted by raising the temperature of the raw solution or slurry in contact with the heat exchanger or the temperature of the refrigerant flowing in the heat exchanger.

For example, the clathrate hydrate deposited on the heat-transfer surface of heat exchanger was known to be melted by raising the refrigerant temperature during production of the clathrate hydrate by cooling the raw solution or slurry with the refrigerant in the heat exchanger (see Jpn. Pat. Appln. KOKAI Publication No. 2004-93052). Jpn. Pat. Appln. KOKAI Publication No. 2004-93052 discloses a method of removing the clathrate hydrate by melting, by terminating cooling of the raw solution and supplying the refrigerant at high temperature present in the refrigerator into the clathrate hydrate-producing heat exchanger (evaporator), as a method of eliminating obstruction, when the raw solution-circulating system is obstructed by the clathrate hydrate during production of the clathrate hydrate slurry by cooling the raw solution with the refrigerant at low temperature cooled in the refrigerator in the clathrate hydrate-producing heat exchanger (evaporator).

The method of raising the temperature of the refrigerant in the clathrate hydrate-producing heat exchanger rapidly and the method of removing the clathrate hydrate deposited on the heat-transfer surface of heat exchanger are desirably easier, cost-effective and lower in energy consumption.

On the other hand, when the refrigeration cycle for generating the heat energy for production of the clathrate hydrate has a configuration including a compressor, a condenser, a pressure-reducing device, and an evaporator connected to each other sequentially by piping, wherein the refrigerant flowing inside the piping is compressed, condensed, placed under reduced pressure and vaporized sequentially and the evaporator is a clathrate hydrate-producing heat exchanger, it is well known that the refrigerant present in any one of the compressor, the condenser, piping connecting these compositions, the condenser, the pressure-reducing device and piping connecting these compositions is in the high-temperature high-pressure state, compared to the refrigerant in the evaporator, and that the refrigerant (in particular, the refrigerant in the condenser and the refrigerant in the piping from the compressor ejection nozzle to the condenser) is in the high-temperature high-pressure state, compared to the refrigerant in the evaporator when the compressor is terminated or the output is reduced. Alternatively, a method of using the heat energy of the refrigerant for melting and removal of the clathrate hydrate was disclosed in Jpn. Pat. Appln. KOKAI Publication No. 2004-93052 disclosed.

However, the method disclosed in Jpn. Pat. Appln. KOKAI Publication No. 2004-93052 is based on the method of melting and removing the clathrate hydrate, by transporting the heat energy of the refrigerant through a bypass piping formed separately from the piping configuring the refrigeration cycle to the evaporator demanding melting and removal of the clathrate hydrate, while continuing normal operation of the compressor without termination or decrease in output of the compressor. Specifically, the high temperature refrigerant gas is supplied through a high temperature refrigerant gas-supplying bypass piping branched from the compressor outlet piping, or the high temperature refrigerant liquid is supplied to the evaporator demanding melting and removal of the clathrate hydrate through a high temperature refrigerant liquid-supplying bypass piping branched from the condenser outlet piping. Therefore, the clathrate hydrate-producing apparatus by the method disclosed in Jpn. Pat. Appln. KOKAI Publication No. 2004-93052 demands a high temperature refrigerant gas-supplying bypass piping or a high temperature refrigerant liquid-supplying bypass piping, and, thus, the apparatus has problems that it becomes complicated and expensive and also demands additional power, because the compressor should be always operated at the rated output or higher for melting and removal of the clathrate hydrate.

The melting operation method of the apparatus for producing clathrate hydrate slurry described in Example 6, which is invented, considering the problems associated with the method disclosed in Jpn. Pat. Appln. KOKAI Publication No. 2004-93052, is a melting operation method of melting the clathrate hydrate deposited on the heat-transfer surface of heat exchanger for production of clathrate hydrate that is easy and cost-effective and demands lower energy consumption because the heat energy of the relatively high-temperature high-pressure refrigerant present in the refrigeration cycle is used.

### <Basic Principle of Example 6>

### <When the Evaporator has a Clathrate Hydrate-Producing Heat Exchanger>

FIG. 29 is a explanatory diagram showing the basic principle of Example 6. FIG. 29 shows the devices configuring the refrigeration cycle, a compressor, a condenser, a pressure-reducing device and an evaporator, which are connected to each other by piping.

During operation of the compressor or immediately after termination thereof in the refrigeration cycle, the refrigerant present in any one of the compressor, condenser, the piping connecting these compositions, condenser, pressure-reducing device and the piping connecting these compositions has a high-pressure and high-temperature heat energy greater than that of the refrigerant in the evaporator. Thus, the region of the refrigerant having a high-pressure high-temperature heat energy greater than that of the refrigerant in the evaporator during operation of the compressor or immediately after termination thereof will be referred to as a particular region, and is shown in gray in FIG. 29.

Immediately after termination of the compressor or when the output from the compressor declines, if the valve on the piping from the evaporator, the compressor, to the condenser is not closed, the refrigerant present in the compressor, condenser and the piping connecting these compositions, which is more pressurized than the refrigerant in the evaporator, is fed back to the evaporator lower in pressure. It is thus possible to raise the temperature of the refrigerant in the evaporator by supplying the refrigerant having a high-pressure high-temperature heat energy to the evaporator.

Alternatively, if the valve on the piping from the condenser, the pressure-reducing device to the evaporator is not closed immediately after termination of the compressor or when the output from the compressor declines, the refrigerant present in the condenser, pressure-reducing device and the piping connecting these compositions, which is more pressurized than the refrigerant in the evaporator, is fed forward to the evaporator lower in pressure. It is thus possible to raise the temperature of the refrigerant in the evaporator by supplying the refrigerant having a high-pressure high-temperature heat energy to the evaporator.

Alternatively if the valve on the piping from the evaporator and the compressor to the condenser and the valve on the piping from the condenser and the pressure-reducing device to the evaporator are not closed immediately after termination of the compressor or when the output from the compressor declines, a part of the refrigerant present in any one of compressor, condenser, the piping connecting these compositions, condenser, pressure-reducing device and the piping connecting these compositions (particular region), which is more pressurized than the refrigerant in the evaporator, is fed back to the evaporator lower in pressure, and at least a part of the other fed forward. It is thus possible to raise the temperature of the refrigerant in the evaporator by supplying the refrigerant having a high-pressure high-temperature heat energy to the evaporator.

When the evaporator has a clathrate hydrate-producing heat exchanger, the clathrate hydrate is produced by cooling the aqueous solution of a guest compound for clathrate hydrate through heat exchange with the refrigerant.

In such a case, for melting of the clathrate hydrate deposited on the heat-transfer surface of heat exchanger for production of clathrate hydrate, it is possible to raise the temperature of the refrigerant in the evaporator, by supplying the heat energy of the refrigerant to the evaporator, as described above.

### <When the Evaporator has a Refrigerant/Heat-Transfer-Medium Heat Exchanger>

FIG. 30 is a explanatory diagram showing an expansion of the basic principle of Example 6 shown in FIG. 29, wherein the evaporator is refrigerant/heat-transfer-medium heat exchanger, which is a heat exchanger for heat exchange between the refrigerant and the heat transfer medium conveying the heat energy to the clathrate hydrate-producing heat exchanger.

The heat transfer medium is cooled through heat exchange with the refrigerant in the refrigerant stored in the evaporator/heat-transfer-medium heat exchanger, and aqueous solution of a guest compound for clathrate hydrate is cooled in the clathrate hydrate-producing heat exchanger through heat exchange with the heat transfer medium to give the clathrate hydrate.

For melting of the clathrate hydrate deposited on the heat-transfer surface of heat exchanger for production of clathrate hydrate, as described above, it is possible to raise the temperature of the refrigerant in the evaporator, by supplying the heat energy of the refrigerant to the evaporator and additionally by raising the temperature of the heat exchange with the refrigerant heat transfer medium to raise the temperature of the heat transfer medium in the clathrate hydrate-producing heat exchanger.

Such melting of the clathrate hydrate is the result of using the heat energy originally present in the refrigeration cycle and the piping configuring the refrigeration cycle, and such an operation advantageously does not demand additional device, apparatus, piping or others, and is thus, easy, cost-effective and lower in energy consumption.

Accordingly, the present invention provides a melting operation method of the apparatus for producing clathrate hydrate slurry that is easy, cost-effective and lower in energy consumption and allows melting of the clathrate hydrate deposited on the heat-transfer surface of heat exchanger for production of clathrate hydrate by supplying the heat energy of the refrigerant present in the particular region to the evaporator.

When the evaporator or its heat exchanger functions as a refrigerant/heat-transfer-medium heat exchanger, the method of supplying the heat energy of the heat transfer medium indirectly to a clathrate hydrate-producing heat exchanger installed outside the refrigeration cycle is not particularly limited, if the function and effect according to the present invention is obtained. In typical examples of the methods, (i) the heat transfer medium is supplied through a separately installed piping to the clathrate hydrate-producing heat exchanger and fed in the clathrate hydrate-producing heat exchanger; (ii) the heat energy is transmitted to another heat transfer medium by at least one heat exchange with the heat transfer medium and the separate heat transfer medium is supplied to the clathrate hydrate-producing heat exchanger and fed in the clathrate hydrate-producing heat exchanger; and (iii) the energy of the heat transfer medium is transmitted to the clathrate hydrate-producing heat exchanger via a heat transfer member thermally connected to the heat transfer medium.

In the present invention, it is preferable to feed the refrigerant through the piping configuring the refrigeration cycle, i.e., by using the configuration of the refrigeration cycle as it is, during supply of the heat energy of the refrigerant present in the particular region in the refrigeration cycle to the evaporator, because it is easier in operation and cost-effective. The direction of the flow of the refrigerant via the piping configuring the refrigeration cycle may vary, for example according to the structure of the refrigeration system (e.g., kind and structure of the pressure-reducing device), the operation method and others, but may be in the forward or backward direction or in the bidirectional direction. That is true in the following case, too.

When the compressor is terminated or the output reduced during operation of the refrigeration cycle, the vapor of the refrigerant in the particular region relatively in the high-temperature high-pressure state moves toward the side in the relatively low-temperature low-pressure state. The flow direction may be a forward flow direction or a backward flow direction, or alternatively both directions, and may vary according to the structure of the refrigeration cycle (e.g., kind and structure of pressure-reducing device), its operation method and others. However, because the destination, i.e., the side in the low-temperature low-pressure state, has an evaporator, the vapor of the refrigerant relatively in the high-temperature high-pressure state moves toward the evaporator consequently. Independently of whether the evaporator or the heat exchanger has the same functions as a clathrate hydrate-producing heat exchanger or a refrigerant/heat-transfer-medium heat exchanger, the heat energy of the refrigerant relatively in the high-temperature high-pressure state is transmitted to the heat-transfer surface of the clathrate hydrate-producing heat exchanger, melting the clathrate hydrate deposited on the heat-transfer surface.

More specifically, when the evaporator or the heat exchanger has the same functions as a clathrate hydrate-producing heat exchanger, the heat energy of the relatively high-temperature high-pressure refrigerant is supplied to the evaporator, raising the temperature of the refrigerant in the evaporator to the melting point of the clathrate hydrate or more, raising the temperature of the heat-transfer surface of the clathrate hydrate-producing heat exchanger, and melting the clathrate hydrate deposited on the heat-transfer surface.

Alternatively when the evaporator or the heat exchanger has the same functions as a refrigerant/heat-transfer-medium heat exchanger, the heat energy raises the temperature of the refrigerant in the evaporator, the temperature of the heat transfer medium in heat exchange with the refrigerant, the temperature of the refrigerant/heat-transfer-medium heat exchanger, and additionally the temperature of the heat transfer medium. By supplying the heat energy of the heat transfer medium directly or indirectly to the clathrate hydrate-producing heat exchanger installed outside the refrigeration cycle, it raises the temperature of the heat-transfer surface of the clathrate hydrate-producing heat exchanger, melting the clathrate hydrate deposited on the heat-transfer surface.

The melting of the clathrate hydrate is the result of using the heat energy originally present in the refrigeration cycle, and such an operation advantageously does not demand additional device, apparatus, piping or others, and thus, is easy, cost-effective and lower in energy consumption. In addition, it is easier and more cost-effective, because it can be done by operation normally practiced in the refrigeration cycle, such as termination of compressor or reduction of output, and by using the configuration of the refrigeration cycle, including a particular region and a piping connecting between the particular region and the evaporator, as it is.

The melting operation of clathrate hydrate disclosed in Jpn. Pat. Appln. KOKAI Publication No. 2004-93052 also does not demand operation of the compressor at the rated output or higher and consume no additional power.

As in Example 6, wherein the heat energy of the refrigerant present in the particular region is supplied to the evaporator by termination of the compressor or reduction of the output, it is possible to provide a melting operation method of the apparatus for producing clathrate hydrate slurry that is easy, cost-effective and lower in energy consumption and allows melting of the clathrate hydrate deposited on the heat-transfer surface of heat exchanger for production of clathrate hydrate.

Although Example 6 is characteristic in that the heat energy of the refrigerant present in the particular region in the refrigeration cycle is supplied to the evaporator, considering availability of the refrigerant (thus, heat energy), particularly in the particular region, it is effective to supply the heat energy of the refrigerant present in any one of the compressor, the condenser and the piping connecting these compositions to the evaporator, and in particular, it is more effective to supply the heat energy of the refrigerant present in the condenser to the evaporator.

Example 6 will be described specifically in the following Examples 7 and 8.

### Example 7

In Example 7, the evaporator 209 or the heat exchanger thereof is a clathrate hydrate-producing heat exchanger.

### <Description of Apparatus>

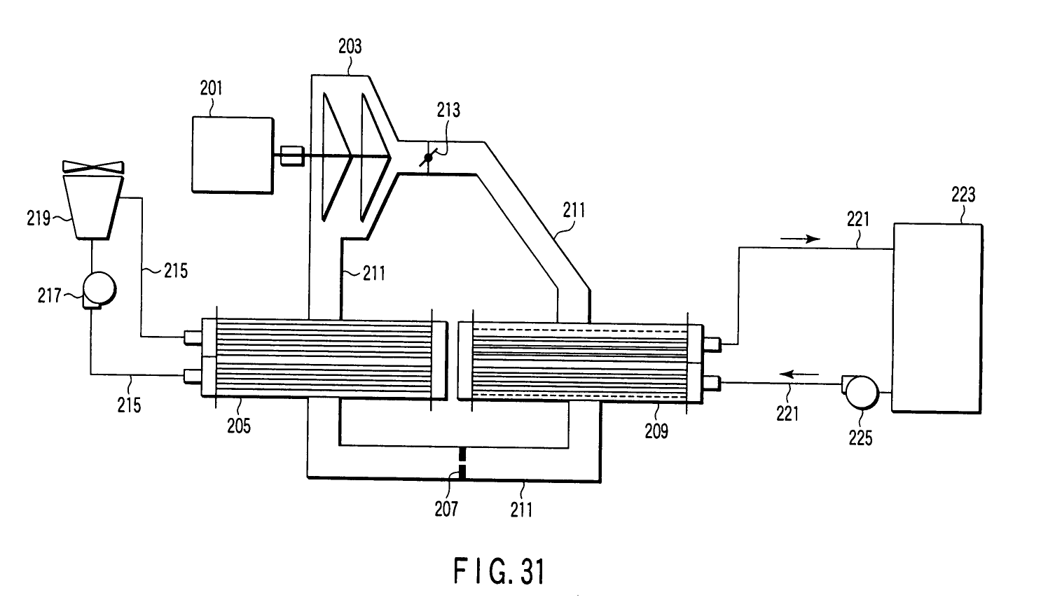

FIG. 31 is a explanatory diagram showing Example 7 of the present invention. The refrigerator unit is formed with a compressor 203 driven by a motor 201, a condenser 205, a pressure-reducing device 207 (orifice or flow rate-regulating valve), an evaporator 209, and piping connecting these compositions 211, and the refrigeration cycle is initiated by operation of the refrigerator unit. There is an inlet guide vane 213 installed at the inlet side of the compressor 203.

The compressor 203 is preferably a centrifugal compressor, but is not limited thereto. If the compressor 203 is centrifugal, the pressure-reducing device 207 is usually an orifice.

In addition, a cooling water piping 215 for circulation of the cooling water is connected to the condenser 205, and a cooling water pump 217 and a cooling tower 219 are connected to the cooling water piping 215. The condenser 205, the cooling tower 219, the cooling water pump 217 and the cooling water piping 215 connecting these compositions forms a heat transfer medium (water)-circulating cycle for condensation.

The clathrate hydrate-producing heat exchanger 209 equivalent to the cycle evaporator 209 configuring the refrigeration is a shell-and-tube heat exchanger, which represents the essential composition of the apparatus for producing clathrate hydrate slurry. The raw solution or slurry is supplied to the tube side of the shell-and-tube heat exchanger, and the raw solution or slurry is cooled via the tube heat-transfer surface with the cold heat by vaporization of the Fleon refrigerant (for example, R134a) in the shell side. The cooling leads to generation of clathrate hydrate, giving a clathrate hydrate slurry, as the generated clathrate hydrate is dispersed or suspended in the raw solution or slurry.

The raw material channel 221, through which the raw solution or slurry is supplied to the tube side of the clathrate hydrate-producing heat exchanger 209, has a tank 223 storing the raw solution or slurry (raw solution stored before initiation of production) and a feed pump 225 installed downstream side of the tank 223. When the clathrate hydrate slurry is used as the thermal storage agent or the cold heat-conveying medium for a thermal-storage air conditioning system, the tank 223 stores the clathrate hydrate slurry as a thermal storage tank and supplies the clathrate hydrate slurry to a heat-consuming device during air conditioning operation.

Although not shown in the figure, a pressure gauge and a thermometer are connected to the condenser 205 and the evaporator 209, and additionally, measurement instruments such as thermometer, pressure difference meter, and flowmeter are connected to the inlet and the outlet of clathrate hydrate slurry side of the evaporator 209.

In the refrigeration cycle configured as described above, the high-temperature refrigerant gas pressurized by the compressor 203 is sent to the condenser 205. Cooling water is supplied from the cooling tower 219 by a cooling water pump 217 to the tube side of the condenser 205, and the refrigerant gas is cooled and condensed by the cooling water, giving a high-pressure refrigerant liquid. The high-pressure refrigerant liquid is brought back to normal pressure by a pressure-reducing device 207 (orifice or flow rate-regulating valve) and sent to the evaporator 209. The refrigerant gas vaporized in the evaporator 209 is fed, via an inlet guide vane 213, to the compressor 203.

On the other hand, the raw solution or slurry is supplied to the tube side of the clathrate hydrate-producing heat exchanger 209; the raw solution or slurry is cooled with the cold heat by vaporization of the refrigerant in the shell side via the tube heat-transfer surface, giving a clathrate hydrate slurry.

### <Operation Method>

In the present example, the raw solution used was an aqueous tetra-n-butylammonium bromide solution (hereinafter, referred to as “aqueous TBAB solution”) at a concentration of 14.4 wt %. The hydrate generation-initiating temperature of the aqueous TBAB solution at the concentration is approximately 8° C.

### [Operation of Apparatus for Producing Clathrate Hydrate Slurry]

The apparatus for producing clathrate hydrate slurry was operated as follows:

The raw solution or slurry was supplied into the clathrate hydrate-producing heat exchanger 209, as the inverter for the feed pump 225 is regulated to a particular flow rate; and then, the refrigeration cycle and the heat transfer medium-circulating cycle for condensation was initiated, generating the clathrate hydrate by cooling the raw solution or slurry while the refrigerant is vaporized in the clathrate hydrate-producing heat exchanger 209 and thus, giving a clathrate hydrate slurry. The refrigerant temperature of the clathrate hydrate-producing heat exchanger 209 is kept constant by regulation of the compressor 203 in the refrigerator unit, for continuous production of the clathrate hydrate slurry.

When R134a is used as the Fleon refrigerant, the refrigerant temperature during vaporization in the evaporator 9 is approximately 2 to 4° C. (0.31 to 0.34 MPa under saturation pressure). When the cooling water temperature is 32° C., the temperature of the refrigerant in the condenser 5 is 32 to 38° C. (0.82 to 0.96 MPa under saturation pressure).

Gradual increase in pressure difference is observed when the pressure difference between the outlet and the inlet of the clathrate hydrate slurry of the clathrate hydrate-producing heat exchanger 209 is monitored, indicating that the clathrate hydrate is deposited on the tube inner wall surface and the thickness and the pressure drop are increasing. When the pressure difference between the inlet and the outlet of the clathrate hydrate slurry becomes higher than a particular value previously determined by increase in thickness of the clathrate hydrate deposition and also in pressure drop, the following melting operation is performed:

### [Melting Operation]

Continued production of the clathrate hydrate slurry in the tube side of clathrate hydrate-producing heat exchanger 209 results in deposition of the clathrate hydrate on the tube inner wall surface and increase in pressure drop, consequently in hindrance and obstruction of the flow of the raw solution, the raw slurry and the clathrate hydrate slurry, as the pressure drop becomes too large, prohibiting stabilized production of the clathrate hydrate slurry. Thus for stable production of the clathrate hydrate slurry, a melting operation of melting and removing the hydrate deposited on the tube inner wall surface in the clathrate hydrate-producing heat exchanger 209 is performed.

The melting operation is performed in the following way:

Operation of the compressor 203 is terminated. The cooling water pump 217 is also terminated as needed, for termination of the heat transfer medium-circulating cycle for condensation. The inlet guide vane 213 is opened completely, and a pressure-reducing device of flow rate-regulating valve 207 is opened completely. In this way, a route supplying the refrigerant in the direction opposite to the direction of the refrigerant flowing in the refrigeration cycle during refrigeration cycle operation (during compressor operation) is formed (back flow direction).

The refrigerant in the condenser 205 is at high pressure and high temperature, immediately before termination of the operation of compressor 203, while the refrigerant in the evaporator 209 is at low pressure and low temperature.

When the refrigerant form a route circulating in the opposite direction in such a state, the high-pressure high-temperature refrigerant gas in the condenser 205 flows back through the compressor 203 into the evaporator 209 and condenses in the evaporator 209 at low temperature. The pressure and the temperature of the refrigerant in the condenser 205 decline gradually, but the pressure and the temperature of the refrigerant in the evaporator 209 rise, equilibrating at the intermediate values of pressure and temperature of the refrigerant in the condenser 205 and the evaporator 209 during compressor operation. The temperature is approximately 10 to 20° C. (pressure: 0.4 to 0.6 MPa), although it depends on the amount of the refrigerant. Increase of the refrigerant temperature in the evaporator 209 leads to melting of the clathrate hydrate present in the evaporator. More specifically, the temperature of the refrigerant supplied to the evaporator 209, i.e., the clathrate hydrate-producing heat exchanger 209, rises, melting and removing the hydrate deposited on the tube inner wall surface.

When the pressure difference between the outlet and the inlet of the clathrate hydrate slurry in the clathrate hydrate-producing heat exchanger 209 is found to decline to the pressure difference at initiation of production when there is no clathrate hydrate deposited by measurement, or when the clathrate hydrate deposited is found to be melted and removed by other means, the clathrate hydrate slurry-producing operation is resumed by turning on the compressor 3 (additionally the circulation cycle, when the heat transfer medium-circulating cycle for condensation is terminated).

### (Operation to Regulate the Temperature of the Heat Transfer Medium (Cooling Water) for Condensation)

When the hydrate deposited on the tube inner wall surface is not melted completely by operation of raising the temperature of the refrigerant in the evaporator 209 or when the temperature of the refrigerant in the evaporator 209 is lower than the melting point of the clathrate hydrate, after terminating operation of the compressor 203 and supplying the high temperature high-pressure refrigerant from the condenser 5 back to the evaporator 209, the operation may be replaced or added with an operation of regulating the temperature of the condensation heat transfer medium supplied to the condenser 205.

For regulation of the temperature of the condensation heat transfer medium supplied to the condenser 205, the temperature of the condensation heat transfer medium is regulated by terminating the compressor 3 in the refrigerator unit and operating the cooling tower fan and the cooling water pump 217 in the cycle of circulating the condensation heat transfer medium supplied to the condenser 205. If the cooling tower fan and the cooling water pump 217 are operated when the outer air temperature is not higher than the melting point of the clathrate hydrate, the condensation heat transfer medium (cooling water) rises approximately to the outer air temperature (accurately to the outer air wet-bulb temperature), and thus, it is possible to raise the temperature of the refrigerant in the condenser 205 approximately to the outer air temperature, and thus, to raise the temperature of the refrigerant in the clathrate hydrate-producing heat exchanger 209 approximately to the outer air temperature. Because the refrigerant is warmed to a temperature not lower than the melting point of the clathrate hydrate in this way, it is possible to melt the clathrate hydrate deposited on the heat-transfer surface of the clathrate hydrate-producing heat exchanger 209.

When the outer air temperature is not lower than the melting point of the clathrate hydrate, it is not possible to raise the temperature in the condenser 205 and the evaporator 209 to a temperature not lower than the melting point of the clathrate hydrate. However, the apparatus for producing clathrate hydrate slurry having a clathrate hydrate-producing heat exchanger is not particularly unfavorable practically, if the clathrate hydrate slurry is used as a thermal storage material for air conditioning. It is because, when the outer air temperature is lower than the melting point of the clathrate hydrate, there is normally no need for using the clathrate hydrate slurry as a thermal storage material.

### (Determination of Melting Operation Initiation Point)

Favorably, the melting operation is initiated when deposition of the clathrate hydrate on the heat-transfer surface of the clathrate hydrate-producing heat exchanger 209, or a change in the operation state of the apparatus for producing clathrate hydrate slurry indicating the deposition, is detected, based on the measured results of the parameters relevant to the operation state of the apparatus for producing clathrate hydrate slurry obtained by monitoring.

In the present Example, the pressure difference or the pressure drop between the outlet and the inlet of the clathrate hydrate slurry in the clathrate hydrate-producing heat exchanger 209 is used as the parameter, but the parameter is not limited thereto. Examples of the parameters include the flow rate and quantity of the clathrate hydrate slurry flowing in the clathrate hydrate-producing heat exchanger, the temperature of the raw solution, raw slurry or clathrate hydrate slurry at the inlet and the outlet of the clathrate hydrate-producing heat exchanger, the heat exchange capacity of the raw solution, raw slurry or clathrate hydrate slurry in the clathrate hydrate-producing heat exchanger, the solid phase rate of the clathrate hydrate slurry withdrawn from the clathrate hydrate-producing heat exchanger (weight rate of the clathrate hydrate in the clathrate hydrate slurry), the temperature of the refrigerant at the inlet and outlet of the clathrate hydrate-producing heat exchanger, the heat exchange capacity of the refrigerant in the clathrate hydrate-producing heat exchanger, and the like, and the melting operation may be initiated after detection, monitoring and confirmation that one of the parameter exceeds a particular value.

### (Supplementary Remarks)

1) In the description above, the heat energy of the refrigerant in the condenser 205 is supplied to the evaporator 209, but, strictly speaking, it should be described that the heat energy of the refrigerant present in the particular region including the condenser 5 is supplied to the evaporator 209. Considering the quantitative distribution of the refrigerant, the heat energy of which can be supplied to the evaporator 209, the refrigerant present in the condenser 9 is greater in amount, and thus, the description above that the heat energy of the refrigerant in the condenser 209 is supplied to the evaporator 209 is not incorrect, although it may be slightly inaccurate.

2) In the description above, the refrigerant present in the particular region was fed backward by opening the inlet guide vane 213 completely and also opening the flow rate-regulating valve 207, but at least a part of the refrigerant may be fed forward to the evaporator 209. At least a part of the refrigerant may also be fed forward to the evaporator 209, similarly when an orifice is used as the pressure-reducing device 207. However, the amount of the refrigerant fed forward or backward varies according to the system configuration and structure of the refrigeration cycle, the kind and structure of the inlet guide vane 213 and the pressure-reducing device 207, the degree of valve opening, and others.

3) In the description above, the operation of the compressor 203 was terminated, but, even when the output of the compressor 203 is reduced, the refrigerant present in the particular region becomes at relatively high temperature and high pressure, and thus, it is possible to melt the clathrate hydrate in the evaporator by supplying the heat energy of the refrigerant thereto. In such a case, because the compressor 203 is operated to feed the refrigerant forward even though the output is lowered, the refrigerant present in the particular region is less likely to be fed backward. Therefore, if the refrigerant reaches the evaporator 209, it is likely that most of it is fed forward into the evaporator 209.

### Example 8

### When the Evaporator or the Heat Exchanger Thereof is a Refrigerant/Heat-Transfer-Medium Heat Exchanger

In Example 8, the evaporator or the heat exchanger thereof is a refrigerant/heat-transfer-medium heat exchanger 241 heat-exchanging the heat transfer medium heat previously exchanged with the raw solution in the clathrate hydrate-producing heat exchanger 231 with the refrigerant in the refrigeration cycle.

### <Description of Apparatus>

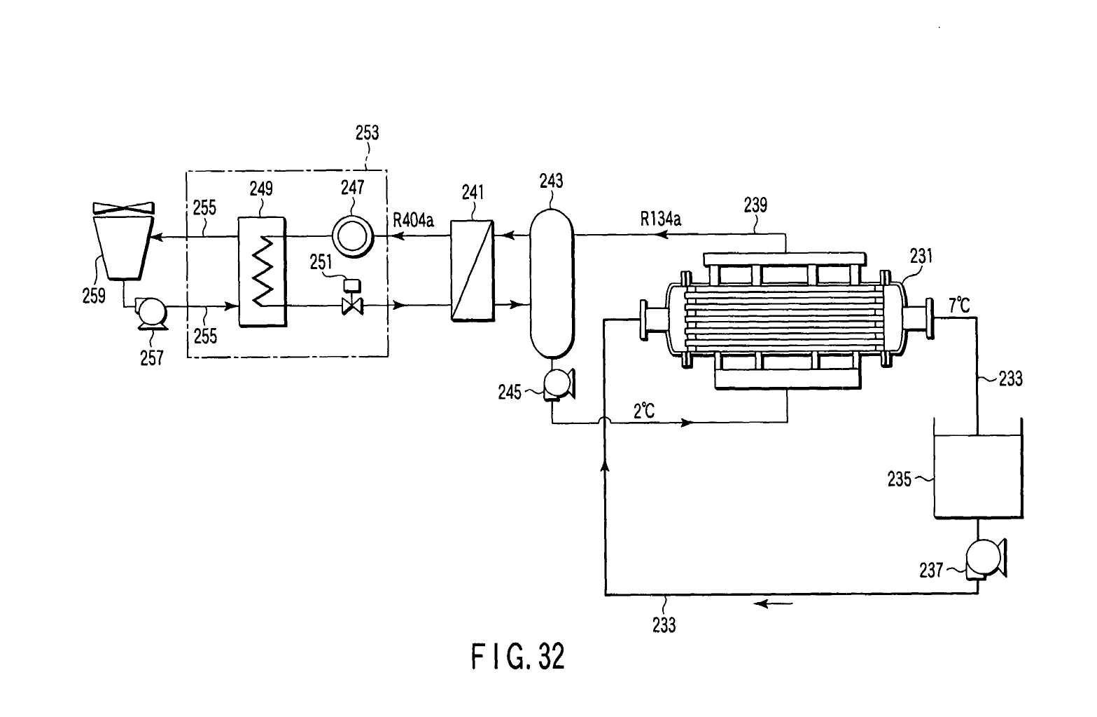

FIG. 32 is a explanatory diagram showing Example 8.

The clathrate hydrate-producing heat exchanger 231 is a one-pass shell-and-tube heat exchanger consisting of a shell obtained by processing of a SUS304 steel tube having a nominal diameter of 150 A and 27 SUS304 tubes each having an outer diameter of 17.3 mm and an inner diameter of 14 mm inserted therein. The raw solution or slurry flows in the tube, while the heat transfer medium in the shell side.

The raw material channel 233 supplying the raw solution or slurry to the tube side of the clathrate hydrate-producing heat exchanger 231 has a tank 235 storing the raw solution or slurry (storing the raw solution when production starts) and a feed pump 237 installed downstream side of the tank 235.

The flow rate of the raw solution or slurry sent to the clathrate hydrate-producing heat exchanger 231 is regulated to a particular value by regulation of the pump rotational frequency by the inverter connected to the feed pump 237.

A Fleon refrigerant R134a is supplied as a heat transfer medium via the heat transfer medium circuit 239 into the shell side of the clathrate hydrate-producing heat exchanger 231. The heat transfer medium circuit 239 has a refrigerant/heat-transfer-medium heat exchanger 241, a gas-liquid separator 243, and a heat transfer medium pump 245 installed. A Fleon refrigerant R404a cooled in the refrigerator unit 253 having a compressor 247, a condenser 249, and a pressure-reducing device 251 (expansion valve 251) is sent to the refrigerant/heat-transfer-medium heat exchanger 241, allowing heat exchange with the heat transfer medium R134a.

A compressor 247, a condenser 249, a pressure-reducing device 251 (expansion valve 251), an evaporator and a piping connecting these compositions form a refrigerator unit 253, and the evaporator is equivalent to the refrigerant/heat-transfer-medium heat exchanger 241.

In addition, a cooling water piping 255 for circulating the cooling water is connected to the condenser 249, and a cooling water pump 257 and a cooling tower 259 are connected to the cooling water piping 255. A condenser 249, a cooling tower 259, a cooling water pump 257 and a cooling water piping 255 connecting these compositions form a circulation cycle of the condensation heat transfer medium (water).

The refrigerant gas at high temperature (Fleon refrigerant: R404a) pressurized by the compressor 247 is sent to the condenser 249. The cooling water is supplied from the cooling tower 259 by the cooling water pump 257 to the tube side of the condenser 249, and the refrigerant gas is cooled and condensed with the cooling water, giving a high-pressure refrigerant liquid. The high-pressure refrigerant liquid is brought back to reduced pressure by the pressure-reducing device 251 (expansion valve 251) and the sent to the evaporator. The gas vaporized in the evaporator is suctioned into the compressor 247.

The evaporator refrigerant/heat-transfer-medium heat exchanger 241 is a shell-and-tube heat exchanger, and the heat transfer medium (R134a) is fed into the tube side and the heat transfer medium is cooled when the refrigerant (R404a) in the shell side vaporizes.

The heat transfer medium cooled in the refrigerant/heat-transfer-medium heat exchanger 241 at approximately 2° C. is supplied by the heat transfer medium pump 245, via the gas-liquid separator 243, into the shell of the clathrate hydrate-producing heat exchanger 231, and the raw solution or slurry in the tube is cooled by vaporization of a part of the heat transfer medium fluid there, generating the clathrate hydrate and giving a clathrate hydrate slurry. The heat transfer medium gas vaporized and the heat transfer medium fluid are sent back to the gas-liquid separator 243.

The heat transfer medium gas isolated in the gas-liquid separator 243 is sent to the refrigerant/heat-transfer-medium heat exchanger 241, where it is cooled and condensed, giving a liquid heat transfer medium, which is then sent back to the gas-liquid separator 243.

Although not shown in the figure, a pressure difference meter monitoring the pressure difference between the inlet and outlet of the clathrate hydrate-producing heat exchanger 231 of the raw solution or slurry sent to the clathrate hydrate-producing heat exchanger 231, a thermometer monitoring the temperature of the clathrate hydrate slurry withdrawn from the clathrate hydrate-producing heat exchanger 231, and a thermometer monitoring the temperature of the heat transfer medium are installed additionally.

### <Operation Method>

The raw solution used was an aqueous TBAB solution at a concentration of 14.4 wt %. The hydrate generation-initiating temperature of the aqueous TBAB solution is approximately 8° C.

### [Clathrate Hydrate Slurry-Producing Operation]

The raw solution or slurry was circulated into the circulation channel after regulation of the inverter for the circulation pump to a particular flow rate; the refrigerator unit 253, the heat transfer medium-circulating cycle for condensation and the heat transfer medium pump 245 are initiated; the heat transfer medium is cooled, as the refrigerant is vaporized in the refrigerant/heat-transfer-medium heat exchanger 241; the cooled heat transfer medium is fed into the clathrate hydrate-producing heat exchanger 231, cooling the raw solution or slurry in the tube and giving a clathrate hydrate slurry.

The temperature of the refrigerant in the refrigerant/heat-transfer-medium heat exchanger 241 is kept constant by regulation of the compressor 247 in the refrigerator unit 253, and the temperature of the heat transfer medium in the clathrate hydrate-producing heat exchanger 231 is kept constant, allowing continuous production of the clathrate hydrate slurry.

The pressure difference between the outlet and inlet of the clathrate hydrate slurry in the clathrate hydrate-producing heat exchanger 231, when monitored, increases gradually, indicating deposition of the clathrate hydrate on the tube inner wall surface and increase in deposition thickness and pressure drop.

### [Melting Operation]

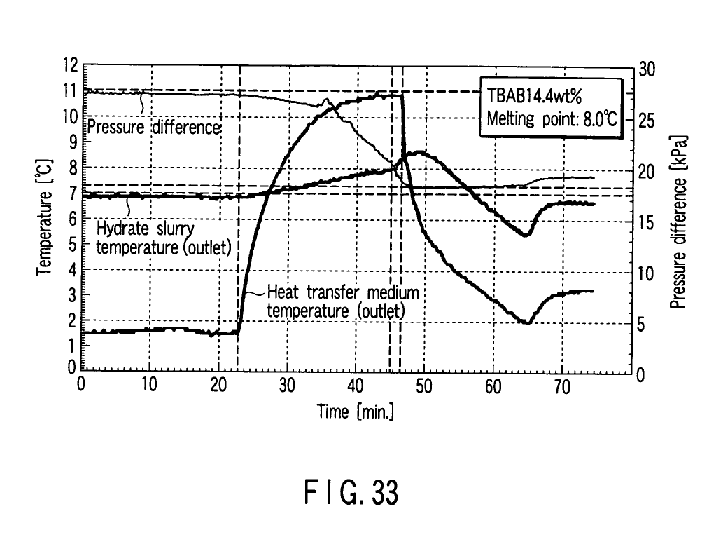

FIG. 33 is a graph showing the change over time in the pressure difference between the outlet and inlet of the clathrate hydrate-producing heat exchanger 231, the temperature of the clathrate hydrate slurry passed through the clathrate hydrate-producing heat exchanger 231, and the temperature of the heat transfer medium.

In FIG. 33, the abscissa represents the time after dozens of minutes from initiation of production of the clathrate hydrate slurry; the left ordinate represents the temperature of the clathrate hydrate slurry and the heat transfer medium; while the right ordinate represents the pressure difference.

Dozens of minutes after initiation of production of the clathrate hydrate slurry, the pressure difference between the outlet and inlet of the clathrate hydrate-producing heat exchanger 231 increases up to 27.5 kPa, indicating that the clathrate hydrate is deposited on the tube inner wall surface and the pressure drop increased.

When the refrigerator is terminated at 23 minutes and the high temperature high-pressure refrigerant in the condenser 249 is fed back to the evaporator, i.e., the refrigerant/heat-transfer-medium heat exchanger 241, the heat transfer medium in the clathrate hydrate-producing heat exchanger 31 was heated, as the heat transfer medium was heated, as shown in FIG. 33.

Increase in temperature of the heat transfer medium in the shell of the clathrate hydrate-producing heat exchanger 231 leads to melting of the clathrate hydrate deposited on the tube inner wall surface and reduction of the pressure difference.

Twenty-four minutes after termination of the refrigerator, the pressure difference returns to the pressure difference of 18 kPa when there is no clathrate hydrate deposited at the start of the clathrate hydrate slurry production.

Returns to the pressure difference when there is no clathrate hydrate deposited at the start of the clathrate hydrate slurry production confirms that all of the deposited clathrate hydrate is fused and removed. Subsequently, the clathrate hydrate slurry-producing operation is resumed, as the refrigerator is activated.

### (Operation of Regulating the Temperature of the Condensation Heat Transfer Medium)

For melting the clathrate hydrate deposited on the tube inner wall surface, favorably used is an operation of raising the temperature of the heat transfer medium by terminating the refrigerator and feeding the high temperature high-pressure refrigerant in the condenser 249 back to the evaporator, or the operation above together with regulation of the temperature of the condensation heat transfer medium supplied to the condenser 249.

For regulation of the temperature of the condensation heat transfer medium supplied to the condenser 249, the temperature of the condensation heat transfer medium is regulated by terminating the compressor 247 for the refrigerator and operating the cooling tower fan and the cooling water pump 257 in the circulating cycle for circulating the condensation heat transfer medium supplied to the condenser 249. Because, if the cooling tower fan and the cooling water pump 257 are operated when the outer air temperature is not lower than the melting point of the clathrate hydrate or more, the temperature of the cooling water rises approximately to outer air temperature (accurately, outer air wet-bulb temperature), and thus, it is possible to raise the temperature of the refrigerant in the condenser 249 approximately to outer air and thus, the temperature of the heat transfer medium in the clathrate hydrate-producing heat exchanger 231 also approximately to outer air temperature. In this way, it is possible to raise the temperature of the heat transfer medium at least to a temperature of the melting point of the clathrate hydrate or more and to melt the clathrate hydrate deposited on the heat-transfer surface of the clathrate hydrate-producing heat exchanger 231.

In particular, if the clathrate hydrate deposited on the heat-transfer surface of the clathrate hydrate-producing heat exchanger 231 is not melted or the temperature of the heat transfer medium in the clathrate hydrate-producing heat exchanger 231 can only be raised to a temperature not higher than the melting point of the clathrate hydrate only by the operation of raising the temperature of the heat transfer medium by terminating the refrigerator and feeding the high temperature high-pressure refrigerant in the condenser 249 back to the evaporator, it is effective to perform an operation of regulating the temperature of the condensation heat transfer medium supplied to the condenser 249.

1. A method of producing a clathrate hydrate slurry, comprising a step of heat-exchanging an aqueous solution of a guest compound for the clathrate hydrate or a slurry of the clathrate hydrate dispersed or suspended in an aqueous solution or water with a refrigerant through a heat transfer surface thereby generating the clathrate hydrate in the aqueous solution or the slurry,
wherein a part of the clathrate hydrate deposited on the heat transfer surface in the process of heat exchange with the refrigerant is removed by adjustment of a temperature of the refrigerant and flow force of the aqueous solution or the slurry and the rest is kept remained as it covers the heat transfer surface.

2. A method of producing a clathrate hydrate slurry, comprising a step of heat-exchanging an aqueous solution of a guest compound for the clathrate hydrate or a slurry of the clathrate hydrate dispersed or suspended in an aqueous solution or water with a refrigerant through a heat transfer surface thereby generating the clathrate hydrate in the aqueous solution or the slurry,
further comprising:
a first step of suppressing increase in an amount of the clathrate hydrate deposited on a heat transfer surface in a process of heat exchange with the refrigerant by flow force of the aqueous solution or the slurry; and
a second step of regulating the refrigerant temperature to a temperature lower than a freezing point of the clathrate hydrate and close to the freezing point or a temperature close to that of the aqueous solution or slurry.

3. A method of producing a clathrate hydrate slurry, comprising a step of heat-exchanging an aqueous solution of a guest compound for the clathrate hydrate or a slurry of the clathrate hydrate dispersed or suspended in an aqueous solution or water with a refrigerant through a heat transfer surface thereby generating the clathrate hydrate in the aqueous solution or the slurry,
further comprising:
a first step of removing a part of the clathrate hydrate deposited on the heat transfer surface in the process of heat exchange with the refrigerant by flow force of the aqueous solution or the slurry and keeping the rest remained as it covers the heat transfer surface; and
a second step of regulating the refrigerant temperature to a temperature lower than a freezing point of the clathrate hydrate and close to the freezing point or a temperature close to that of the aqueous solution or slurry.

4. The method of producing a clathrate hydrate slurry according to claim 2, further comprising the step of returning a part or all of the aqueous solution or the slurry passed through the heat transfer surface to the heat transfer surface.

5. The method of producing a clathrate hydrate slurry according to claim 2, wherein the second step is a step of regulating a difference between the temperature of the refrigerant and the temperature of the aqueous solution or slurry to be 1 degree or more and 4 degrees or less.

6. An apparatus for producing a clathrate hydrate slurry, comprising a heat transfer body having a heat transfer surface, a refrigerant-supplying device supplying a refrigerant to the heat transfer body, a raw liquid-supplying device supplying an aqueous solution of a guest compound for the clathrate hydrate or a slurry of the clathrate hydrate dispersed or suspended in an aqueous solution or water to the heat transfer surface, a flow rate-regulating device regulating a flow rate of the aqueous solution or the slurry, and a refrigerant temperature-regulating device regulating the temperature of the refrigerant, the clathrate hydrate being formed in the aqueous solution or the slurry through heat exchange with the refrigerant through the heat transfer surface,
wherein the flow rate of the aqueous solution or the slurry is regulated by the flow rate-regulating device in such a manner that increase in the amount of the clathrate hydrate deposited on the heat transfer surface is suppressed by flow force of the aqueous solution or the slurry supplied to the heat transfer surface; and
the refrigerant temperature is regulated by the refrigerant temperature-regulating device to a temperature lower than a freezing point of the clathrate hydrate and close to the freezing point or a temperature close to that of the aqueous solution or slurry.

7. An apparatus for producing a clathrate hydrate slurry, comprising a heat transfer body having a heat transfer surface, a refrigerant-supplying device supplying a refrigerant to the heat transfer body, a raw liquid-supplying device supplying an aqueous solution of a guest compound for the clathrate hydrate or a slurry of the clathrate hydrate dispersed or suspended in an aqueous solution or water to the heat transfer surface, and a flow rate-regulating device regulating a flow rate of the aqueous solution or the slurry, a refrigerant temperature-regulating device regulating the temperature of the refrigerant, the clathrate hydrate being formed in the aqueous solution or the slurry through heat exchange with the refrigerant through the heat transfer surface,
wherein the flow rate of the aqueous solution or the slurry is regulated by the flow rate-regulating device in such a manner that a part of the clathrate hydrate deposited on the heat transfer surface is removed by flow force of the aqueous solution or the slurry and the rest is kept remained as it covers the heat transfer surface; and
the refrigerant temperature is regulated by the refrigerant temperature-regulating device to a temperature lower than a freezing point of the clathrate hydrate and close to the freezing point or a temperature close to that of the aqueous solution or slurry supplied to the heat transfer surface.

8. The apparatus for producing clathrate hydrate slurry according to claim 6, further comprising a turbulence-generating means generating turbulence in a flow of the aqueous solution or the slurry supplied to the heat transfer surface.

9. The apparatus for producing clathrate hydrate slurry according to claim 6, wherein the heat transfer surface has irregularities along a flow direction of the aqueous solution or the slurry.

10. The apparatus for producing clathrate hydrate slurry according to claim 6, further comprising a circulating device circulating a part or all of the aqueous solution or the slurry passed through the heat transfer surface around the heat transfer surface.

11. The apparatus for producing clathrate hydrate slurry according to claim 6, wherein the refrigerant temperature-regulating device regulates a difference between the temperature of the refrigerant and the temperature of the aqueous solution or slurry to be 1 degree or more and 4 degrees or less.

12. A method of operating an apparatus for producing clathrate hydrate slurry, comprising a heat transfer body having a heat transfer surface, a refrigerant-supplying device supplying a refrigerant to the heat transfer body, a raw liquid-supplying device supplying an aqueous solution of a guest compound for the clathrate hydrate or a slurry of the clathrate hydrate dispersed or suspended in an aqueous solution or water to the heat transfer surface, a flow rate-regulating device regulating a flow rate of the aqueous solution or the slurry, and a circulating device circulating a part or all of the aqueous solution or the slurry passed through the heat transfer surface around the heat transfer surface regularly or as needed, the clathrate hydrate being formed in the aqueous solution or the slurry through heat exchange with the refrigerant through the heat transfer surface,
comprising:
a first step of removing a part of the clathrate hydrate deposited on the heat transfer surface by flow force of the aqueous solution or the slurry and keeping the rest remained as it covers the heat transfer surface, on initial operation, resumption of operation after cessation or commissioning for performance test of the production apparatus; and
a second step of regulating the refrigerant temperature to a temperature lower than a freezing point of the clathrate hydrate and close to the freezing point or a temperature close to that of the aqueous solution or slurry supplied to the heat transfer surface.

13. A method of operating an apparatus for producing clathrate hydrate slurry, comprising a heat transfer body having a heat transfer surface, a refrigerant-supplying device supplying a refrigerant to the heat transfer body, a refrigerant temperature-regulating device regulating the temperature of the refrigerant, a raw liquid-supplying device supplying an aqueous solution of a guest compound for the clathrate hydrate or a slurry of the clathrate hydrate dispersed or suspended in an aqueous solution or water to the heat transfer surface, a flow rate-regulating device regulating a flow rate of the aqueous solution or the slurry, and a circulating device circulating a part or all of the aqueous solution or the slurry passed through the heat transfer surface around the heat transfer surface regularly or as needed, the clathrate hydrate being formed in the aqueous solution or the slurry through heat exchange with the refrigerant through the heat transfer surface,
further comprising:
a first step of removing a part of the clathrate hydrate deposited on the heat transfer surface by flow force of the aqueous solution or the slurry and keeping the rest remained as it covers the heat transfer surface, on normal operation of the apparatus; and
a second step of regulating the refrigerant temperature to a temperature lower than a freezing point of the clathrate hydrate and close to the freezing point or a temperature close to that of the aqueous solution or slurry supplied to the heat transfer surface.

14. The method of operating an apparatus for producing clathrate hydrate slurry according to claim 12, wherein the second step is a step of regulating a difference between the temperature of the refrigerant and the temperature of the aqueous solution or slurry to be 1 degree or more and 4 degrees or less.

15. A method of operating an apparatus for producing clathrate hydrate slurry, comprising a heat transfer body having a heat transfer surface, a refrigerant-supplying device supplying a refrigerant to the heat transfer body, a refrigerant temperature-regulating device regulating the temperature of the refrigerant, a raw liquid-supplying device supplying an aqueous solution of a guest compound for the clathrate hydrate or a slurry of the clathrate hydrate dispersed or suspended in an aqueous solution or water to the heat transfer surface, a flow rate-regulating device regulating a flow rate of the aqueous solution or the slurry, and a circulating device circulating a part or all of the aqueous solution or the slurry passed through the heat transfer surface around the heat transfer surface regularly or as needed, the clathrate hydrate being formed in the aqueous solution or the slurry through heat exchange with the refrigerant through the heat transfer surface,
wherein, on initial operation, resumption of operation after cessation or commissioning for performance test of the production apparatus, the refrigerant temperature is regulated with the refrigerant temperature-regulating device to a temperature higher than the freezing temperature of the clathrate hydrate so as to remove a part of the clathrate hydrate deposited on the heat transfer surface by flow force of the aqueous solution or the slurry and keep the rest remained as it covers the heat transfer surface.

16. The method of producing a clathrate hydrate slurry according to claim 3, further comprising the step of returning a part or all of the aqueous solution or the slurry passed through the heat transfer surface to the heat transfer surface.

17. The method of producing a clathrate hydrate slurry according to claim 3, wherein the second step is a step of regulating a difference between the temperature of the refrigerant and the temperature of the aqueous solution or slurry to be 1 degree or more and 4 degrees or less.

18. The apparatus for producing clathrate hydrate slurry according to claim 7, further comprising a turbulence-generating means generating turbulence in a flow of the aqueous solution or the slurry supplied to the heat transfer surface.

19. The apparatus for producing clathrate hydrate slurry according to claim 7, wherein the heat transfer surface has irregularities along a flow direction of the aqueous solution or the slurry.

20. The apparatus for producing clathrate hydrate slurry according to claim 7, further comprising a circulating device circulating a part or all of the aqueous solution or the slurry passed through the heat transfer surface around the heat transfer surface.

21. The apparatus for producing clathrate hydrate slurry according to claim 7, wherein the refrigerant temperature-regulating device regulates a difference between the temperature of the refrigerant and the temperature of the aqueous solution or slurry to be 1 degree or more and 4 degrees or less.

22. The method of operating an apparatus for producing clathrate hydrate slurry according to claim 13, wherein the second step is a step of regulating a difference between the temperature of the refrigerant and the temperature of the aqueous solution or slurry to be 1 degree or more and 4 degrees or less.
